(19) United States
(12) Patent Application Publication
(10) Pub. No.: US 2026/0234825 A1
(43) Pub. Date: Aug. 13, 2026

(54) ELECTRODE COMPOSITES FOR ELECTROCHEMICAL ION SEPARATION FROM AQUEOUS SOLUTIONS, AND METHODS THEREOF

(71) Applicant: Lithios Inc., Cambridge, MA (US)

(72) Inventors: Michael J. Wang, Cambridge, MA (US); Martin Z. Bazant, Wellesley, MA (US); Mohammad A. Alkhadra, Boston, MA (US); Wei Lun Toh, Somerville, MA (US); Taksh J. Satra, Cambridge, MA (US)

(73) Assignee: Lithios Inc., Cambridge, MA (US)

(21) Appl. No.: 19/150,492

(22) PCT Filed: Jan. 23, 2024
(86) PCT No.: PCT/US2024/012499

§ 371 Date: Jul. 23, 2025

Related U.S. Application Data
(60) Provisional application No. 63/440,889, filed on Jan. 24, 2023.
(60) Provisional application No. 63/444,484, filed on Feb. 9, 2023.
(60) Provisional application No. 63/513,519, filed on Jul. 13, 2023.
(60) Provisional application No. 63/513,532, filed on Jul. 13, 2023.
(60) Provisional application No. 63/513,538, filed on Jul. 13, 2023.

(51) Int. Cl. C25C 1/02; C25C 7/02; C25C 7/04

(52) U.S. Cl. CPC C25C 1/02; C25C 7/02; C25C 7/04

(57) ABSTRACT

The present disclosure generally relates to apparatuses and methods for extraction of ions, including lithium ions, e.g., from aqueous solutions. For example, some aspects are generally directed to apparatuses in which ion exchange can be driven by electricity. Such apparatuses can be used, for example, to extract target ions (e.g., lithium) from a target-ion rich fluid to a target-ion poor fluid. However, in some cases, the target-ion rich fluid may be substantially impure or contain a variety of contaminants, which can adversely affect various components within the apparatus, for example, the electrodes used to supply electricity. Thus, certain embodiments are generally directed to apparatuses and methods that can address various physical, chemical, and/or biological problems associated with such fluids, including hydrodynamic dispersion, water splitting, pH variations, bubble generation, corrosion, scaling, fouling, bio-fouling, dissolution, softening, erosion, freezing, boiling, or the like.

### RELATED APPLICATIONS

This application claims the benefit of U.S. Provisional Patent Application Ser. No. 63/440,889, filed Jan. 24, 2023, entitled “Methods and Apparatuses for Galvanic Ion Extraction”; U.S. Provisional Patent Application Ser. No. 63/444,484, filed Feb. 9, 2023, entitled “Flow Field Configurations and Methods for Separation Processes”; U.S. Provisional Patent Application Ser. No. 63/513,519, filed Jul. 13, 2023, entitled “Methods and Apparatuses for Electrochemical Ion Exchange”; U.S. Provisional Patent Application Ser. No. 63/513,532, filed Jul. 13, 2023, entitled “Processes and Apparatuses for Enriching Solutions”; and U.S. Provisional Patent Application Ser. No. 63/513,538, filed Jul. 13, 2023, entitled “Flow Systems and Methods for Membraneless Separation.” Each of the above is incorporated herein by reference.

### FIELD

The present disclosure generally relates to apparatuses and methods for extraction of ions, including lithium ions, e.g., from aqueous solutions.

### BACKGROUND

Electrochemical systems operating in aqueous electrolytes have been widely used for a variety of industries, including energy storage, chemicals production, water treatment, and metals refining. In many of these cases, the electrodes comprise simple geometries of metallic materials, which may allow for electrochemical interactions with an electrolytic solution, such as electrodeposition, electrodissolution, electrolysis, electroflocculation, electrocoagulation, electroflotation, reduction, oxidation, capacitive charging, or electrosorption, at the electrode surface. In some cases, the electrochemically active materials are integrated in porous electrodes with conducting additives and binders, in order to increase the internal electrode surface area for electrochemical reactions. In many applications, however, the electrodes have to also address various practical challenges associated with the physical, chemical, and biological properties of water, such as hydrophobicity, hydrodynamic slip, hydrodynamic dispersion, water splitting, pH variations, bubble generation, corrosion, scaling, fouling, bio-fouling, dissolution, softening, erosion, freezing, boiling, or the like. Accordingly, improvements are still needed.

### SUMMARY

The present disclosure generally relates to apparatuses and methods for extraction of ions, including lithium ions, e.g., from aqueous solutions. The subject matter of the present disclosure involves, in some cases, interrelated products, alternative solutions to a particular problem, and/or a plurality of different uses of one or more systems and/or articles.

Certain embodiments are directed to electrodes for use in electrochemical separations, such lithium extraction, from aqueous feedstocks. The electrode, in some embodiments, may comprise a porous composite of electrochemically active material, conductive matrix, binder, and additives. Individual components and/or the entire electrode may be treated or coated in some instances, for example, to alter the electrode interaction with water. In certain cases, additives may be introduced to the electrode composite, e.g., to alter the interaction with water.

In some embodiments, the electrodes are working electrodes used for selective electrosorption and release of certain target ions in aqueous solutions, such as lithium ions. In certain embodiments, the electrodes are counter-electrodes in electrochemical separation systems, which involve electrochemical processes that are less selective to the target ions than the working electrode. Certain embodiments are directed toward various materials used in or around the electrodes, such as current collectors, packaging materials, adhesives, spacers, supports, tubes, flow channels, etc.

One aspect is generally drawn to an apparatus for electrochemical extraction of lithium. In one set of embodiments, the apparatus comprises a compartment containing a lithium-selective electrode, the lithium-selective electrode comprising an active material, a conducting material, and a binder, where the lithium-selective electrode exhibits an air-water contact angle of less than 120°.

In another set of embodiments, the apparatus comprises a compartment containing a lithium-selective electrode, the lithium-selective electrode comprising an active material, a conducting material, and a binder, where a component of the apparatus exhibits an air-water contact angle of greater than 100°.

According to yet another set of embodiments, the apparatus comprises a compartment containing a lithium-selective electrode, the lithium-selective electrode comprising an active material, a conducting material, a binder, and silicone.

In still another set of embodiments, the apparatus comprises a compartment containing a lithium-selective electrode, the lithium-selective electrode comprising an active material, a conducting material, a binder, and lyotropic ions at a concentration of at least 1 wt %.

The apparatus, in yet another set of embodiments, comprises a compartment containing a lithium-selective electrode, the lithium-selective electrode comprising an active material, a conducting material, a binder, and a zwitterionic material.

The apparatus, in one set of embodiments, comprises a compartment containing a lithium-selective electrode, the lithium-selective electrode comprising an active material, a conducting material, a binder, and an anti-fouling coating present on at least a portion of the electrode.

In another set of embodiments, the apparatus comprises a compartment containing a lithium-selective electrode, the lithium-selective electrode comprising an active material, a conducting material, a binder, and a biocide.

In yet another set of embodiments, the apparatus comprises a compartment containing a lithium-selective electrode, the lithium-selective electrode comprising an active material, a conducting material, a binder, and a corrosion inhibitor.

The apparatus, in still another set of embodiments, comprises a compartment containing a lithium-selective electrode, the lithium-selective electrode comprising an active material, a conducting material, a binder, and a pH buffer.

In accordance with another set of embodiments, the apparatus comprises a compartment containing a lithium-selective electrode, the lithium-selective electrode comprising an active material, a conducting material, and a binder, where the lithium-selective electrode exhibits an elastic modulus of at least 5 MPa.

In still another set of embodiments, the apparatus comprises a compartment containing a lithium-selective electrode, the lithium-selective electrode comprising an active material, a conducting material, and a binder, where the lithium-selective electrode exhibits a compressive strength of at least 0.5 MPa.

The apparatus, in yet another set of embodiments, comprises a compartment containing a lithium-selective electrode, the lithium-selective electrode comprising an active material, a conducting material, and a binder, where the lithium-selective electrode exhibits a specific toughness of at least 3 mJ/cm³.

According to still another set of embodiments, the apparatus comprises a compartment containing a lithium-selective electrode, the lithium-selective electrode comprising an active material, a conducting material, a binder, and a mechanical stability additive.

The apparatus, in yet another set of embodiments, comprises a compartment containing a lithium-selective electrode, the lithium-selective electrode comprising an active material, a conducting material, a binder, and an anti-freeze chemical

In still another set of embodiments, the apparatus comprises a compartment containing a lithium-selective electrode, the lithium-selective electrode comprising an active material, a conducting material, a binder, and an anti-boiling coolant chemical.

Another aspect is generally drawn to an apparatus for electrochemical extraction of a target ion. In one set of embodiments, the apparatus comprises a compartment containing a target ion-selective electrode, the lithium-selective electrode comprising an active material, a conducting material, and a binder, where the target ion-selective electrode exhibits an air-water contact angle of less than 120°.

The apparatus, in another set of embodiments, comprises a compartment containing a target ion-selective electrode, the target ion-selective electrode comprising an active material, a conducting material, and a binder, where a component of the apparatus exhibits an air-water contact angle of greater than 100°.

Yet another aspect is generally drawn to a method for electrochemical extraction of lithium. In one set of embodiments, the method comprises flowing a lithium-rich fluid through a compartment containing a lithium-selective electrode, where the lithium-selective electrode comprises an active material, a conducting material, and a binder, and the lithium-selective electrode exhibits an air-water contact angle of less than 120°; and incorporating lithium from the lithium-rich fluid into the lithium-selective electrode.

In another set of embodiments, the method comprises flowing a lithium-rich fluid through a compartment of an apparatus, the compartment containing a lithium-selective electrode, where the lithium-selective comprises comprising an active material, a conducting material, and a binder, and a component of the apparatus exhibits an air-water contact angle of greater than 100°; and incorporating lithium from the lithium-rich fluid into the lithium-selective electrode.

Still another aspect is generally drown to a method for electrochemical extraction of a target ion. In one set of embodiments, the method comprises flowing a target ion-rich fluid through a compartment containing a target ion-selective electrode, where the lithium-selective electrode comprises an active material, a conducting material, and a binder, and the target ion-selective electrode exhibits an air-water contact angle of less than 120°; and incorporating target ions from the target ion-rich fluid into the target ion-selective electrode.

In another set of embodiments, the method comprises flowing a target ion-rich fluid through a compartment of an apparatus, the compartment containing a target ion-selective electrode, where the target ion-selective electrode comprises an active material, a conducting material, and a binder, and a component of the apparatus exhibits an air-water contact angle of greater than 100°; and incorporating target ions from the target ion-rich fluid into the target ion-selective electrode.

Still another aspect is generally drawn to a method comprising flowing a lithium-rich fluid through a compartment containing a lithium-selective electrode; incorporating lithium from the lithium-rich fluid into the lithium-selective electrode; and flowing an abrasive fluid through the compartment.

Yet another aspect is generally drawn to a method comprising flowing a lithium-rich fluid through a compartment containing a lithium-selective electrode; incorporating lithium from the lithium-rich fluid into the lithium-selective electrode; and applying a shear stress of at least 1 kPa to the lithium-selective electrode.

Another aspect is generally drawn to a device. In accordance with one set of embodiments, the device may comprise an electrode comprising an active material, a conducting material, and a binder, where the electrode exhibits an air-water contact angle of less than 120°.

In another set of embodiments, the device comprises an electrode comprising an active material, a conducting material, and a binder, where the electrode exhibits fouling resistance as determined by ASTM D3623-78a (1998).

The device, in still another set of embodiments, comprises an electrode comprising an active material, a conducting material, and a binder, where the electrode exhibits corrosion resistance as determined by ASTM B117-19 Salt Spray (2019), ASTM G85-19 Modified Salt Spray (2019), ASTM G85 Cyclic Corrosion (2019), or ASTM G1-03 Corrosion Test (2003).

In another aspect, the present disclosure encompasses methods of making one or more of the embodiments described herein, for example, a method of making electrodes for use in the extraction of target ions such as lithium. In still another aspect, the present disclosure encompasses methods of using one or more of the embodiments described herein, for example, a method of using electrodes for use in the extraction of target ions such as lithium.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 illustrates the contact angle of water on an electrode, in certain embodiments;

FIGS. 2A-2B illustrate the electrochemical behavior of certain electrodes, in another embodiment;

FIG. 3 illustrates electrode capacity for a cell in yet another embodiment; and

FIGS. 4A-4B illustrate electrochemical ion exchange of lithium and one or more divalent ions (M²⁺), in one embodiment.

FIG. 5A-5B illustrate electrochemical ion exchange of lithium and one or more monovalent cations (M⁺) in another embodiment.

FIG. 6A-6B illustrate electrochemical ion exchange of lithium and a combination of divalent cations (M²⁺) and anions (A⁻), in another embodiment.

FIG. 7 illustrates galvanic ion extraction of lithium using a stack lithium-selective electrodes alternating with anion exchange membranes.

### DETAILED DESCRIPTION

The present disclosure generally relates to apparatuses and methods for extraction of ions, including lithium ions, e.g., from aqueous solutions. For example, some aspects are generally directed to apparatuses in which ion exchange can be driven by electricity. Such apparatuses can be used, for example, to extract target ions (e.g., lithium) from a target-ion rich fluid to a target-ion poor fluid. However, in some cases, the target-ion rich fluid may be substantially impure or contain a variety of contaminants, which can adversely affect various components within the apparatus, for example, the electrodes used to supply electricity. Thus, certain embodiments are generally directed to apparatuses and methods that can address various physical, chemical, and/or biological problems associated with such fluids, including hydrodynamic dispersion, water splitting, pH variations, bubble generation, corrosion, scaling, fouling, bio-fouling, dissolution, softening, erosion, freezing, boiling, or the like.

One aspect of the present disclosure is generally drawn to electrodes for use in various apparatuses for the electrochemical extraction of target ions, e.g., in aqueous solutions, such as lithium ions, or other dissolved species such as sodium, potassium, copper, gold, silver, magnesium, calcium, aluminum, nickel, protons, hydronium, hydroxide, bromide, iodide, chloride, sulfate, ammonium, rare earth elements, lanthanides or other target ions such as those described herein. Without wishing to be bound by any theory, it is believed that such electrodes, and/or other component surfaces, may be exposed to fluids containing relatively high amounts of contaminants, e.g., within an apparatus. For instance, lithium-rich fluids may include brines, mining leachates, battery recycling leachates, electronic waste leachates, brackish water, or seawater, which may contain lithium ions to be extracted, but also may contain other ions, particles, molecules, microorganisms, silt, debris, rocks, etc., to be separated from the lithium ions. Similar considerations apply to other selective ion separations, such as the separation of specific rare earth elements from brines, mining leachates and effluents, which may contain a mixture of different rare earth elements with many of the same contaminants.

In some cases, such contaminants may interact with electrodes or other components, causing corrosion, fouling, or other problems. However, certain embodiments as discussed herein are generally directed to electrodes and/or other components that can better resist problems created by such contaminants, such as fouling, biofouling, corrosion, oxidation, reduction, pH changes, bubble generation, softening, erosion, dissolution, electrodeposition, or other problems. In addition, in some cases, electrodes and/or other components such as those discussed herein may be treated, e.g., using an abrasive fluid or a cleaning chemical, to remove any surface fouling, corrosion, oxidation, or the like.

In some applications, e.g., in geothermal brines or cold environments, the electrodes may be exposed to extreme temperatures, which may cause phase transformations of the electrolytic solution, leading to electrode damage or loss of active area. However, certain embodiments described herein provide anti-freeze or anti-boiling properties to the electrodes and surrounding structures to widen the temperature window for safe and efficient operation. In addition, exposure to aqueous solutions can lead to gradual softening, erosion or fluidization of the electrodes or surrounding materials, which can lower performance and limits system lifetime. However, in certain embodiments, this form of mechanical degradation can be suppressed or avoided, for example, such as those discussed herein. These may, for example, improve various mechanical properties and/or structural stability of the electrodes, for example, for use in long-term operation in aqueous environments.

In contrast, in other types of electrochemical systems, e.g., batteries, electrodes are often contained within a sealed compartment (e.g., a sealed battery) to prevent external contaminants from adversely affecting the electrodes. In some cases, such as lithium ion batteries, the electrolytes contained in the sealed compartment consist of only non-aqueous solvents, and water must be kept away from the electrodes during manufacturing and use. Accordingly, due to the sealed and/or non-aqueous environment, various problems associated with water, such as fouling, biofouling, bubble generation, oxidation, reduction, pH swings, erosion, dissolution or corrosion, can be avoided. Moreover, electrodes designed for use in such sealed environments are often not able to properly function when exposed to external aqueous solutions, which may include contaminants or additional reactants. Electrochemical systems, such as many batteries and fuel cells, are thus required to be contained within sealed environments with specific tailored electrolytes in order to prevent any potential exposure to contaminants (particles, microorganisms, oxygen, water, etc.) that can degrade their performance and limit their useful lifetime. However, the sealed compartment severely limits the type fluids to which the electrodes and other components can be exposed. Thus, in certain embodiments, improved designs of electrodes and surrounding materials for electrochemical ion extraction and related processes are provided, e.g., for robust stable operation in wide range of aqueous environments, which are not encountered in traditional electrochemical systems such as batteries and fuel cells.

Accordingly, certain embodiments such as discussed herein are generally directed to systems and methods of preventing or reducing various physical, chemical, and/or biological problems in the handling of certain aqueous fluids, for example, hydrodynamic dispersion, water splitting, bubble generation, pH variations, corrosion, fouling, bio-fouling, dissolution, softening, boiling, freezing, etc. Various components of an apparatus or a compartment may be prepared such as described herein, for example, electrodes, compartments, tubing, stacks, tanks, reservoirs, pipes, channels, spacers, supports, gaskets, separators, fluidic interconnects, electrical interconnects, etc. In some cases, more than one component may be prepared, and different components may be prepared the same or differently, e.g., using techniques including any of those described herein. Such systems and methods can be used, for example, in non-sealed environments, apparatuses which are exposed to such conditions, or the like. For example, systems and methods such as those described herein may be used to extract target ions from a target ion-rich fluid, for instance, that may contain a variety of impurities such as other ions, particles, molecules, dissolved gases, microorganisms, silt, debris, rocks, etc.

As a non-limiting example, in certain aspects, systems and methods such as those described herein may be directed to reducing or preventing fouling (including biofouling), e.g., of electrodes and/or other components of an apparatus such as those described herein, for example, compartments. Such systems may be able to better resist fouling, e.g., by micro-organisms, chemical deposition, etc. In some embodiments, for example, fluids that are treated in such systems may contain microorganisms, which may be able to grow on surfaces and cause fouling to occur. Fouling may be resisted using a variety of mechanisms, e.g., as discussed herein. For example, fouling may be resisted by using surfaces to which fouling organisms do not adhere well, by using surfaces that can inhibit or prevent the growth of organisms, by using surfaces containing biocides, by periodic treatments (e.g., physical, chemical, biological, etc.) to remove or kill fouling organisms, or the like. In certain embodiments, the amount of fouling resistance may be determined using ASTM D3623-78a (1998), which is herein incorporated by reference in its entirety. Other fouling tests may also be used in other embodiments.

For example, in one aspect, an electrode (e.g., or a portion thereof, e.g., an exposed or outer surface of the electrode), or other component, may have a hydrophobicity that prevents or at least reduces the ability of microorganisms to adhere to it. In one set of embodiments, for example, an electrode or other component may be formed or coated (e.g., partially or completely) such that it exhibits a relatively hydrophobic surface.

In some cases, an electrode or other component may exhibit a contact angle (determined with a surface in air and pure water) of at least 30°, at least 40°, at least 50°, at least 60°, at least 70°, at least 75°, at least 80°, at least 85°, at least 90°, at least 95°, at least 100°, at least 105°, at least 110°, at least 115°, at least 120°, at least 125°, at least 130°, at least 135°, etc. In some cases, the electrode or other component may exhibit a contact angle of no more than 135°, no more than 130°, no more than 125°, no more than 120°, no more than 115°, no more than 110°, no more than 105°, no more than 100°, no more than 95°, no more than 90°, no more than 85°, no more than 80°, no more than 75°, no more than 70°, no more than 60°, no more than 50°, no more than 40 °, etc. In some cases, the contact angle may be a combination of any of these. For example, the electrode or other component may have a contact angle of between 100° and 110°, between 75° and 120°, between 90° and 120°, between 80° and 130°, between 80° and 110°, between 50° and 120°, between 75° and 100°, between 75° and 90°, or the like. In some embodiments, certain ranges of contact angles, e.g., between 100° and 110°, may be surprisingly useful at minimizing fouling by microorganisms, as compared to other contact angles. Surprisingly, such contact angles do not correspond to extreme hydrophilicity or extreme hydrophobicity.

In some embodiments, the contact angles of the electrode components and surrounding materials may allow fouling to be minimized, and in some cases, while also maintaining good electrochemical performance and fluid handling. In some embodiments, surfaces of the electrode active material may be selected so as to maintain close contact at the atomic scale with the aqueous electrolyte. For instance, this may be promoted in certain cases by using wetting contact angles of less than 90°. However, highly wetting surfaces with small contact angles, e.g. below 40°, can also be undesirable in some embodiments, since they may promote fouling and/or may interfere with the swapping of fluids in contact with the electrode, e.g. during electrochemical ion exchange or galvanic ion extraction.

Other, non-active components of the electrode, such as binders, conducting additives, support structures and current collectors, may have larger contact angles in certain embodiments. In some embodiments, it may be desirable to avoid de-wetting and bubble generation, which can degrade the electrode and interfere with electron or ion transport. In some embodiments, some or all of the non-active components of the electrode may have contact angles, for example, that are in the range 70° to 120°, while electrochemically active materials may have lower contact angles in the range 40° to 90°. It should be understood that these contact angles are by way of example only, and other contact angles for non-active components or electrochemically active materials are described herein. In addition, surprisingly, the most highly wetting materials, e.g., with contact angles below 30°, may not always be optimal for electrochemical ion extraction and other electrochemical separations in aqueous environments.

A variety of techniques may be used to achieve such properties, e.g., for the electrode materials and surrounding components. For example, in one set of embodiments, an electrode or other component may contain one or more hydrophilic additives (for example, hydrophilic polymers or ceramics), and/or one or more hydrophobic additives (for example, hydrophobic polymers or ceramics). In some cases, only one hydrophilic additive is present, and/or only one hydrophobic additive is present. An additive may be present anywhere within an electrode or other component, for example, as part of a binder, as part of a coating, on at least a portion of a surface, as a specific layer, or the like. If more than one additive is present, they may be independently present in the same or different parts of the electrode or other component.

In some embodiments, hydrophobic and/or hydrophilic additives may be present in any suitable ratio that allows the electrode or other component to have a desired contact angle, e.g., such as those described above, and specific ratios to achieve a desired contact angle can be found without undue experimentation. For example, one or more hydrophobic or hydrophilic additives (for example, one or more hydrophobic and/or hydrophilic polymers or ceramics) may be present within an electrode or other component at at least 0.1 wt %, at least 0.2 wt %, at least 0.3 wt %, at least 0.5 wt %, at least 1 wt %, at least 2 wt %, at least 3 wt %, at least 5 wt %, at least 7 wt %, at least 10 wt %, at least 15 wt %, at least 20 wt %, at least 25 wt %, at least 30 wt %, at least 35 wt %, at least 40 wt %, at least 45 wt %, at least 50 wt %, within the electrode. In some embodiments, one or more hydrophobic additives may be present at no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 7 wt %, no more than 5 wt %, no more than 3 wt %, no more than 2 wt %, no more than 1 wt %, no more than 0.5 wt %, no more than 0.3 wt %, no more than 0.2 wt %, no more than 0.1 wt %, etc. Combinations of these are also possible in certain embodiments. For example, one or more hydrophobic additives may be present at between 30 wt % and 50 wt %, between 60 wt % and 80 wt %, between 5 wt % and 80 wt %, between 10 wt % and 20 wt %, or the like.

In some cases, a hydrophobic additive may be an additive that exhibits an air-water contact angle of greater than 90°, greater than 100°, greater than 110°, greater than 120°, greater than 130°, etc. In one set of embodiments, a hydrophobic additive may include one or more hydrophobic polymers. Other non-limiting examples of hydrophobic additives include carbons, waxes, nanostructured metals/metalloids, etc. Non-limiting examples of hydrophobic polymers include polytetrafluoroethylene (PTFE), fluoroethers, fluorinated ethylene propylene (FEP), silicone, polyvinylidene fluoride (PVDF), polypropylene, polystyrene, polyethylene terephthalate (PET), or the like. In some embodiments, silicone or silicone polymers may be used. For example, the silicone polymer may be a cross-linked silicone polymer, and or the silicone or silicone polymer may be infused with silicone oil.

For instance, in one set of embodiments, an electrode or other component may include silicone. The silicone, in some cases, may be present as a silicone polymer or rubber. In some cases, the silicone may be present within the electrode, for example, present within a binder, or within a polymer, or within or on the surfaces of other components, such as supports, spacers, current collectors, channels, tubing, compartments, stacks, tanks, reservoirs, pipes, channels, gaskets, separators, fluidic interconnects, electrical interconnects, etc. In some cases, the silicone may be present at at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, etc., and/or no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, etc. Combinations of these are also possible in certain embodiments.

In some cases, the silicone may be present within the electrode or other component may be present in a coating on at least a portion of the electrode or other component. For instance, the coating may cover at least 50%, at least 55%, at least 60%, at least 65%, at least 70%, at least 75%, at least 80%, at least 85%, at least 90%, at least 95%, at least 99%, etc. of an outer surface of the electrode or other component. In some cases, the coating covers all of the outer surface of the electrode or other component. The coating may be present, for example, as a paint on the surface of the electrode or other component.

In some embodiments, one or more hydrophilic additives may be present within an electrode (in addition to or instead of a hydrophobic additive). In certain embodiments, a hydrophilic additive may include a hydrophilic polymer. For example, one or more hydrophilic additives (for example, one or more hydrophobic polymers) may be present at at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, etc. within or on the surface of at least one material, e.g., a material within an electrode. In some embodiments, one or more hydrophilic additives may be present at no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, etc. Combinations of these are also possible in certain embodiments. For example, one or more hydrophilic additives may be present at between 30 wt % and 50 wt %, between 60 wt % and 80 wt %, between 5 wt % and 80 wt %, between 10 wt % and 20 wt %, or the like.

In some cases, a hydrophilic additive may be an additive that exhibits an air-water contact angle of less than 100°, less than 90°, less than 80°, less than 70°, less than 60°, etc. In one set of embodiments, a hydrophilic additive may include one or more hydrophilic polymers. Non-limiting examples of hydrophilic polymers include polyurethane, carboxymethyl cellulose (CMC), styrene-butadiene rubber (SBR), polyethylene glycol (PEG), Nafion, sulfonated tetrafluoroethylene, LA1333, polyacrylic latex, polyamide (PA), poly(methyl methacrylate) (PMMA), polyvinyl alcohol (PVA), polyacrylonitrile (PAN), polyvinyl chloride (PVC), polyethylene terephthalate (PET), or the like.

Other examples of hydrophilic additives include certain alkali metal salts. For example, in certain embodiments, a hydrophilic additive may comprise an alkali metal salts of alkylsulfonic acids or alkali metal salts of alkylbenzene sulfonic acids. One non-limiting example of such an alkali metal salt is sodium dodecylbenzene. As another non-limiting example, a hydrophilic additive may include a fluorosurfactant. The fluorosurfactant may be partially fluorinated, or perfluorinated. In some embodiments, the fluorosurfactant may include a polyethylene glycol polymer covalently bonded to a fluorinated hydrocarbon, a perfluorinated hydrocarbon bonded to a sulfonate, a perfluorinated hydrocarbon bonded to a quaternary ammonium, or the like. Still other non-limiting examples of hydrophilic additives include polydopamine, polyvinyl alcohol, etc.

In addition, in some cases, an electrode or other component may be treated to improve its hydrophilicity. Examples include, but are not limited to, thermal treatments, acid treatments, and/or surfactant treatments, etc. In addition, in some cases, a surfactant may be present in an electrode or other component, e.g., at formation, and/or a surfactant may be added to the electrode or other component, e.g., after formation. Non-limiting examples of surfactants include sorbitan monostearate, sorbitan trioleate, sorbitan tristearate, sorbitan monolaurate, an ethoxylated sorbitan ester, a polysorbate, a dodecylbenzenesulfonate salt., sodium dodecyl sulfate (SDS), or the like.

In some cases, for example, a surfactant may be present in a coating on at least a portion of the electrode or other component. For instance, the coating may cover at least 50%, at least 55%, at least 60%, at least 65%, at least 70%, at least 75%, at least 80%, at least 85%, at least 90%, at least 95%, at least 99%, etc. of an outer surface of the electrode or other component. In some cases, the coating covers all of the outer surface of the electrode or other component. The coating may be present, for example, as a paint on the surface of the electrode or other component.

In another set of embodiments, the hydrophobic or hydrophilic additive or coating may include one or more inorganic materials. Non-limiting examples of hydrophilic inorganic ceramics include silica, alumina, zirconia, titania, silicon carbide, ceria, perovskites, metal oxides, and photocatalysts, such as titanium oxide, tungsten oxide, tin oxide, and zirconium oxide, etc. In some embodiments, the material may have a wettability that can be controlled using techniques such as irradiation (photo-induced hydrophilicity), plasma treatment, chemical decomposition of surface films, surface roughness, etc. Most ceramic surfaces are hydrophilic, but contact angles approaching 100° can be achieved by certain processing conditions, such as plasma treatment, phase separation, and water vapor exposure during sol-gel synthesis. In some cases, the ceramic surface may have a contact angle of at least 30°, at least 40°, at least 50°, at least 60°, at least 70°, at least 75°, at least 80°, at least 85°, at least 90°, at least 95°, at least 100°, etc., and/or no more than 100°, no more than 95°, no more than 90°, no more than 85°, no more than 80°, no more than 75°, no more than 70°, no more than 60°, no more than 50°, no more than 40°, etc. In some cases, the contact angle may be a combination of any of these.

In another set of embodiments, the hydrophobic or hydrophilic additive or coating may include one or a combination of organic and inorganic materials. Non-limiting examples of hydrophilic mixed organic-inorganic materials include metal-organic frameworks. Non-limiting examples hydrophobic organic-inorganic materials include ceramics, such as titania or alumina, coated with carbons, silanes, fluoroalkanosilanes, fluoropolymers, etc.

In some aspects, an electrode (e.g., or a portion thereof, e.g., an exposed or outer surface of the electrode), or other component, may contain one or more lyotropic ions, e.g., as functionalizations on the surface of an electrode or other component. Without wishing to be bound by any theory, it is believed that lyotrophic ions may strengthen hydrophobic interactions of proteins presented by microorganism membranes, which may impede the growth of such microorganisms, and thus reduce fouling of surfaces.

Certain lyotropic ions are able to salt out or salt in proteins, e.g., by altering their solubility. The changes in solubility may be due to changes in their secondary and/or tertiary structures caused by such lyotropic ions. In some cases, certain lyotropic ions can lower the surface tension of solvents and thus strengthen hydrophobic interactions. Lyotropic ions can also act as biocides and/or impart anti-fouling properties in certain embodiments. Non-limiting examples of lyotropic anions include F⁻, SO₄⁻, HPO₄²⁻, C₂H₃O₂⁻, Cl⁻, Br⁻, etc. in order of decreasing lyotropicity in the Hofmeister series. Non-limiting examples of cationic lyotropic ions include NH₄⁺, K⁺, Na⁺, Li⁺, Mg²⁺, Ca²⁺, etc. in order of decreasing lyotropicity. In addition, in one embodiment, the lyotropic ion may be a quaternary ammonium cation, also known as “quat,” with the chemical formula [NR₄]⁺, where R may be, for example, an alkyl, organyl, or aryl group. This may be contained, for example, in a quaternary ammonium salt, quaternary ammonium compound, or a polymer (e.g., a “polyquat”), for example, to impart biocidal or anti-fouling properties.

The lyotropic ions may be present anywhere within an electrode or other component, for example, as part of a binder, as part of a coating, on at least a portion of a surface, as a specific layer, or the like. If more than one lyotropic ion is present, they may be independently present in the same or different parts of the electrode or other component. For example, the lyotropic ion may be present in a coating on at least a portion of an electrode or other component. For instance, the coating may cover at least 50%, at least 55%, at least 60%, at least 65%, at least 70%, at least 75%, at least 80%, at least 85%, at least 90%, at least 95%, at least 99%, etc. of an outer surface of the electrode or other component. In some cases, the coating covers all of the outer surface of the electrode or other component. The coating may be present, for example, as a paint on the surface of the electrode. In other embodiments, the lyotropic ions are integrated in or coated on an internal surface of a binder, conducting additive or active material, e.g., in a porous electrode. For instance, the coating may cover at least 50%, at least 55%, at least 60%, at least 65%, at least 70%, at least 75%, at least 80%, at least 85%, at least 90%, at least 95%, at least 99%, etc. of an internal surface of one or more of the materials within the porous electrode.

The lyotropic ions may be present at any suitable concentration. For example, in some cases, the lyotropic ions may be present at a concentration that is able to cause precipitation of 1 M albumin in water under ambient conditions. For example, the lyotropic ions may be present at a concentration of at least 1 wt %, at least 2 wt %, at least 3 wt %, at least 5 wt %, at least 7 wt %, or at least 10 wt % of the electrode or other component. In some cases, the lyotropic ions may be present at a concentration of no more than 10 wt %, no more than 7 wt %, no more than 5 wt %, no more than 3 wt %, no more than 2 wt %, no more than 1 wt %, etc. Combinations of any of these are also possible, e.g., a lyotropic ion may be present in an electrode or other component at between 2 wt % and 3 wt %, between 5 wt % and 7 wt %, etc. In some cases, the presence of lyotropic ions may also be determined by electrokinetic measurements, such as streaming potential in a microslit containing the sample on its surfaces, where electrolyotropic theory is used to determine ion pairing dissociation constants. Chemical composition involving lyotropic ions may also be detected by chromatography for organic compounds and/or spectroscopy for crystal structures, etc.

In another aspect, an electrode (e.g., or a portion thereof, e.g., an exposed or outer surface of the electrode, or an internal surface of an active material, binder, conducting additive, etc.), or other component, may contain one or more zwitterionic materials, e.g., as functionalizations on the surface of an electrode or other component. Typically, a zwitterionic material will contain a comparable number of positive and negative functional groups, e.g., under conditions in which the electrode or other component is used. In some cases, the material may be zwitterionic at neutral pH, and/or when exposed to a target-ion rich or target-ion poor solution. Without wishing to be bound by any theory, it is believed that many microorganisms are unable to adhere well to such zwitterionic materials. For example, in some cases, the zwitterionic material may have an atomically heterogeneous surface charge, which may be able to disrupt the binding of proteins produced by microorganisms, e.g., during binding. Accordingly, using zwitterionic materials in an electrode or other component may allow it to better resist fouling by microorganisms.

Non-limiting examples of potentially useful zwitterionic materials include amino acids, sulfamic acid, anthranilic acid, H₄EDTA, psilocybin, trimethylglycine, betaines, glycine betaines, sulfobetaines, etc.

The zwitterionic material may be present at any suitable concentration. For example, in some cases, the zwitterionic material may be present at a concentration of at least 1 wt %, at least 2 wt %, at least 3 wt %, at least 5 wt %, at least 7 wt %, or at least 10 wt % of the electrode or other component. In some cases, the zwitterionic material may be present at a concentration of no more than 10 wt %, no more than 7 wt %, no more than 5 wt %, no more than 3 wt %, no more than 2 wt %, no more than 1 wt %, etc. Combinations of any of these are also possible, e.g., a zwitterionic material may be present in an electrode or other component at between 2 wt % and 3 wt %, between 5 wt % and 7 wt %, etc.

The zwitterionic material may be present anywhere within an electrode or other component, for example, as part of a binder, as part of a coating, on at least a portion of a surface, as a specific layer, or the like. If more than one zwitterionic material is present, they may be independently present in the same or different parts of the electrode or other component. For example, the zwitterionic material may be present in a coating on at least a portion of an electrode or other component. For instance, the coating may cover at least 50%, at least 55%, at least 60%, at least 65%, at least 70%, at least 75%, at least 80%, at least 85%, at least 90%, at least 95%, at least 99%, etc. of an outer surface of the electrode or other component. In some cases, the coating covers all of the outer surface of the electrode or other component. The coating may be present, for example, as a paint on the surface of the electrode or other component.

In certain aspects, an electrode (e.g., or a portion thereof, e.g., an exposed or outer surface of the electrode), or other component, may contain a biocide. The biocide may be any chemical that kills microorganisms exposed to it, or at least impedes their growth.

Examples of biocides include fungicides, microbicides, bactericides, or the like, and many such biocides are readily available commercially. For instance, in one set of embodiments, a biocide may include metal ions, e.g., preset within a component. Non-limiting examples of suitable metal ions include copper, zinc, silver, or the like. These may be present as metals, or as salts, etc. Non-limiting examples of salts include oxides, hydroxides, sulfates, sulfides, chlorides, chlorites, or the like. In some embodiments, the biocide may include sodium hypochlorite (NaClO). Biocides may also be present as quaternary ammonium salts, compounds, polymers, etc., including any of those described herein.

In some cases, a biocide may be contained within a bead, e.g., a ceramic or polymer bead, e.g., which can allow for slow release of the biocide. In some cases, the ceramic bead may have an average dimension of less than 1 cm, less than 5 mm, less than 3 mm, less than 1 mm, less than 500 micrometers, less than 300 micrometers, less than 100 micrometers, etc.

The biocide may be present at any suitable concentration. For example, in some cases, the biocide may be present at a concentration of at least 0.01 wt %, at least 0.02 wt %, at least 0.03 wt %, at least 0.05 wt %, at least 0.1 wt %, at least 0.2 wt %, at least 0.3 wt %, at least 0.5 wt %, at least 1 wt %, at least 2 wt %, at least 3 wt %, at least 5 wt %, at least 7 wt %, or at least 10 wt % of the electrode or other component. In some cases, the biocide may be present at a concentration of no more than 10 wt %, no more than 7 wt %, no more than 5 wt %, no more than 3 wt %, no more than 2 wt %, no more than 1 wt %, no more than 0.5 wt %, no more than 0.3 wt %, no more than 0.2 wt %, no more than 0.1 wt %, no more than 0.05 wt %, no more than 0.03 wt %, no more than 0.02 wt %, no more than 0.01 wt %, etc. Combinations of any of these are also possible, e.g., a biocide may be present in an electrode or other component at between 2 wt % and 3 wt %, between 5 wt % and 7 wt %, etc.

The biocide may be present anywhere within an electrode or other component, for example, as part of a binder, as part of a coating, on at least a portion of a surface, as a specific layer, or the like. If more than one biocide is present, they may be independently present in the same or different parts of the electrode or other component. For example, the biocide may be present in a coating on at least a portion of an electrode or other component. For instance, the coating may cover at least 50%, at least 55%, at least 60%, at least 65%, at least 70%, at least 75%, at least 80%, at least 85%, at least 90%, at least 95%, at least 99%, etc. of an outer surface of the electrode or other component. In some cases, the coating covers all of the outer surface of the electrode or other component. The coating may be present, for example, as a paint on the surface of the electrode or other component.

Thus, in certain aspects, an electrode or other component may contain an anti-fouling coating, e.g., on at least a portion of an electrode or other component. For instance, the coating may cover at least 50%, at least 55%, at least 60%, at least 65%, at least 70%, at least 75%, at least 80%, at least 85%, at least 90%, at least 95%, at least 99%, etc. of an outer surface of the electrode or other component. In some cases, the coating covers all of the outer surface of the electrode or other component. The coating may be present, for example, as a paint on the surface of the electrode or other component.

An anti-fouling coating may, for example, contain certain anti-fouling polymers such as, but not limited to, polyethylene (PE), polypropylene (PP), polystyrene (PS), or the like. As another example, an anti-fouling coating may contain one or more hydrophilic additives (for example, hydrophilic polymers), and/or one or more hydrophobic additives (for example, hydrophobic polymers). Specific non-limiting examples include any of those hydrophilic additives and/or hydrophobic additives described herein. As yet other non-limiting examples, an anti-fouling coating may include one or more lyotropic ions, zwitterionic materials, biocides, corrosion inhibitors, reaction inhibitors, antioxidants, oxygen scavengers, pH buffers, etc. Specific non-limiting examples of these and/or other compounds or treatments are described in more detail herein.

In other embodiments, an anti-fouling coating may include quaternary ammonium salts and compounds, such as those described herein. The anti-fouling coating may also contain polymers in certain embodiments. Non-limiting examples of anti-fouling polymers include polytetrafluoroethylene (PTFE), polyvinylidene fluoride (PVDF), polypropylene, silicone, polyethylene glycol (PEG), polyethylene (PE), polypropylene (PP), polystyrene (PS), etc. as well as quaternary ammonium polymers (polyquats).

In yet another aspect, an electrode (e.g., or a portion thereof, e.g., an exposed or outer surface of the electrode), or other component, may contain one or more corrosion inhibitors. Without wishing to be bound by any theory, it is believed that certain materials that may be present in an electrode or other component may be susceptible to oxygen reactions, due to exposure to oxygen (for example, from air, or being dissolved), water, or the like, e.g., within a target-ion rich or target-ion poor fluid, a rinse fluid, or the like. In some cases, oxygen-based or chloride-based reactions may cause corrosion of the electrode or other components. Accordingly, certain embodiments are generally directed to reducing or preventing corrosion, e.g., using one or more corrosion inhibitors, or other techniques such as those described herein. Non-limiting examples of corrosion inhibitors include oxygen scavengers, antioxidants, certain metals, reaction inhibitors, coatings, pH buffers, or the like. In some cases, more than one type of corrosion inhibitor may independently be present, e.g., within an apparatus, and different components within an apparatus may independently contain the same or different corrosion inhibitors. In certain embodiments, the amount of corrosion resistance may be determined using ASTM B117-19 Salt Spray (2019), ASTM G85-19 Modified Salt Spray (2019), ASTM G85 Cyclic Corrosion (2019), and/or ASTM G1-03 Corrosion Test (2003), which are herein incorporated by reference in their entirety.

For example, in one set of embodiments, an electrode or other component may include one or more metals that can function as corrosion inhibitors. Without wishing to be bound by any theory, such metals may corrode or oxidize more readily, thereby reducing or inhibiting corrosion of other metals or materials within the electrode or other component. Examples of such “sacrificial” metals that may be used as corrosion inhibitors include, but are not limited to, zinc, aluminum, magnesium, titanium, or the like. These may be present as pure metals, or as metal compounds or salts. Non-limiting examples of salts include phosphates, chlorides, fluorides, sulfides, iodides, or the like.

In another set of embodiments, a corrosion inhibitor may include a reactor inhibitor. Reaction inhibitors may inhibit certain oxidation reactions, and thus inhibit corrosion, e.g., of an electrode or other component. Non-limiting examples include amines, hydrazines, hexamines, phenylenediamine, dimethylethanolamine, or the like.

In some cases, a corrosion inhibitor may include an antioxidant. Antioxidants may be present, for example, to inhibit oxidation reactions, and/or to inhibit the production of free radicals in some cases. Non-limiting examples of antioxidants include sulfite, ascorbic acid, polyphenols, tocopherols, glutathione, mycothiol, bacilithiol, stilbenes, dflavonoids, hydroxycinnamic acid, BHT, etc.

In certain cases, a corrosion inhibitor may include an oxygen scavenger or an oxygen absorber. Without wishing to be bound by any theory, such oxygen scavengers may oxidize more readily, thereby reducing or inhibiting corrosion of other metals or materials within the electrode or other component. Non-limiting examples of oxygen scavengers include ferrous carbonate, ascorbic acid, pyrogallic acid, or the like.

The corrosion inhibitor may be present at any suitable concentration. For example, in some cases, the corrosion inhibitor may be present at a concentration of at least 0.01 wt %, at least 0.02 wt %, at least 0.03 wt %, at least 0.05 wt %, at least 0.1 wt %, at least 0.2 wt %, at least 0.3 wt %, at least 0.5 wt %, at least 1 wt %, at least 1 wt %, at least 2 wt %, at least 3 wt %, at least 5 wt %, at least 7 wt %, or at least 10 wt % of at least one material comprising the electrode or other component. In some cases, the corrosion inhibitor may be present at a concentration of no more than 10 wt %, no more than 7 wt %, no more than 5 wt %, no more than 3 wt %, no more than 2 wt %, no more than 1 wt %, no more than 0.5 wt %, no more than 0.3 wt %, no more than 0.2 wt %, no more than 0.1 wt %, no more than 0.05 wt %, no more than 0.03 wt %, no more than 0.2 wt %, no more than 0.01 wt %, etc. Combinations of any of these are also possible, e.g., a corrosion inhibitor may be present in at least one material of an electrode or other component at between 2 wt % and 3 wt %, between 5 wt % and 7 wt %, etc.

The corrosion inhibitor may be present anywhere within an electrode or other component, for example, as part of a binder, as part of a coating, on at least a portion of a surface, as a specific layer, or the like. For example, in some cases, a coating comprising a polymer, a paint, a galvanic protection layer, a functional coating, a ceramic layer, a carbonaceous layer, or the like may function as an anti-corrosion coating. In some embodiments, the corrosion inhibitor may prevent or reduce leaching of metal ions from the active material. In certain cases, the corrosion inhibitor may prevent or reduce oxidation or reduction reactions at the internal surfaces of the active material, conducting additive, or the current collector, etc. If more than one corrosion inhibitor is present, they may be independently present in the same or different parts of the electrode or other component. For example, the corrosion inhibitor may be present in a coating on at least a portion of an electrode or other component. For instance, the coating may cover at least 50%, at least 55%, at least 60%, at least 65%, at least 70%, at least 75%, at least 80%, at least 85%, at least 90%, at least 95%, at least 99%, etc. of an outer surface of the electrode or other component. In some cases, the coating covers all of the outer surface of the electrode or other component. The coating may be present, for example, as a paint on the surface of the electrode or other component. In certain embodiments, the coating can be present as a surface treatment of the active material, conducting additive, or current collector, for example, by using treatments such as chemical vapor deposition, plasma treatment, chemical precipitation, electrodeposition.

In addition, in certain aspects, an electrode (e.g., or a portion thereof, e.g., an exposed or outer surface of the electrode), or other component, may contain a pH buffer. The pH buffer may be helpful to buffer the pH, e.g., experienced by the electrode or other component, to a desired range. For example, the pH buffer may be constructed to buffer the pH to at least 3, at least 3.5, at least 4, at least 4.5, at least 5, at least 5.5, at least 6, at least 6.5, at least 7, and/or no more than 11, no more than 10.5, no more than 10, no more than 9.5, no more than 9, no more than 8.5, no more than 8, no more than 7.5, no more than 7, etc. For example, the pH may be buffered to be between 6 and 8, between 5 and 7, between 7 and 9, e.g., near an electrode or other component. In certain embodiments, the pH buffer may include a weak acid and its conjugate base. In some cases, the weak acid has a pKₐ of at least 2, at least 3, or at least 4. Specific non-limiting examples include borate, boric acid, citric acid, acetic acid, monopotassium phosphate, carbonic acid, phosphonic acid, polymethylacrylic acid, which can be, in some embodiments, supported on a solid polymer substrate, nanoparticle or bead.

The pH buffer may be present anywhere within an electrode or other component, for example, as part of a binder, as part of a coating, on at least a portion of a surface, as a specific layer, or the like. If more than one pH buffer is present, they may be independently present in the same or different parts of the electrode or other component. For example, the pH buffer may be present in a coating on at least a portion of an electrode or other component. For instance, the coating may cover at least 50%, at least 55%, at least 60%, at least 65%, at least 70%, at least 75%, at least 80%, at least 85%, at least 90%, at least 95%, at least 99%, etc. of an outer surface of the electrode or other component. In some cases, the coating covers all of the outer surface of the electrode or other component. The coating may be present, for example, as a paint on the surface of the electrode or other component. In some embodiments, the pH buffer may be present within an internal surfaces of the active material, binder, conducting additive of the electrode. In some embodiments, the pH buffer may be contained in a separate chamber, sponge, membrane, or vessel that is able to exchange ions with a solution around the electrodes or components, e.g., to provide pH buffering.

The pH buffer may be present at any suitable concentration. For example, the pH buffer may be present at a concentration of at least 0.1 wt %, at least 0.2 wt %, at least 0.3 wt %, at least 0.5 wt %, at least 1 wt %, at least 2 wt %, at least 3 wt %, at least 5 wt %, at least 7 wt %, or at least 10 wt % of the electrode or other component. In some cases, the pH buffer may be present at a concentration of no more than 10 wt %, no more than 7 wt %, no more than 5 wt %, no more than 3 wt %, no more than 2 wt %, no more than 1 wt %, no more than 0.5 wt %, no more than 0.3 wt %, no more than 0.2 wt %, no more than 0.1 wt %, etc. Combinations of any of these are also possible, e.g., a pH buffer may be present in an electrode or other component at between 2 wt % and 3 wt %, between 5 wt % and 7 wt %, etc.

Certain aspects are generally directed to mechanical stability additives that can be added to improve the mechanical stability or robustness of electrodes and/or other components of an apparatus, which may in some cases be exposed to compressive, tensile, or shear loading of the solid phases, shear stress and erosion caused by the liquid phases, etc.

Examples of additives include, but are not limited to, fibers, metal fibers, wires, metal wires, powders, metal powders, fibers, carbon fibers, nanotubes, carbon nanotubes, graphene, PTFE, PVDF, polypropylene, aluminum oxide, titanium oxide, and/or zirconium oxide, etc. If more than one mechanical stability additive or is present, they may be independently present in the same or different parts of the electrode or other component. In some cases, the additives may be determined using microscopy techniques, stress/strain curves, localized or rapid heating or cooling, or the like.

For example, a mechanical stability additive may be present to allow the elastic compression modulus of an electrode or other component to be at least 1 MPa, at least 2 MPa, at least 3 MPa, at least 4 MPa, at least 5 MPa, at least 6 MPa, at least 7 MPa, at least 8 MPa, at least 9 MPa, at least 10 MPa, etc. a mechanical stability additive may be present to allow the compressive strength of an electrode or other component to be at least 0.1 MPa, at least 0.2 MPa, at least 0.3 MPa, at least 0.4 MPa, at least 0.5 MPa, at least 0.6 MPa, at least 0.7 MPa, at least 0.8 MPa, at least 0.9 MPa, at least 1 MPa, etc. In some embodiments, a mechanical stability additive may be present to allow the specific toughness of an electrode or other component to be at least 1 mJ/cm³, at least 2 mJ/cm³, at least 3 mJ/cm³, at least 4 mJ/cm³, at least 5 mJ/cm³, at least 6 mJ/cm³, at least 7 mJ/cm³, at least 8 mJ/cm³, at least 9 mJ/cm³, at least 10 mJ/cm³, etc.

The mechanical stability additive may be present at any suitable concentration. For example, in some cases, the additive may be present at a concentration of at least 1 wt %, at least 2 wt %, at least 3 wt %, at least 5 wt %, at least 7 wt %, at least 10 wt %, at least 15 wt %, at least 20 wt %, at least 25 wt %, or at least 30 wt % of the electrode or other component. In some cases, the additive may be present at a concentration of no more than 30 wt %, no more than 25 wt %, no more than 20 wt %, no more than 15 wt %, no more than 10 wt %, no more than 7 wt %, no more than 5 wt %, no more than 3 wt %, no more than 2 wt %, no more than 1 wt %, etc. Combinations of any of these are also possible, e.g., an additive may be present in an electrode or other component at between 2 wt % and 3 wt %, between 5 wt % and 7 wt %, etc.

The additive may be present anywhere within an electrode or other component, for example, as part of a binder, as part of a coating, on at least a portion of a surface, as a specific layer, or the like. If more than one additive is present, they may be independently present in the same or different parts of the electrode or other component. For example, the additive may be present in a coating on at least a portion of an electrode or other component. For instance, the coating may cover at least 50%, at least 55%, at least 60%, at least 65%, at least 70%, at least 75%, at least 80%, at least 85%, at least 90%, at least 95%, at least 99%, etc. of an outer surface of the electrode or other component. In some cases, the coating covers all of the outer surface of the electrode or other component. The coating may be present, for example, as a paint on the surface of the electrode or other component or other component.

In addition, in certain aspects, corrosion or fouling may be treated by exposing surfaces (e.g., of electrodes or other components) to at least partially remove surface corrosion or fouling, e.g., using chemical or physical approaches. In some cases, an anti-corrosion fluid and/or an anti-fouling fluid may be used, e.g., passed through a compartment within an apparatus. In some embodiments, alkaline cleaning may be performed by flowing an aqueous solution containing a base, such as sodium hydroxide (NaOH), sodium bicarbonate (NaHCO₃), or sodium hypochlorite (NaClO). In some cases, such bases may be able to remove silica and other inorganic fouling or corrosion products. For example, the pH of the base may be at least 9, at least 10, at least 11, or more. In some embodiments, acid cleaning may be performed by flowing an aqueous solution containing an acid, such as hydrochloric acid, citric acid, formic acid, or acetic acid, which in some embodiments may be able to dissolve and remove limescale, hard water scale, or other inorganic fouling and corrosion products. In some cases, the pH may be less than 5, less than 4, or less than 3, etc. In some embodiments, acid cleaning may be performed on electrodes or components for processing high-temperature aqueous solutions, such as geothermal brines.

For example, in one embodiment, a biocide (e.g., including any of those discussed herein) may be added to a fluid flowing through a compartment (for example, a rinse fluid, a target ion-rich fluid, a target-ion poor fluid, etc.), in order to treat fouling. As other non-limiting examples, a fluid (for example, a rinse fluid, a target ion-rich fluid, a target-ion poor fluid, etc.) may contain lyotropic ions, zwitterionic materials, corrosion inhibitors, reaction inhibitors, antioxidants, oxygen scavengers, pH buffers, acids, bases, organic extractants, coagulants, flocculants, etc. Specific non-limiting examples of these include any of those described herein.

As another example, fouling and/or corrosion may be treated using physical techniques. For example, in one set of embodiments, a fluid (for example a rinse fluid) may be passed through a compartment at relative high speeds, and/or be applied at relatively high pressures. In some cases, this may cause various shear forces or stresses to be applied to the compartment and/or components within the compartment, such as electrodes. Such shear forces, in certain embodiments, may be helpful to remove fluids from the compartment (e.g., a first fluid), and/or to at least partially remove products of corrosion, scaling, fouling, or biofouling, etc., such as colloidal particles, sediments, chemical deposits, electrochemical deposits, microorganisms, or the like from the compartment (for example, from the surfaces of electrodes or other components within the compartment).

In some cases, the pressure (gauge pressure) that the fluid is applied may be at least 50 kPa, at least 100 kPa, at least 200 kPa, at least 300 kPa, at least 1 MPa, at least 2 MPa, at least 5 MPa, at least 10 MPa, at least 20 MPa, etc. In some cases, the rinse fluid may cause a shear stress to be applied to a surface within the compartment (e.g., the surface of an electrode) of at least 1 kPa, at least 2 kPa, at least 3 kPa, at least 5 kPa at least 10 kPa, at least 20 kPa, at least 30 kPa, at least 50 kPa, at least 100 kPa, etc. The shear stress for liquid and/or solid removal, and/or surface cleaning may depend on factors such as surface roughness, particle or grain size (e.g., for solid deposits), liquid/vapor contact angle, or viscosity (e.g., for liquid deposits), etc.

As another example, an abrasive fluid, e.g., a suspension or a slurry, may be passed through a compartment to at least partially remove or treat fouling or corrosion, e.g., on surfaces of an electrode or other components). In some embodiments, an abrasive fluid may contain suspended particles, which can abrade surfaces within the compartment, for example, electrode surfaces. In some cases, such abrasion may be sufficient to at least partially remove corrosion, fouling, microorganisms, or the like from the compartment.

In some cases, the suspended particles within an abrasive fluid may have an average size or diameter of at least 10 nm, at least 20 nm, at least 30 nm, at least 50 nm, at least 100 nm, at least 200 nm, at least 300 nm, at least 500 nm, at least 1 micrometer, at least 2 micrometers, at least 3 micrometers, at least 5 micrometers, at least 10 micrometers, at least 20 micrometers, at least 30 micrometers, at least 50 micrometers, at least 100 micrometers, etc. In certain embodiments, the suspended particles may have an average size or diameter of less than 100 micrometers, less than 50 micrometers, less than 30 micrometers, less than 20 micrometers, less than 10 micrometers, less than 5 micrometers, less than 3 micrometers, less than 2 micrometers, less than 1 micrometer, less than 500 nm, less than 300 nm, less than 200 nm, less than 100 nm, less than 50 nm, less than 30 nm, less than 20 nm, less than 10 nm, etc. Combinations of any of these sizes are also possible, e.g., the suspended particles may have an average size or diameter between 100 nm and 1 micrometer, between 20 micrometers and 50 micrometers, between 100 nm and 300 nm, etc.

The particles may be formed out of any suitable material. For instance, in one set of embodiments, the particles may include ceramic particles. Non-limiting examples include zirconia, alumina, silica, glass, sand, silicon carbide (SiC), silicon nitride, zirconia, silica, borosilicate glass, or the like. Other examples of ceramics include, but are not limited to, oxides, carbides, phosphates, carbonates, etc. of metals and metalloids such as calcium, titanium, silicon, etc. In addition, other materials, such as metals, glass, or the like, may be used in certain embodiments.

In some cases, the suspended particles may be present at a concentration of at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, etc. of the fluid.

In addition, certain aspects are directed to minimizing or avoiding phase transitions of aqueous solutions within an electrode or another component, such as evaporation, condensation, boiling, and freezing. In some cases, this may improve electrode performance or lifetime, e.g., under extreme temperatures. For example, in certain embodiments, elevated temperatures may cause evaporation, drying, boiling, etc., which may be encountered during electrochemical ion extraction in hot climates, exposure to intense solar radiation, proximity of engines or hot machinery, etc. as well as in processing of warm aqueous solutions, such as geothermal brines or industrial effluents. In some cases, lowered temperatures, which may cause condensation and/or and freezing, may be encountered during electrochemical ion extraction in cold climates or exposure to snow and ice, as well as in processing of cold aqueous solutions such as polar brines, ice brines, seawater, and melting glaciers.

In some embodiments, electrodes and/or components may operate at low temperatures, e.g., below the freezing point of water. Without wishing to be bound by any theory, it is believed that dissolved solids and ions typically present at high concentrations may lower the freezing point of the solution, e.g., by up to 10° C., although electrodes or components may also be exposed to dilute solutions, which may freeze closer to 0° C. Thus, for instance, in some embodiments, an anti-freeze chemical may be present, for example, in an electrode (e.g., or a portion thereof, e.g., an exposed or outer surface of the electrode), or other component.

Non-limiting examples of anti-freeze chemicals include ethylene glycol, propylene glycol, methanol, isopropanol, antifreeze proteins, cryoprotectants, organic acids, sodium silicate, disodium phosphate, dextrin, or the like. In some cases, one or more ani-freeze chemicals may be incorporated into an electrode (e.g., blended and cross-linked into a polymeric binder) or other component.

In certain embodiments, the presence of charged nanopores in the electrodes or components, e.g., as in sulfonated porous carbons, defected metal-organic frameworks, and cementitious materials, etc., may allow cryotolerance by nanofluidic salt trapping, in some cases lowering the freezing point locally by 10° C. to 40° C. In some cases, an electrode may generate heat (for example, by Joule heating, exothermic reactions, etc.). In some embodiments, thermally insulating materials may be present, e.g., within binders, active materials, conducting additives, packaging and component materials. Such materials may, for example, be used to trap heat, suppress freezing, or the like. In some embodiments, flows of warmer fluids, such as brine, recovery fluid, rinse fluid, etc., may be used, for example, to heat the electrodes and/or compartments, for example, by convection. The heating may be, for instance, continuous or periodic. In some embodiments, current, e.g., delivered as pulses or continuously, may be used to produce Joule heating. In some embodiments, local heating elements, e.g., that can operate by resistive heating, phase change, convection, radiation, etc. may be present in an electrode or another component.

The anti-freeze chemical may be present at any suitable concentration. For example, the anti-freeze chemical may be present at a concentration of at least 0.1 wt %, at least 0.2 wt %, at least 0.3 wt %, at least 0.5 wt %, at least 1 wt %, at least 2 wt %, at least 3 wt %, at least 5 wt %, at least 7 wt %, or at least 10 wt % of the electrode or other component. In some cases, the anti-freeze chemical may be present at a concentration of no more than 10 wt %, no more than 7 wt %, no more than 5 wt %, no more than 3 wt %, no more than 2 wt %, no more than 1 wt %, no more than 0.5 wt %, no more than 0.3 wt %, no more than 0.2 wt %, no more than 0.1 wt %, etc. Combinations of any of these are also possible, e.g., an anti-freeze chemical may be present in an electrode or other component at between 2 wt % and 3 wt %, between 5 wt % and 7 wt %, etc.

In some embodiments, electrodes and/or components may operate at high temperatures, e.g., above the boiling point of water. For example, an anti-boiling coolant chemical may be present, for example, in an electrode (e.g., or a portion thereof, e.g., an exposed or outer surface of the electrode), or other component. Examples of such anti-boiling coolant chemicals include, but are not limited to, the anti-freeze chemicals and hydrophilic materials described herein. Specific non-limiting examples include ethylene glycol or polyethylene glycol (PEG). Such chemicals may be incorporated into an electrode (e.g., blended and cross-linked into a polymeric binder) or other component.

In some cases, boiling chips and/or surface treatments causing nanoscale roughness may also be present. These may be useful, for example, to control bubble nucleation, avoid large bubble generation, etc., which may damage electrodes or components in certain cases. In some embodiments, thermally conductive materials may be present, e.g., in binders, active materials, conducting additives, packaging, component materials, etc., e.g., to remove heat, suppress evaporation or boiling, etc. In some embodiments, flows of colder fluids, such as brine, recovery fluid, rinse fluid, etc., can be used to cool the electrodes and/or components, e.g., by convection. The cooling may be, for instance, continuous or periodic. In certain embodiments, local cooling elements, e.g., that can operate by convection, phase change, etc., may be present in an electrode or another components.

The anti-boiling coolant chemical may be present at any suitable concentration. For example, the anti-boiling coolant chemical may be present at a concentration of at least 0.1 wt %, at least 0.2 wt %, at least 0.3 wt %, at least 0.5 wt %, at least 1 wt %, at least 2 wt %, at least 3 wt %, at least 5 wt %, at least 7 wt %, or at least 10 wt % of the electrode or other component. In some cases, the anti-boiling coolant chemical may be present at a concentration of no more than 10 wt %, no more than 7 wt %, no more than 5 wt %, no more than 3 wt %, no more than 2 wt %, no more than 1 wt %, no more than 0.5 wt %, no more than 0.3 wt %, no more than 0.2 wt %, no more than 0.1 wt %, etc. Combinations of any of these are also possible, e.g., an anti-boiling coolant chemical may be present in an electrode or other component at between 2 wt % and 3 wt %, between 5 wt % and 7 wt %, etc.

Certain aspects are generally directed to lithium-selective electrodes. As discussed, the lithium-selective electrodes may preferentially allow lithium to be incorporated (e.g., deposited, intercalated, etc.) or removed therefrom, relative to other co-ions (e.g., cations or positively charged ions) such as sodium, calcium, magnesium, or other competing ions. The lithium-selective electrode may comprise an active material such as an active battery cathode material. The active material, in one set of embodiments, can be a material that is selective for reaction with lithium ions versus other competing co-ions. Thus, for example, the active material may be a material that preferentially reacts with lithium ions in solution, e.g., such that the lithium ions can be incorporated into the electrode due to such reaction. The incorporation may occur by ion intercalation, electrosorption, electrodeposition, or the like, as well as combinations of these and/or other processes in certain embodiments. In some cases, this reaction may be reversible, e.g., such that the incorporated lithium can be released from the active material to enter solution as lithium ions.

In some cases, the active material may be material that forms a lithium salt, reduced lithium metal, and/or a material that intercalates lithium ions as compensating electrons reduce the host material. The active material may be, for example, a lithium-ion battery active material, such as a lithium-ion intercalation material. In addition, in some cases, more than one such active material may be present, including any one or more of the active materials described herein, and/or other active materials.

For instance, in one embodiment, the active material may comprise a lithium metal phosphate, LiMePO₄, where Me can be a transition metal such as iron (e.g., lithium iron phosphate, LiFePO₄ or LFP), titanium (e.g., lithium titanium phosphate, LiTi₂(PO₄)₃ or LTP), manganese, nickel, cobalt, or the like, or a mixture of transition metals such as manganese, iron, cobalt, nickel, etc. (e.g. lithium manganese iron phosphate, LiMnₓFe₁₋ₓPO₄ or LMFP). In some cases, more than one such metal may be present, including these and/or other suitable metals. For example, the active material may include a blend of LTP and LFP, a composition comprising lithium iron titanium phosphate, other blends, or the like. In some embodiments, smaller quantities of metals, for example, transition metals such as manganese or nickel, may be present, e.g., within the active material, e.g., lithium iron manganese nickel phosphate, LiFe_{1-x-y}MnₓNi_{y}PO₄, where x and y are each independently less than 1.

In some cases, the active material may include a lithium transition-metal oxide, LiMeO₂, where Me can be a transition metal. Non-limiting examples include manganese (e.g., lithium manganese oxide, layered LiMnO₂ or LMO, spinel LiMn₂O₄), nickel (e.g., lithium nickel oxide, LiNiO₂ or LNO), cobalt (e.g., lithium cobalt oxide, LiCoO₂ or LCO), or the like. More than one transition metal may be present in some embodiments, e.g., as combinations or stochiometric blends. As non-limiting examples, the active material may include a combination of LiMnO₂ and LiNiO₂, or a composition comprising Li(MnₓNi₁₋ₓ)O₂, or the like.

In another example, the active material may include lithium titanate, Li₂TiO₃ and/or Li₄Ti₅O₁₂ (LTO), optionally with coatings such as LiTiO₂, or other coatings such as any of those described herein. Still other non-limiting examples of lithium-ion intercalation material include nickel manganese cobalt oxide (NMC) or nickel cobalt aluminum oxide (NCA).

In yet another example, the active material may be a solid metal. Examples include, but are not limited to, lithium metal, which may be coated with a lithium-selective solid electrolyte membrane material, such as a lithium o conductor (LISICON). In some embodiments, in order to avoid chemical reduction of Ti(IV) in LISICON or other degradation phenomena in contact with the aqueous brine, a buffer coating such as lithium phosphorous oxynitride (LiPON) may also be applied. Other non-limiting examples of membrane materials include lithium aluminum titanium phosphate, lithium superionic conductors, LiPON, lithium lanthanum zirconium oxide, solid polymer electrolytes, etc.

In still another example, active material may comprise a lithium-ion intercalation material. Non-limiting examples of lithium-ion intercalation material comprises lithium titanium phosphate (LTP), lithium manganese oxide (LMO), nickel manganese cobalt oxide (NMC), nickel cobalt aluminum oxide (NCA), lithium cobalt oxide (LCO), lithium iron phosphate (LFP), lithium manganese iron phosphate (LMFP), lithium titanium oxide (LTO), disordered rock salt (DRX), graphite, graphene oxide, hard carbon, a carbon ionomer composite, functionalized carbon, or the like.

However, in one set of embodiments, electrodes selective to other target ions (e.g., cations other than lithium ions, for example, sodium, potassium, hydrogen, or the like) may be used, e.g., if the target ion to be extracted is not lithium. In some embodiments, the electrodes may include active materials, such as Prussian blue (e.g. sodium or potassium iron hexanoferrate M₂₋ₓFeFe(CN)₆, or MFeHCF, where M⁺=Na⁺ or K⁺, and x ranges from 0 to 2 intercalated M⁺ ions), Prussian blue analogues (PBA) or Prussian white analogues (e.g., sodium or potassium metal hexacyanoferrate, M₂NFe(CN)₆, or MNHCF, where N is a transition metal, such as iron, cobalt, copper, nickel, manganese, or the like, or N is a mixture of transition metals of the same stoichiometry), sodium manganese oxide (Na₂Mn₅O₁₀), titanium disulfide (TiS₂), sodium chromium oxide, sodium cobalt oxide, sodium manganese oxide, sodium cobalt phosphate, sodium nickel phosphate, sodium iron phosphate, potassium cobalt oxide, potassium manganese oxide, potassium iron phosphate, potassium vanadium oxide, potassium vanadium phosphate, Prussian white (e.g., potassium Prussian white or KPW), Prussian white analogues, etc. may be used to selectively intercalate sodium or potassium compared to other monovalent ions, such as lithium, and all multivalent ions. In some embodiments, certain electrode active materials, such as NiHCF and CuHCF PBA, may be selective to ions of heavy rare earth elements versus ions of light rare earth elements, which may allow rare earth element separations in any of the electrochemical ion extraction systems described here. In another set of embodiments, the electrodes may be selective to multivalent target ions, such as Mg²⁺ or Ca²⁺, versus monovalent ions, such as Na⁺, Li⁺, and K⁺, e.g., by virtue of a high chemical surface charge in a microporous metallic electrode. Non-limiting examples of such multivalent-ion-selective electrodes include sulfonated porous carbons, vanadium oxide, Prussian Blue analogues, molybdenum sulfides, molybdenum oxides, manganese oxides, manganese/iron/cobalt silicates, vanadium phosphates, Mg metal, Ca metal, Mg/Ca alloys, etc. In some cases, one or more of these materials may be present, e.g., as an intercalant. In yet another embodiment, the active material may comprise a metal oxide, a metal phosphate, a metal-organic framework, a conjugated polymer, and/or a carbonaceous material, etc.

In one set of embodiments, the active material may be present in an electrode at at least 1 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, etc. In some case, the active material may be present at no more than 95 wt %, no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 1 wt %, etc. Combinations of any of these are also possible. For example, an active material may be present at a concentration of between 70 wt % and 90 wt %, between 30 wt % and 50 wt %, between 20 wt % and 45 wt %, etc.

In certain embodiments, an active material may be present in the electrode at at least 1 mg/cm² of surface. In some cases, the active material may be present at at least 2 mg/cm², at least 3 mg/cm², at least 5 mg/cm², at least 10 mg/cm², at least 15 mg/cm², at least 20 mg/cm², at least 25 mg/cm², at least 30 mg/cm², at least 35 mg/cm², at least 40 mg/cm², at least 45 mg/cm², at least 50 mg/cm², at least 55 mg/cm², at least 60 mg/cm², at least 65 mg/cm², at least 70 mg/cm², at least 75 mg/cm², at least 80 mg/cm², at least 85 mg/cm², at least 90 mg/cm², at least 100 mg/cm², at least 110 mg/cm², at least 120 mg/cm², at least 150 mg/cm², at least 200 mg/cm² , etc. In some cases, the active material may be present at no more than 200 mg/cm², no more than 150 mg/cm², no more than 120 mg/cm², no more than 110 mg/cm², no more than 100 mg/cm², no more than 90 mg/cm², no more than 85 mg/cm², no more than 80 mg/cm², no more than 75 mg/cm², no more than 70 mg/cm², no more than 65 mg/cm², no more than 60 mg/cm², no more than 55 mg/cm², no more than 50 mg/cm², no more than 45 mg/cm², no more than 40 mg/cm², no more than 35 mg/cm², no more than 30 mg/cm², no more than 25 mg/cm², no more than 20 mg/cm², no more than 15 mg/cm², no more than 10 mg/cm², no more than 5 mg/cm², no more than 3 mg/cm², no more than 2 mg/cm², no more than 1 mg/cm², etc. In addition, combinations of any of these ranges are also possible.

In some cases, an active material may exhibit a contact angle of at least 60°, at least 70°, at least 75°, at least 80°, at least 85°, at least 90°, at least 95°, at least 100°, at least 105°, at least 110°, at least 115°, at least 120°, etc. In some cases, the electrode or other component may exhibit a contact angle of no more than 140°, no more than 135°, no more than 130°, no more than 125°, no more than 120°, no more than 115°, no more than 110°, no more than 105°, no more than 100°, etc. In some cases, the contact angle may be a combination of any of these. For example, the active material or other component may have a contact angle of between 75° and 90°, between 70° and 100°, between 80° and 100°, etc.

In addition, in certain aspects, the compartments may include one or more divalent or other multivalent cation-selective electrodes. Examples of divalent ions (+2 charge) include Ca²⁺, Mg²⁺, Ni²⁺, Co²⁺, Zn²⁺, Cu²⁺, Mn²⁺, certain lanthanides or actinides, or the like. However, other, higher charges are also possible, e.g., +3 charged ions such as Fe³⁺, Al³⁺, Co³⁺, certain lanthanides or actinides, or the like. Specific non-limiting examples of multivalent cation-selective electrodes include, but are not limited to, Mg-selective electrodes, Mn-selective electrodes, Ni-selective electrodes, or the like. In some cases, such ion-selective electrodes can be made in similar fashion as a lithium-selective electrode, such as discussed herein. In some embodiments, the ion-selective electrode may be a divalent or other multivalent selective electrode. The divalent or other multivalent selective electrode may be relatively selective only against monovalent ions. This can be achieved, for example, by functionalizing an electrode to make the surface charge relatively dense and negatively charged, e.g., so as to induce a preference of more positively charged ions over less positively charged ions.

In some embodiments, a compartment may include one or more ion-selective electrodes. These may include cation-selective electrodes or anion-selective electrodes, or anion-capture electrodes in some embodiments. As discussed herein, a variety of ion-selective electrodes may be used in various embodiments. A compartment may contain one, two, or more types of ion-selective electrodes. In addition, in some embodiments, a compartment may contain any number of the same type of electrode, e.g., 1, 2, 3, 4, or more first electrodes, and/or 1, 2, 3, 4, or more second electrodes, etc. For example, the electrodes may include one or more of a first type of electrode and/or one or more of a second type of electrode, or there may be three or more different types of electrodes present in a compartment, in various embodiments.

Non-limiting examples include sodium ion-selective electrodes or potassium ion-selective electrodes. Thus, in one embodiment, an active material may comprise a sodium-ion intercalation material. Non-limiting examples of sodium-ion intercalation materials include sodium manganese oxide (NMO), sodium vanadium oxide (NVO), sodium iron phosphate (NFP), sodium titanium phosphate (NTP), PBA, Prussian blue analogues (PBA), Prussian white analogues (PWA), carbon nanomaterials, or the like. In one embodiment, an active material may comprise a potassium-ion intercalation material. Non-limiting examples of potassium-ion intercalation materials include potassium manganese oxide (KMO), potassium vanadium oxide (KVO), potassium iron phosphate (KFP), potassium vanadium phosphate (KVP), PBA, PWA, graphite, or the like.

As a non-limiting example, a compartment may contain a lithium-selective electrode an ion-selective electrode that is not a lithium-selective electrode, such as a monovalent ion-selective electrode, a divalent cation-selective electrode, a multivalent cation-selective electrode, an anion-selective electrode, etc., e.g., as discussed herein. As another example, a compartment may contain a sodium-selective electrode, an ion-selective electrode that is not a sodium-selective electrode, such as a monovalent ion-selective electrode, a divalent cation-selective electrodes, a multivalent cation-selective electrodes, etc. Accordingly, certain embodiments are generally directed to a target ion-selective electrode, an ion-selective electrode that is not a target ion electrode, e.g., for various target ions such as sodium, potassium, copper, gold, silver, magnesium, calcium, nickel, manganese, cobalt, chloride, sulfate, nitrate, hydroxide, heavy metals, transition metals, rare earth elements, lanthanides, actinides, and others including any of those disclosed herein.

The electrode may have any shape or size, and the electrodes within different compartments may independently have the same or different shapes or sizes, in one set of embodiments. For example, an electrode may be rectangular, cylindrical, toroidal, or spherical, or have other shapes (including regular or irregular shapes). In some cases, the electrode may have a longest dimension that is at least 10 mm, at least 20 mm, at least 30 mm, at least 50 mm, at least 100 mm, at least 200 mm, at least 300 mm, at least 500 mm, at least 1000 mm, etc. In some embodiments, the electrode may have a longest dimension that is no more than 1000 mm, no more than 500 mm, no more than 300 mm, no more than 200 mm, no more than 100 mm, no more than 50 mm, no more than 30 mm, no more than 20 mm, no more than 10 mm, no more than 5 mm, no more than 3 mm, no more than 2 mm, no more than 1 mm, etc. Combinations of any of these ranges are also possible in yet other embodiments. For example, the electrode may have a longest dimension that is between 300 mm and 500 mm, between 500 mm and 1000 mm, between 10 mm and 50 mm, etc.

In some cases, a cation-selective electrode may be used. In certain embodiments, the cation-selective electrode is a carbon-based electrode. For example, the carbon-based electrode may be formed from carbon-based materials such as activated carbon, carbon nanotubes, graphene, carbon aerogel, graphitic carbon, carbon black, graphene oxide, Vulcan carbon, coke, carbon nanotubes, or the like. In some cases, the electrode may be porous, e.g., formed from a porous conducting material such as discussed herein. Fluid may also flow around and/or through the electrodes (e.g., using flow-through electrodes).

In certain embodiments, the cation-selective electrode may be functionalized to enhance cation-selectivity. In some cases, a surface may be functionalized using functionalization agents, which can react with a surface to form surface groups. For example, the electrode may be enhanced with surface groups such as carboxylic acids, sulfonic acids, phosphoric acids, or the like. In some cases, the cation-selective electrode may be pre-charged in situ or ex situ.

In addition, in certain cases, an electrode may comprise various portions with different selectivities. For example, an electrode may comprise a first portion and a second portion, where the first portion is functionalized, e.g., as discussed herein, while the second portion is not functionalized, or functionalized with a different functionality. For instance, the first portion may be functionalized to be a divalent or other multivalent cation-selective electrode, while the second portion may not be selective to ions, and/or may be functionalized to be selective to different ions than the first portion. In some cases, for example, the second portion may be non-selective. In certain embodiments, the second electrode may be acting as a more general cation electrode or anion electrode. In addition, the first portion and the second portion may be in physical contact with each other, or separate in some cases.

In one embodiment, as a non-limiting example, an electrode may be functionalized to enhance divalent or other multivalent cation selectivity with surface groups for some fraction of the electrode area, while the remaining fraction of the electrode is not functionalized and remains largely non-selective. Such segmentation can be within a single contiguous electrode, between material layers forming the electrode, or between separate electrodes placed in the same compartment, or adjacent compartments, or the like.

A compartment may have only a single electrode, or more than one electrode in some cases. If more than one electrode is present, the electrodes may independently have the same or different sizes, shapes, compositions, etc. In addition, as discussed herein, some or all of the compartments within a stack may independently contain one or more electrodes, which may independently have the same or different sizes, shapes, compositions, etc. As an example, in some embodiments, at least 50%, at least 75%, at least 80%, or at least 90% of the electrodes within a stack may be compositionally identical, other than the presence/absence of any incorporated lithium. In some cases, the electrodes within a stack may be connected via electrical pathways in any suitable arrangement, e.g., in any suitable configuration, e.g., in series, in parallel, or in other arrangements. Different groups of electrodes may be present within a stack in some embodiments (e.g., a first group and a second group of electrodes), and the electrodes within a group may independently be connected to each other in the same or different configurations, e.g., in series, in parallel, or in other configurations.

In one set of embodiments, the electrode may comprise a coating. The coating may, in some embodiments, partially or completely surrounded an active material, and/or active material may be present in the coating, for example, as a component of the coating. One or more than one coating may be present in some cases. However, it should also be understood that no coating may be present in certain instances. The coating may provide a variety of functions, depending on the embodiment. In some cases, a coating may be used to enhance wettability, increase ionic or electronic conductivity, improve electrochemical stability or the like. For example, in one embodiment, a coating may include a lithium-selective material, which may provide additional lithium selectivity versus competing co-ions, such as sodium. Other ion-selective (e.g., cation-selective) materials can also be used in certain embodiments, e.g., for target ions other than lithium. As another example, a coating may include a hydrophilic coating, which may improve wettability of the electrode. In other embodiments, the coating may include a lyotropic ion, for example, to control fouling, wettability, precipitation, macromolecular interactions.

Non-limiting examples of coating materials include lithium titanium oxide (LiTiO₂) or polydopamine. Additional non-limited examples of coating materials include carbon (for example, graphitic carbon, carbon black, graphene oxide, Vulcan carbon, coke, carbon nanotubes, or the like), or conducting polymers (for example, polypyrrole (PPy), polyethylene oxide (PEO), or the like). Still another example includes ceramics. For example, a coating material may include one or more oxides of aluminum (i.e., alumina), silicon, zirconium (i.e., zirconia), niobium, etc. Other examples of ceramics include titania or phosphate or borosilicate glass. Such coating materials, in certain cases, may slow or block the transfer of electrons, metal ions, and/or oxygen.

The coating, if present, may be of any thickness on the electrode. For instance, the coating may have an average thickness on the electrode of at least 0.1 mm, at least 0.2 mm, at least 0.3 mm, at least 0.5 mm, at least 1 mm, at least 2 mm, at least 3 mm, at least 5 mm, at least 10 mm, at least 20 mm, at least 30 mm, at least 50 mm, at least 100 mm, etc. In addition, the coating may cover all, or a portion, of the electrode. For example, in various embodiments, the coating may cover at least 10%, at least 20%, at least 30%, at least 40%, at least 50%, at least 60%, at least 70%, at least 80%, at least 90%, at least 95%, etc. of the electrode.

The electrodes may be porous in one set of embodiments, e.g., formed from a porous conducting material. For example, an electrode may have a porosity that allows a liquid to enter, and/or pass through the pores, for example, in a normal or transverse direction to the current. The porosity may thus allow a liquid to enter the electrodes, thus allowing ions to incorporate and/or be removed from the electrodes, e.g., due to the increased available surface area. For example, the porosity may allow fast mass transfer of ions deep into the electrode materials.

In some cases, an electrode may have a porosity of at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, and/or no more than 90%, no more than 85%, no more than 80%, no more than 75%, no more than 70%, no more than 65%, no more than 60%, no more than 55%, no more than 50%, no more than 45%, no more than 40%, no more than 35%, no more than 30%, no more than 25%, no more than 20%, no more than 15%, no more than 10%, no more than 5%, etc., as determined as a volume fraction of the material forming the electrode. For instance, an electrode may have a porosity of between 20% and 25%, between 10% and 30%, between 35% and 45%, between 30% and 40%, between 25% and 70%, etc., on a volumetric basis. In addition, in some cases, the pores may have an average cross-sectional dimension of less than 1 mm, less than 300 micrometers, less than 100 micrometers, less than 30 micrometers, less than 10 micrometers, less than 3 micrometers, less than 1 micrometer, less than 300 nm, less than 100 nm, less than 30 nm, or less than 10 nm, etc. Porosity can be determined using standard porosimetry techniques (e.g., mercury intrusion porosimetry, cyclic porosimetry, gas absorption techniques, etc.) known to those of ordinary skill in the art.

The porosity within the electrodes may have a variety of configurations. For instance, an electrode may include one or more channels (e.g., “flow-through” channels), through which a fluid can flow through the electrode. See, e.g., U.S. Pat. Apl. Ser. No. 63/513,538, filed Jul. 13, 2023, entitled “Flow Systems and Methods for Membraneless Separation,” incorporated herein by reference in its entirety. As additional examples, an electrode may be fabricated from particles, fibers (which may be woven or non-woven), and/or other materials, e.g., packed into an electrode. For example, particles or fibers of active material (e.g., as discussed herein), inert materials, conducting materials, etc. may be packed together to form an electrode. Due to the shape of the particles, fibers, or other materials, spaces or pores may exist within the electrode, through which a fluid can flow.

Examples of inert materials include, but are not limited to, glass (e.g., phosphate glass), polymers, plastics, ceramics, or the like.

Examples of conducting materials include but are not limited to, carbon particles, e.g., coke particles, carbon black, Vulcan carbon particles, or the like. In one set of embodiments, the conducting material may include a capacitive material. Non-limiting examples of conductive materials include graphite, titanium, activated carbon, sulfonated carbon, or the like. As another example, the conducting material may include a metal (for example, present as a metal powder). Non-limiting examples include titanium, platinum, silver, zirconium, tin, copper, gold, zinc, stainless steel. As yet another example, the conducting material includes glass microspheres, for example, metal coated glass microspheres (such as the metals described herein). In still another example, a conductive material may include a conductive carbon material. Non-limiting examples include carbon black, carbon nanotubes, graphene, graphene oxide, etc. Yet other examples include a conductive polymer. Non-limiting examples of conductive polymers include poly(3,4-ethylenedioxythiophene) polystyrene sulfonate (PEDOT:PSS), polypyrrole, polythiophene, polyaniline (PANI), polythiophene, etc. Still other examples of conducting materials include conductive ceramic. Non-limiting examples of conductive ceramics include indium tin oxide (ITO), niobium titanium oxide (NTO), or the like. In addition, one or more than one conductive material may be present, including any of the conductive materials described herein.

In one set of embodiments, a conducting material may be present in an electrode at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, etc. In some case, the conducting material may be present at no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of any of these are also possible. For example, a conducting material may be present at a concentration of between 5 wt % and 80 wt %, between 30 wt % and 50 wt %, between 20 wt % and 45 wt %, etc.

In some cases, a conducting material may exhibit a contact angle of at least 60°, at least 70°, at least 75°, at least 80°, at least 85°, at least 90°, at least 95°, at least 100°, at least 105°, at least 110°, at least 115°, at least 120°, etc. In some cases, the electrode or other component may exhibit a contact angle of no more than 140°, no more than 135°, no more than 130°, no more than 125°, no more than 120°, no more than 115°, no more than 110°, no more than 105°, no more than 100°, etc. In some cases, the contact angle may be a combination of any of these. For example, the conducting material may have a contact angle of between 90° and 125°, between 85° and 120°, between 80° and 100°, etc.

In some cases, an electrode may be formed using one or more porogens, which may increase the porosity of the electrodes. In some cases, the porogens can be removed, thereby increasing the porosity of the electrode. For example, an electrode may be fabricated using a porogen such as polythelyene glycol (PEG), for example, PEG-6000. Other examples of porogens include, but are not limited to, sucrose, ammonium carbonate, sodium chloride or other salts, or the like. Still other examples of porogens include chloride salts, sulfate salts, silica, carbonate salts, polystyrene, polyethylene glycol (PEG), polyvinyl pyrrolidone (PVP), polyvinylalcohol (PVA), polymethaacrylate (PMA), polyacrylicacid (PAA), or the like. Porogens can be subsequently removed, e.g., by heating the electrode to oxidize the porogen, or by adding water to dissolve the porogen. Other methods of introducing porosity into an electrode include laser ablation, additive manufacturing, mechanical patterning, or the like.

In certain aspects, the active material may comprise particles, for example, forming a packed bed. In some cases, the particles may have an average size of at least 1 nm, at least 2 nm, at least 3 nm, at least 5 nm, at least 10 nm, at least 20 nm, at least 30 nm, at least 50 nm, at least 100 nm, at least 200 nm, at least 300 nm, at least 500 nm, at least 1 micrometer, at least 2 micrometers, at least 3 micrometers, at least 5 micrometers. In some cases, the particles may have an average size of less than 10 micrometers, less than 5 micrometers, less than 3 micrometers, less than 2 micrometers, less than 1 micrometer, less than 500 nm, less than 300 nm, less than 200 nm, less than 100 nm, less than 50 nm, less than 30 nm, less than 20 nm, less than 10 nm, less than 5 nm, less than 3 nm, less than 2 nm, etc. Combinations of any of these ranges are also possible in some embodiments.

In some embodiments, the active material particles may be coated. For example, the particles may be coated to improve electronic conductivity, ionic conductivity, anti-fouling properties, solubility, reactivity, hydrophilicity, etc., of the electrode in aqueous solutions. In some cases, the particles may be coated with a ceramic. Non-limiting examples of ceramics include, but are not limited to, silica, alumina, aluminum fluorides, titanium oxide, zirconium oxide, niobium oxide, ITO, boron oxide, vanadium oxide, aluminum oxide, tin oxide, zinc oxide, magnesium oxide, tungsten oxide, lithium phosphate, manganese phosphate, aluminum phosphate, cobalt phosphate, nickel phosphate, magnesium fluoride, zirconium fluoride, iron fluoride, zirconium oxyfluoride, lithium lanthanum zirconium oxide, lithium lanthanum titanium oxide, lithium titanate, lithium aluminum titanium phosphate, and/or boron nitride, etc. In addition, in some cases, the particles may be coated with a carbon. Non-limiting examples of carbons include graphite, hard carbon, graphene oxide, and/or activated carbon, etc. In addition, in certain cases, the particles may be coated with a polymer. Non-limiting examples of polymers include perfluorinated hydrocarbon polymers linked to sulfonate groups, polyamide, polypyrrole, polyethylene glycol (PEG), PEDOT, polyimide, polydopamine, polyvinyl alcohol, etc., or the like.

In one set of embodiments, the electrode may include an additive, such as a conductivity additive, which can be used to increase conductivity of the electrode. Non-limiting examples of additives include carbon (for example, graphitic carbon, carbon black, graphene oxide, Vulcan carbon, coke, or the like), metals (for example, gold, silver, copper, or the like), etc. In addition, in some embodiments, more than one additive may be present in an electrode.

In some embodiments, the electrode may include an ionically conductive additive. In some embodiments, this may improve the transport of ions through the electrode. In some embodiments, the ionically conductive additive may include perfluorinated hydrocarbon polymers linked to sulfonate groups (trademark name Nafion, Aquivion, etc.), alkali metal salts of polystyrene sulfonate, alkali metal salts of sulfonated poly(ether-etherketone) (SPEEK), alkali metal salts of polyvinylsulfonate, hydrocarbon polymers bearing peralkylated ammonium groups, hydrocarbon polymers bearing peralkylated phosphonium groups, or the like.

In some embodiments, the additive may be present at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, etc. within the electrode. In some embodiments, the additive may be present at no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of these are also possible in certain embodiments. For example, one or more additives may be present at between 30 wt % and 50 wt %, between 60 wt % and 80 wt %, between 5 wt % and 80 wt %, between 10 wt % and 20 wt %, or the like.

In some embodiments the electrode may include a mixed ion-electron conducting (MIEC) additive. In some embodiments, this may improve the transport of both ions and electrons through the electrode. Examples of MIEC additives include, but are not limited to, poly(3,4-ethylenedioxythiophene) polystyrene sulfonate (PEDOT:PSS), or polystyrene sulfonate (cation conducting) with polyaniline, polythiophene, polypyrrole, graphite, graphene oxide, carbon coated garnets, nonstoichiometric oxides and perovskites, strontium titanate, titania, ceria, etc.

In some embodiments, the additive may be present at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, etc. within the electrode. In some embodiments, the additive may be present at no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of these are also possible in certain embodiments. For example, one or more additives may be present at between 30 wt % and 50 wt %, between 60 wt % and 80 wt %, between 5 wt % and 80 wt %, between 10 wt % and 20 wt %, or the like.

In addition, the electrode may include a binder in one set of embodiments. The binder may assist in the formation of the electrode, e.g., to bind together components such as the active material, and other components (if present) such as additives, particles, fibers, conducting materials, inert materials, particles or fibers, etc. In some embodiments, the binder may include one or more polymers. Non-limiting examples of polymers include polyvinylidene fluoride (PVDF), polypyrrole (PPy), polyethylene oxide (PEO), etc. In some cases, the polymer may be a hydrophobic polymer, for example, a hydrophobic polymer that exhibits an air-water contact angle of greater than 90°, greater than 100°, greater than 110°, greater than 120°, greater than 130°, etc., or other contact angles such as any of those described herein. Additional non-limiting examples of hydrophobic polymers include polytetrafluoroethylene (PTFE), fluoroethers, fluorinated ethylene propylene (FEP), silicone, polyvinylidene fluoride (PVDF), polypropylene, polystyrene, polyethylene terephthalate (PET), or the like. In some embodiments, silicone or silicone polymers may be used. For example, the silicone polymer may be a cross-linked silicone polymer, and or the silicone or silicone polymer may be infused with silicone oil.

In one set of embodiments, the binder may be present in an electrode at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, etc. In some case, the binder may be present at no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of any of these are also possible. For example, a binder may be present at a concentration of between 5 wt % and 80 wt %, between 30 wt % and 50 wt %, between 20 wt % and 45 wt %, etc.

In some cases, the binder may exhibit a contact angle (determined with a surface in air and pure water) of at least 30°, at least 40°, at least 50°, at least 60°, at least 70°, at least 75°, at least 80°, at least 85°, at least 90°, at least 95°, at least 100°, at least 105°, at least 110°, at least 115°, at least 120°, etc. In some cases, the binder may exhibit a contact angle of no more than 120°, no more than 115°, no more than 110°, no more than 105°, no more than 100°, no more than 95°, no more than 90°, no more than 85°, no more than 80°, no more than 75°, no more than 70°, no more than 60°, no more than 50°, no more than 40°, etc. In some cases, the binder may exhibit a contact angle that is a combination of any of these.

The electrode may be in contact with a current collector in one aspect. The current collector may collect current (electrons), which may flow from a first set of electrodes within the apparatus to a second set of electrodes, or vice versa, e.g., as discussed herein. In some embodiments, the current collector may include a relatively inert material for the fluids and/or active materials. Non-limiting examples of materials for use as current collectors include carbon, graphite, titanium, aluminum, copper, stainless steel, platinum, metallic/polymer composites, graphite/polymer composites, or the like.

In certain embodiments, the current collector may take the form of a mesh or fibers, e.g., for use in porous electrodes, and/or flow-through electrodes. For instance, the current collector may comprise a metal mesh, a carbon cloth, or the like. The current collector may also be a solid material in some cases.

In some cases, the electrode may be in contact with a substrate, for example, a substrate forming a current collector. In some cases, the substrate may be attached to the electrode, for example, welded, soldered, attached via an adhesive, etc.

In certain embodiments, the substrate comprises a conductor, which may be the same or different as the conducting material. Examples of materials that can be used as a conducting material are discussed in more detail herein. As additional examples, the substrate may comprise platinum, stainless steel, aluminum, copper, titanium, silver, gold, lead, zinc, or the like. In other embodiments, the substrate may comprise a metal-polymer composite, graphite, a graphite-polymer composite, indium tin oxide (ITO), niobium titanium oxide (NTO), or the like. The substrate may have any suitable shape or dimension. For instance, in various embodiments, the substrate may be a foil, a sheet, a mesh, a foam, a paper, a fabric, a shim, or the like.

In some embodiments, the electrode may be present on the substrate as a deposition layer or coating. The deposition layer may be formed using any suitable technique, for example, dip coating, spray deposition, aerosol deposition, spin coating, blade coating, screen printing, slot-die coating, slurry coating, inkjet printing, physical deposition, pad printing, or the like.

In various aspects, electrodes such as any of those described herein may be used in a variety of apparatuses, e.g., for the extraction of target ions, such as lithium or other ions. Examples of such apparatuses include galvanic ion extraction apparatuses such as those described in U.S. Pat. Apl. Ser. No. 63/440,889, filed Jan. 24, 2023, entitled “Methods and Apparatuses for Galvanic Ion Extraction”, or electrochemical ion extraction apparatus such as those described in U.S. Pat. Apl. Ser. No. 63/513,519, filed Jul. 13, 2023, entitled “Methods and Apparatuses for Electrochemical Ion Exchange”, each incorporated herein by reference in its entirety. In some cases, such electrodes may also be used in a variety of other electrochemical systems, for example, batteries, fuel cells, or the like, e.g., which often have electrodes in contact with a liquid (for example, an electrolyte).

Apparatuses such as these may be used in accordance with certain embodiments to remove lithium ions from a first fluid and add them to a second fluid. For example, at a first time, when a current is applied to the electrodes of such an apparatus, e.g., via a voltage source, at the lithium-selective electrode, lithium ions can act as charge carriers and are driven into the lithium-selective electrode, e.g., becoming incorporated into the electrode by combining with electrons (Li⁺+e⁻-->Li⁰). In addition, at the multivalent cation-selective electrode, cations can also act as charge carriers, and can be removed from the electrode when a current is applied (M⁰-->M²⁺+2e⁻), e.g., entering the fluid within the compartment as ions. (It should be understood that the multivalent ions can also be trivalent or have higher valences, and divalent ions are described here by way of example only.) In summary, in this example, lithium ions are removed from the lithium-rich fluid and are exchanged for other multivalent ions as current is applied to the electrodes.

At a second point of time, however, the lithium may be removed from the lithium-selective electrode into a second fluid, e.g., a recovery solution or a lithium-poor fluid. The lithium-poor fluid may be one that has relatively low concentrations of lithium, including no lithium. For instance, in FIG. 4B, fluid 80 may be present within compartment 20, and current applied to electrodes 30 and 40. At the lithium-selective electrode, lithium is driven out as lithium ions (Li⁰-->Li⁺+e³¹), while at the multivalent cation-selective electrode, cations are driven into the electrode (M²⁺+2e⁻-->M⁰), by the application of a current. In this way, lithium ions are driven into the second fluid, e.g., by action of a current, in exchange for multivalent ions that are removed from it.

Thus, these electrically driven ion exchange processes, in combination, cause lithium ions to be removed from the first fluid (e.g., a lithium-rich fluid) into a second fluid (e.g., a lithium-poor fluid). This may allow for lithium to be extracted or purified from a fluid. It should be understood, however, that the present disclosure is not limited to only the exchange of lithium ions and multivalent cations (e.g., divalent cations, trivalent cations, etc.). For example, in certain cases, ions other than lithium may be exchanged in some embodiments, for example, sodium or potassium ions. As another example, monovalent ions (e.g., other than lithium) may be exchanged with lithium ions, for example, using a monovalent cation-selective electrode.

In some aspects, an apparatus such as described herein may be used to extract lithium ions from a first fluid (for example, one having a relatively high concentration of lithium ions, i.e., a lithium-rich fluid), and add them to a second fluid (for example, one having a relatively low concentration of lithium ions, i.e., a lithium-poor fluid). For example, the apparatus may contain one or more electrodes, including any of those described herein.

The first fluid may be, for example, a salt-lake brine, a subterranean brine, a geothermal brine, seawater, a leach liquor from hard-rock mining, a leachate from lithium-ion battery recycling, or other potential sources of lithium ions. Such fluids, in some embodiments, may also contain high concentrations of other co-ions (e.g., cations or positively charged ions) such as sodium, calcium, magnesium, potassium, or other competing ions, as well as high concentrations of counterions (e.g., anions or negatively charged ions) such as chloride, sulfate, hydroxide, or the like. The second fluid may be, for example, fresh water, naturally occurring water, desalinated water, distilled water, etc., which can then become concentrated in lithium ions (while not being as concentrated in other co-ions) as described in this example, e.g., for subsequent processing or use. Thus, lithium ions from the first fluid may become purified and/or concentrated within the second fluid. In addition, it should be understood that while this example describes the purification of lithium ions, this is for ease of presentation only, and that in other embodiments such as are described herein, other ions instead of lithium may be separated, for example, using electrodes that are optionally covered with ion-selective membranes, for example, that are capable of selective reverse electrosorption of those ions.

In some cases, the target ion may include metal ions. As a non-limiting example, target metal ions such as sodium, potassium, silver, gold, aluminum, zinc, nickel, or copper ions, etc., may be extracted by electrodeposition electrodes (e.g., by controlling the voltage to exploit differences in standard reduction potentials of species in solution). As another non-limiting example, ions, such as lithium and sodium, may be extracted by electrodeposition electrodes after passing through selective solid-state membranes (e.g., LIPON, LISICON, NASICON etc.), or task-specific ionic liquids (e.g., which selectively chelate the target ions). In another example, target ions such as sodium, potassium, chloride, protons, hydronium, or hydroxide ions may be extracted by selective intercalation electrodes (e.g., Prussian blue analogues, nickel or other metal hexanoferrates, etc.), etc. Non-limiting examples of sodium or potassium selective intercalation electrode materials include Prussian blue (Fe₄[Fe(CN)₆]₃), Prussian blue analogues, Prussian white (Na₂Fe₂(CN)₆), Prussian white analogues (e.g., nickel hexacyanoferrate, Na₂NiFe(CN)₆, manganese hexanoferrate (Na₂MnFe(CN)₆,), etc. Non-limiting examples of sodium-ion intercalation materials include sodium manganese oxide (NMO), sodium vanadium oxide (NVO), sodium iron phosphate (NFP), sodium titanium phosphate (NTP), Prussian blue analogues (PBA), Prussian white analogues (PWA), carbon nanomaterials, or the like. In one embodiment, an active material may comprise a potassium-ion intercalation material. Non-limiting examples of potassium-ion intercalation materials include potassium manganese oxide (KMO), potassium vanadium oxide (KVO), potassium iron phosphate (KFP), potassium vanadium phosphate (KVP), PBA, PWA, graphite, or the like. In another set of examples, the target ions are rare earth elements, such as lanthanides and actinides, which may be extracted by selective intercalation, for example, by metal hexanoferrates, Prussian blue or white analogues, other metal-organic framework (MOF) electrodes, or the like. In some cases, rare elements may be separated by size, for example, as the smaller, heavier ions may be intercalated more easily. Non-limiting examples of target ions may include metal lanthanides, such as lanthanum, cerium, neodymium, gadolinium, terbium, europium, etc., or metal actinides, such as uranium, plutonium, thorium, etc. Other examples are provided below. Other examples are provided below.

In some aspects, the second fluid may contain lithium ions paired with anions from the first fluid, such as chloride and/or sulfate, etc. In some embodiments, the second fluid may include reagents that allow the apparatus to directly produce lithium hydroxide, lithium carbonate, or other lithium chemicals.

For example, in certain cases, the second fluid may contain one or more reagents that can be used to precipitate salts of the target ion. For example, if the target ion is lithium, the second fluid (e.g., the lithium-poor fluid) may contain a hydroxide, such as sodium hydroxide (NaOH) or potassium hydroxide (KOH), which may cause the lithium to precipitate as lithium hydroxide (LiOH). The second fluid may have a relatively higher pH, e.g., a pH of at least 5, at least 6, at least 7, at least 8, at least 9, at least 10, etc. In some cases, the LiOH may precipitate in an outlet or exit channel of the compartment.

As another example, in one embodiment, lithium may be precipitated using sodium carbonate (soda ash) to make Li₂CO₃. In another embodiment, lithium may be precipitated using sodium hydroxide to make LiOH. As other examples, sodium carbonate can be used to precipitate certain divalents such as Mg or Ca to form MgCO₃ or CaCO₃, respectively; magnesium may be precipitated using CaCO₃ (lime) to make MgCO₃; or calcium may be precipitated using sodium oxalate to make calcium oxalate.

As another non-limiting example, the second fluid (e.g., the lithium-poor fluid) may contain carbon dioxide (CO₂) and/or carbonic acid (H₂CO₃, e.g., by sparging with CO₂ gas), which may cause the lithium to precipitate as lithium carbonate (Li₂CO₃). The CO₂ and/or H₂CO₃ may be present at any suitable concentration, e.g., a concentration of at least 1 mmol, at least 3 mmol, at least 5 mmol, at least 10 mmol, at least 20 mmol, at least 30 mmol, etc. In some cases, the Li₂CO₃ may precipitate in an outlet or exit channel of the compartment.

The apparatus may include a plurality or “stack” of compartments, through which fluid can flow, in certain aspects. The fluid may completely fill the compartments, and/or only a portion of the compartment may be filled with fluid. For example, in some cases, at least 10%, at least 20%, at least 30%, at least 40%, at least 50%, at least 60%, at least 70%, at least 80%, or at least 90% (by volume) of a compartment may be filled with a fluid.

Some or all of the compartments within the stack may also contain one, two, or more electrodes, such as a lithium-selective electrode, in which lithium ions may be incorporated into or removed from. Non-limiting examples of materials that may be used in the lithium-selective electrode include lithium iron phosphate, lithium titanium phosphate, lithium manganese oxide, or other materials such as those described herein. In addition, in some embodiments such as described in more detail below, the lithium-selective electrode may be porous, e.g., comprising particles, fibers, or the like to cause porosity, which may allow fluid to flow through the electrode in some cases. Each of the compartments may independently have the same or different electrodes therein. In some cases, for instance, all of the electrodes within a stack are compositionally identical other than the presence/absence of any deposited, electrosorbed, or intercalated lithium.

In some embodiments, the compartments within the stack are arranged in an alternating manner, where a first fluid is able to access a first set of compartments and a second fluid is able to access a second, interleaved set of compartments. Thus, for example, two adjacent compartments will not both contain fluid from the same source. In addition, in some cases, a flow-switching element may be used to intermittently switch the flows of fluid.

Separating each of the compartments within the stack is a membrane or other separator, which may be an anion-selective membrane in certain instances. The anion-selective membrane may be one that allows anions such as chloride to pass through, while preventing or inhibiting cations from passing through. In some embodiments, the anion-selective membrane is anisotropic, e.g., the membrane may preferentially allow anions to pass in certain directions across the membrane. Non-limiting examples of materials that may be used for the anion-selective membrane include various ionomers such as Neosepta®, poly(fluorenyl-co-aryl piperidinium) (PFAP), various polymer electrolytes containing positive tertiary or quaternary ammonium functional groups and mobile anions, block copolymer electrolytes such as poly(arylene ether sulfone) with hydrophilic and hydrophobic segments, polyethylene or polystyrene based multi-block copolymers, or other materials such as any of those described herein. In some embodiments, the block copolymer has at least one positively charged block or segment.

In addition, other separators may be used in certain embodiments, instead of or in addition to anion-selective membranes. In some cases, the separator may be a membrane, for example, a permeable or a semipermeable membrane. The membrane or separator may be relatively permeable to water but impermeable to ions, e.g., charged ions in certain embodiments. In some cases, the membrane or separator may be relatively porous, e.g., having a porosity that allows fluid to flow through the membrane or separator in some cases. In addition, in some cases, the membrane or separator may be functionalized, e.g., with positively charged or negatively charged species. In some cases, separators may comprise polypropylene-based separators (e.g., Celgard), glass fiber, polymer/ceramic composites (e.g., polypropylene and alumina), plastic mesh, virgin wood fiber tissue, or the like.

In some cases, a separator is porous enough that it does not fluidically separate the two compartments. In some embodiments, the separator is soft and/or flexible, and/or may be provided with mechanical reinforcement to increase its stiffness. In some cases, reinforcement allows more efficient operation, for example, during both fluid switching and ion extraction steps. For example, this may be achieved by reducing the deformation of the separator into adjacent flow channels, e.g., which may in some embodiments cause undesirable heterogeneities in the fluid flows and/or ion exchange with the electrodes. Non-limiting examples of reinforcement materials for separators or membranes include polymeric fibers or meshes, ceramic particles or powders, nanoparticles, nanotubes, nanoflakes, etc. These may, for example, be integrated into the bulk porous solid, coated on one or both surfaces of the separator or membrane, etc.

As non-limiting examples, in some embodiments, a membrane or other separator may be formed or treated as discussed herein to reduce various physical, chemical, and/or biological problems such as hydrodynamic dispersion, water splitting, pH variations, corrosion, bio-fouling, or the like. In certain cases, for example, a membrane or other separator may have a hydrophobicity that prevents or at least reduces the ability of microorganisms to adhere to it. For instance, the membrane or other separator may comprise certain anti-fouling polymers such as, but not limited to, polyethylene (PE), polypropylene (PP), polystyrene (PS), or the like. As another example, a membrane or other separator may contain one or more hydrophilic additives (for example, hydrophilic polymers), and/or one or more hydrophobic additives (for example, hydrophobic polymers). Specific non-limiting examples include any of those hydrophilic additives and/or hydrophobic additives described herein. As yet other non-limiting examples, a membrane or other component may include one or more lyotropic ions, zwitterionic materials, biocides, corrosion inhibitors, reaction inhibitors, antioxidants, oxygen scavengers, pH buffers, etc. Specific non-limiting examples of these and/or other compounds or treatments are described in more detail herein.

In some aspects, some or all of the electrodes within a compartment may be connected to each other, e.g., electrically, via one or more electrical pathways. In some embodiments, a voltage may be applied to the electrodes, e.g., creating a potential on the electrical pathway connecting the electrodes. In some cases, this potential may be used to drive the process, for example, to cause faster or better extraction of a target ion. The potential may be applied from an external voltage source, such as a battery, municipal power, or other power source (for example, fossil fuel or renewable power sources).

In certain embodiments, certain electrodes within a set of compartments may be connected to each other. For example, a first set of lithium-selective electrodes (and/or other electrodes) may be connected to each other, and/or a second set of non-lithium ion selective electrodes (and/or other electrodes) may be connected to each other, and the sets of electrodes may be connected, e.g., via an electrical pathway.

In some embodiments, the electrodes of adjacent compartments are of the same type of selectivity, thus resulting in a stack of “mirror image” compartments. However, it should be understood that although in some embodiments, repeat units within an apparatus may be arranged in a mirror image alternating manner, in other embodiments, other arrangements may also be used.

In addition, in some cases, the potential may be applied to retard the process, which may cause slower or less efficient extraction of lithium or other target ions. This may be useful in some cases, for example, to control the rate at which the target ions are incorporated into or removed from the electrodes.

In addition, electrodes within the first set of compartments may be connected to electrodes within the second set of compartments, e.g., by an electrical pathway. In some embodiments, the electrical pathway may be free of a voltage source, e.g., a battery or an external voltage source. Accordingly, electrons can flow from the electrodes within the first set of to the electrodes within the second set of compartments, or vice versa, along the electrical pathway. In addition, in some embodiments, a load (or external resistance) may also be present within the electrical pathway, e.g., such that power can be generated from the apparatus as electrons flow from one set of electrodes to the other.

In some embodiments, due to the presence of the anion-selective membrane, anions (such as chloride) may pass from the first set of compartments (e.g., containing a first fluid rich in lithium ions, and counterions such as chloride) to the second set of compartments (e.g., containing the second fluid). However, while anions are able to pass through the anion-selective membrane, lithium ions (or other cations) within the first set of compartments are not able to easily pass through the membrane. Instead, the lithium ions may become incorporated into the lithium-selective electrode, e.g., by effects such as intercalation, electrosorption, deposition or electrodeposition, e.g., in combination with electron transfer from the electrical pathway to reduce a host material (e.g., lithium), as the anions leave the first set of compartments (Li⁺+e⁻-->Li). As the lithium-selective electrode is selective to lithium, rather than to other co-ions such as sodium, calcium, magnesium, etc., lithium may be preferentially incorporated into the lithium-selective electrode, while the other co-ions pass by the electrode and exit the first set of compartments.

In the second set of compartments, the anions enter across the anion-selective membrane, while lithium ions are created from lithium previously incorporated in the lithium-selective electrode and released into solution, while creating an electron which can then flow via the electrical pathway into the first set of compartments (Li-->Li⁺+e⁻). The lithium ions and the anions thus enter the second fluid contained within the second set of compartments. In this way, the second fluid becomes enriched in lithium ions, without necessarily including other contaminating co-ions such as sodium or other cations described herein. The second fluid can then be used for a variety of purposes, e.g., as a source of purified lithium ions.

As a non-limiting example, in certain embodiments, at a first point in time, a first fluid (e.g., a lithium-rich fluid) from a first source of fluid passes through a first set of compartments, while a second fluid (e.g., a lithium-poor fluid) from a second source of fluid passes through a second set of compartments. In the first set of compartments, the lithium incorporates (e.g., deposits) into a first set of lithium-selective electrodes by combination of the lithium ions with an electron from the electrical pathway and anions exit through the anion-selective membrane, while in the second set of compartments, anions flow in through the anion-selective membrane and lithium ions are created from lithium incorporated into the second set of lithium-selective electrodes, thereby freeing an electron that flows through the electrical pathway into the first set of compartments.

However, at a second point in time, the first and second fluids are switched by action of the flow-switching element. In this example, fluid from the first source of fluid now passes through the second set of compartments, while fluid from the second source of fluid now passes through the first set of compartments. In the first set of compartments, the lithium that was previously incorporated into the first set of electrodes can now be removed as lithium ions into the second fluid (e.g., a lithium-poor fluid) as anions also enter across the anion-selective membrane, while in the second set of compartments, lithium ions are now able to incorporate into the second set of electrodes (now more depleted of lithium) as anions leave across the anion-selective membrane to reach the first set of compartments. Accordingly, this may be thought of as a “mirror image” of the above process.

This process may be repeated any suitable number of times, e.g., resulting in a second fluid that becomes enriched in lithium ions after passing through the apparatus, while the first fluid accordingly becomes more depleted in lithium ions. The repetition may occur on a periodic or regular basis, or the repetition may occur on an aperiodic or irregular basis in some embodiments. The second fluid can be used for a variety of purposes, e.g., for the production of lithium batteries as a source of lithium, or for other applications. In addition, in certain embodiments, one or both sets of compartments may be “flushed” between switches, e.g., with a different fluid, and/or by rejecting some of the fluid initially passing through the compartments after a switch occurs.

As another non-limiting example, a flow-switching element may be constructed and arranged to, at a first time, flow a first fluid into some or all compartments of a device, and at a second time, flow a second fluid into some or all compartments of a device. For example, in one set of embodiments, a flow-switching element may be constructed and arranged to, at a first time, flow a lithium-rich (or other target ion-rich) fluid into a compartment, and at a second time, flow a rinse fluid into the compartment. At a third time, the flow-switching element may be constructed and arranged to flow a third fluid into the compartment, e.g., a lithium-poor (or other target ion-poor) fluid into the compartment. In some cases, some or all of the compartments of the device may have the same fluids therein, e.g., as controlled by the flow-switching element.

In some cases, the flushing or rinse fluid may be chosen to be the same as the fluid most recently introduced into the compartment, although in some cases, the fluid may be a different fluid. Rinse fluids are discussed in more detail herein. For example, additional recovery fluid may be used to flush the recovery compartment after lithium (or other target ion) release from the contacting electrode. The duration and flow rate of a flushing step may be controlled to increase the recovery of additional target ions while minimizing dilution of the recovery fluid. In some embodiments, at least one of the rinse fluids is a gas. In some cases, the pressure or temperature of the rinse fluid may be elevated. For example, the pressure (gauge pressure) may be at least 50 kPa, at least 100 kPa, at least 200 kPa, at least 300 kPa, at least 1 MPa, at least 2 MPa, at least 5 MPa, at least 10 MPa, at least 20 MPa, etc. The temperature may be, in some embodiments, at least 30° C., at least 40° C., at least 50° C., at least 60° C., at least 70° C., at least 80° C., at least 90° C., etc. In some cases, the temperature may be no more than 100° C., no more than 90° C., no more than 80° C., no more than 70° C., no more than 60° C., no more than 50° C., no more than 40° C., no more than 30° C., etc. In addition, combinations of any of these are also possible. This may, in certain embodiments, may improve flushing and reduce the retained volume of the original fluid in the flow channels and electrodes.

In one set of embodiments, whenever fluids are switched in a given compartment, fluid mixing may be reduced. Without wishing to be bound by any theory, fluid mixing may be dominated by convection and associated hydrodynamic dispersion. Converging flow fields, e.g., in radial inward flow geometries, may be designed in certain embodiments to limit the total volume of the mixing zone. As a non-limiting example, the mixed volume between two miscible fluids in contact with one another can be estimated in some cases as the product of existing cross sectional area between the two fluids and the mixing zone thickness, approximated by sqrt(2 K t), where t is the residence time and K is the hydrodynamic dispersion coefficient for the channel. Enhanced mixing in turbulent flows may be avoided by maintaining a small Reynolds number in open compartments. Hydrodynamic dispersion may be limited, for example, by reducing the flow rate during fluid switching, by modifying the microstructure to reduce the sizes or thicknesses of channels and/or pores and/or loops in the pore network, etc.

Systems and methods for reducing the ability of two fluids to mix, e.g., as described above, may be used in accordance with certain aspects in apparatuses for purifying a fluid rich in a target ion, such as a target cation or a target anion. As mentioned, in one set of embodiments, the target ion may be lithium. Examples of lithium-rich fluids in which it may be desired to extract the lithium include, but are not limited to, water from naturally occurring or artificially produced brines, for example, salt-lake brines, geothermal brines, artificial desalination brines, water from hydraulic fracturing, brackish water, underground water, or seawater. In some cases, such water may contain high concentrations of sodium, potassium, calcium, magnesium, and/or other competing ions which differ from the target ions. As another example, the lithium-rich fluid may be a leachate, such as an acidic or basic leachate or other leach liquor. The leachate may be a leachate from, for example, hard-rock mining, lithium metal recycling, lithium-ion battery recycling, or the like. Examples of hard rocks containing lithium include spodumene or eucryptite, which may be crushed and processed in some cases by hydrometallurgical methods to dissolve lithium and other ions in a leachate. Still other non-limiting examples include water produced from oil or gas extraction (e.g., water produced by hydraulic fracturing), nuclear plant cooling or cleaning water, reverse-osmosis or other desalination processes, or other water treatment processes.

However, as mentioned, in other embodiments, other target ions may be extracted, instead of or in addition to lithium. For example, the target ion may be a metal ion, e.g., another dissolved metal cation. Non-limiting examples include sodium, potassium, silver, gold, copper, iron, aluminum, mercury, cadmium, chromium, arsenic, manganese, cobalt, nickel, other transition metals, lanthanum, ytterbium, cerium, neodymium and other lanthanides, yttrium, actinium, thorium, uranium, plutonium, and other actinides, etc. In certain cases, the target ion may be an anion, such as chloride, sulfate, nitrate, or hydroxide, or ionic complexes of the metal cations listed above, such as heavy metal oxyanions (e.g., arsenate, chromate, ferricyanide, etc.) or the like, which can be extracted using a suitable electrode selective to the target ion, as discussed herein. In some cases, more than one target ion can be extracted in an apparatus, for example, by using a first electrode within a compartment that is selective to a first target ion, and a second electrode within the compartment that is selective to a second target ion, thereby allowing the different target ions to be incorporated (e.g., deposited, intercalated, etc.) into and/or removed from the different electrodes.

In some cases, the target ion may be dissolved in an aqueous solution. For example, the aqueous solution may be seawater, brackish water, underground water, geothermal water, brines, leachates from mining operations, water produced from oil or gas extraction, or the like, including any of the sources of water previously described above. As a non-limiting example, in one set of embodiments, the first fluid rich in the target ion may be obtained by passing water or aqueous solutions across ores or rocks rich in one or more target ions, which may allow such ions to leach out of the ores or rocks. As another example, the water or aqueous solution may be obtained by passing water or aqueous solution across electrical components (e.g., semiconductor chips) to leach out such ions. As other examples, the water or aqueous solution may be obtained as a leachate from metal scrap, e-waste, or battery recycling, etc. In certain cases, such processes may be facilitated by elevating or lowering the temperature, mechanical operations (crushing, grinding, shredding, pulverizing, etc.), or the like.

In some embodiments, the target ion may be dissolved in a non-aqueous solution. As a non-limiting example, in one set of embodiments, the target ion is lithium, and the first fluid rich in the target ion is a Li-ion battery electrolyte, containing an organic solvent, such as ethylene carbonate, ethyl-methyl or di-methyl carbonate, a dissolved lithium salt as well as possible contaminants. In some embodiments, the organic Li-ion battery electrolyte is obtained from aged Li-ion batteries, and lithium extraction is performed during battery recycling.

In certain embodiments, the lithium (or other target ions) may be present in the fluid at a concentration of at least 0.01 mol %, at least 0.02 mol %, at least 0.03 mol %, at least 0.05 mol %, at least 0.1 mol %, at least 0.2 mol %, at least 0.3 mol %, at least 0.5 mol %, at least 1 mol %, at least 2 mol %, at least 3 mol %, at least 5 mol %, at least 10 mol %, etc. of the target ion. Other concentrations are also possible in other embodiments. In some cases, the concentration of lithium (or other target ions) may not be known.

In one set of embodiments, the target ions (for example, lithium, copper, gold, silver, chloride, hydroxide, etc. etc.) may be extracted into a second or recovery fluid, e.g., one that is free of the target ion, or at least one that is relatively poor or has a lower concentration of the target ion than the fluid rich in a target ion.

As a non-limiting example, for lithium ion extraction, the second fluid may be a lithium-poor fluid, e.g., one that has a relatively low concentration of lithium ions (or is substantially free of lithium ions). For example, the lithium-poor fluid may have a concentration of lithium of no more than 0.01 mol %. Non-limiting examples of such fluids include fresh water (e.g., naturally-occurring fresh water), purified water, distilled water, desalinated water, municipal water, or the like.

The second (or recovery) fluid can then be used for a variety of applications, e.g., using the extracted lithium (or other target ion). The second fluid may have a concentration of the target ion of less than 0.01 mol %. In some cases, for lithium, the lithium may be available within the second fluid as a lithium hydroxide solution, a lithium chloride solution, a lithium carbonate solution, or the like. In some embodiments, the second fluid can be directly used as a source of lithium for the direct manufacture of lithium batteries, e.g., without requiring subsequent processing, purification, crystallization, or the like. However, in other cases, the second fluid may be processed, for example, using subsequent steps such as reverse osmosis, evaporation, precipitation, or the like to concentrate the lithium (or other target ions).

In certain aspects, as discussed, an apparatus as discussed herein can include a plurality or “stack” of compartments, through which fluids can flow. The compartments may be of the same or different sizes. The compartments can be formed using metals, plastics, ceramics, or other suitable materials. In some cases, some or all of the compartments may be lined or coated with a plastic, e.g., a substantially water-resistant plastic, a hydrophobic plastic, or the like, e.g., as discussed herein. The fluid compartments may also be filled with and/or supported by a porous plastic or other permeable material, e.g., which may promote mixing by hydrodynamic dispersion during ion extraction.

The compartments may be of any size, and different compartments may independently be of the same or different sizes. For example, a compartment may have a volume of at least 0.1 m³, at least 0.3 m³, at least 0.5 m³, at least 1 m³, at least 3 m³, at least 5 m³, at least 10 m³, etc. The compartments may also have any suitable shape, including cylindrical or rectangular. In one set of embodiments, for instance, the compartments may have opposed or parallel surfaces, for example, that adjoin neighboring compartments. In some cases, the surfaces may include a membrane, such as a selective ion exchange membrane, e.g., as described herein.

However, it should be understood that in some embodiments, non-rectangular stacks or non-rectangular compartments may be used. For instance, the stack may be cylindrical, for example, with inward or outward radial flow between parallel circular annular electrodes and membranes (or other separators). Such a configuration may be useful, for example, for reducing mixing by hydrodynamic dispersion during ion exchange. In some embodiments, the stack is rolled or has spiral-wound cylindrical shape, optionally with either normal or parallel flow through the electrodes, e.g., as described herein. Flows in such cylindrical stacks may be radially and/or axially directed in some embodiments. In some embodiments, a rectangular or non-rectangular stack may be oriented vertically with lighter fluids introduced above heavier fluids, for example, in order to reduce mixing by buoyancy-driven convection.

In certain embodiments, the compartments may have any suitable shape, for example, square, cylindrical, rectangular, circular, or the like., and different compartments may independently have the same or different shapes. In some cases, counterflows in rectangular or cylindrical geometries, etc., may be helpful in distributing the current more evenly across the electrodes and membranes. However, in one set of embodiments, the compartments may be shaped so as to minimize mixing by hydrodynamic dispersion, for example, by applying inward and/or outward radial fluid flows in a cylindrical compartment. In some cases, this may allow the dispersive mixing layer to be confined to a smaller area near the central orifice. Inward radial flows with reduced dispersion may also be present as wedge-shaped stacks, which can be packed in triangular lattice arrangements in some embodiments. In addition, in one set of embodiments, the compartments may have a spiral configuration. In some cases, a spiral distribution may achieve greater active areas and more compact devices with fewer peripheral parts.

The flows of fluid within adjacent compartments may be parallel, anti-parallel, orthogonal, or at any other suitable angles. In some case, the flows may be skewed or bidirectional. In some cases, the flow of fluid may be perpendicular to each other. In addition, in some cases, there may be serpentine flows of fluid between different compartments. The fluid may also flow around and/or through the electrodes (e.g., using flow-through electrodes).

In some embodiments, a stack of compartments may be cylindrical, for example, with inward or outward radial flow between parallel circular annular electrodes and membranes. In some cases, one or more of the compartments may exhibit rotational symmetry, e.g., 3-fold, 4-fold, 5-fold, 6-fold, or more. Such a configuration may be useful, for example, for reducing mixing by hydrodynamic dispersion during ion exchange. In some embodiments, the stack is rolled or has spiral-wound cylindrical shape, optionally with either normal or parallel flow through the electrodes, e.g., as described herein. Flows in such cylindrical stacks may be radially and/or axially directed in some embodiments.

In addition, in some cases, there may be serpentine flows of fluid between different compartments. In one embodiment, the flows may together define an angle of at least 45°, at least 60°, at least 70°, at least 80°, at least 90°, at least 100°, at least 110°, at least 120°, at least 135°, at least 150°, at least 165°, etc.

The compartments may be open or closed in some embodiments. In some cases, gaskets or spacers may be present. In some embodiments, the compartments may contain inert or porous materials, for example, glass fabrics or mats (e.g., coated with PTFE), electrospun or extruded fibrous polymeric materials, packed beds of beads (e.g., glass, ceramic, plastic, etc.), or the like. The flow of fluid through the fluids through the compartments may be in any suitable orientation, e.g., vertical, horizontal, etc. As an example, some or all of the compartments may be oriented vertically in one embodiment, e.g., to allow precipitates to fall through the compartments, e.g., for collection.

The compartment may be operated in any suitable fashion, e.g., as batch, semi-batch, or continuous processes, etc. For example, in a batch operation, a compartment may be filled, partially or completely, with a first fluid at the first point of time, then the first fluid may be removed and the compartment filled with a second fluid at a second point in time. In contrast, in a continuous operation, a fluid may be passed through the compartment continually, e.g., while a current is applied to the electrodes. Combinations of these may also be used in other embodiments, for example, a first fluid may be contained statically within a compartment at a first point in time while a second fluid flows continuously though the compartment at a second point in time, etc.

In some embodiments, the same compartment can be used for incorporation of lithium (or other target ions) into an electrode, and for removal of lithium (or other target ions) from the electrode, at different times during use or operation. For example, at a first point of time, a lithium-rich fluid may pass through the compartment and lithium incorporated into the electrode, and at a second point of time, a lithium-poor fluid may pass through the compartment and lithium removed from the electrode. Other target ions may be incorporated or removed, in addition to or instead of lithium, in other embodiments.

In some cases, the compartments define a “repeat unit” that is repeated throughout the entire stack, in which some or all of the repeat units are nearly identical. There may be any number of repeat units within the stack. For instance, a stack may contain at least 2, at least 4, at least 5, at least 10, at least 15, at least 20, at least 25, at least 30, at least 40, at least 50, at least 60, at least 75, at least 100, etc. repeat units. In addition, the repeat units may extend in two dimensions, or three dimensions in some cases. For example, in FIG. 4E, a stack comprises a plurality of repeat units that extend in two dimensions. In some cases, the repeat units at the ends of a stack may be different than the internal repeat units, for example, ending with different electrodes or flow channel geometries.

In some cases, the use of stacks may allow a given compartment (e.g., one containing a lithium-rich fluid) to access more than one compartment across more than one multiple anion-exchange membrane. For example, a given compartment may have access to two, three, four, or more other compartments via anion-exchange membrane positioned between the given compartment and the adjacent compartments. This may improve the efficiency of separation in some cases, for example, due to the increased ability for anions to exit across the anion-exchange membranes, e.g., due to the increased available surface area for anionic transport to occur.

In some aspects, the compartments may be divided into a first group of compartments and a second group of compartments, where the compartments are divided such that some or all of the counterion-selective membranes separates a compartment from the first group and a compartment from the second group. For example, the compartments may be arranged in an alternating manner within the stack.

In one set of embodiments, the groups of compartments may be run in an alternating or “rocking-chair” manner, where at a first point of time, fluid from a first source of fluid passes through the first group of compartments and fluid from a second source of fluid passes through the second group of compartments, and at a second point of time, fluid from the first source of fluid passes through the second group of compartments and fluid from the second source of fluid passes through the first group of compartments. For example, the first fluid may be a lithium-rich fluid or a fluid rich in another target ion, while the second fluid may be a lithium-poor fluid or a fluid poor in the target ion.

In such a system, the same compartment can be used for incorporation of lithium (or other target ions) into an electrode, and for removal of lithium (or other target ions) from the electrode, at different times during use. For example, at a first point of time, a lithium-rich fluid may pass through the compartment and lithium incorporated into the electrode, and at a second point of time, a lithium-poor fluid may pass through the compartment and lithium removed from the electrode. Other target ions may be incorporated or removed, in addition to or instead of lithium, in other embodiments.

The times in which fluid switches occur may be fixed, or may vary. For example, in one set of embodiments, the fluids are switched at a fixed period or frequency. In another set of embodiments, the times the fluids are switched may vary, e.g., in a regular or an irregular pattern. In some cases, the time when the fluids are switched may depend on conditions within the compartments. For example, in certain embodiments, the fluids may be switched when a certain amount of lithium has been incorporated, or when a certain current is reached in the flow of electrons between the groups of compartments, etc.

In one set of embodiments, the fluids are controlled using a flow-switching element. The flow-switching element may be constructed and arranged to, at a first time, direct a first fluid from a first fluid source to a first exit and a second fluid from a second fluid source to a second exit, and at a second time, direct the first fluid from the first fluid to the second exit and the second fluid from the second fluid source to the first exit. In some cases, the flow-switching element may, at a first point in time, direct a first fluid from a first fluid source to an inlet of a first compartment (or a first common inlet of a first group of compartments) and a second fluid from a second fluid source to an inlet of a second compartment (or a second common inlet of a second group of compartments), and at a second point in time, direct the first fluid from the first fluid source to the inlet of the second compartment (or second common inlet of the second group of compartments) and the second fluid from the second fluid source to an inlet of the first compartment (or first common inlet of the first group of compartments). In addition, in some cases, the flow-switching element may, at a first point in time, direct a first fluid from a first fluid source to an inlet of a first compartment (or a first common inlet of a first group of compartments) and an inlet of a second compartment (or a second common inlet of a second group of compartments), and at a second point in time, direct a second fluid from a second fluid source to the inlet of the first compartment (or first common inlet of the first group of compartments) and the inlet of the second compartment (or second common inlet of the second group of compartments). The flow-switching element may be a single component, or comprise a plurality of components that together form the flow-switching element.

In some cases, the flow-switching element may allow other fluids to be introduced as well, e.g., into one or both exits. For example, between switches, there may be a period of time where a buffer or rinse fluid can be added, for instance, to separate the first fluid from the second fluid (or vice versa), to permit cleaning of the compartments, or the like. Rinse fluids are discussed in more detail herein.

As another non-limiting example, a flow-switching element may be constructed and arranged to, at a first time, flow a first fluid into some or all compartments of a device, and at a second time, flow a second fluid into some or all compartments of a device. For example, in one set of embodiments, a flow-switching element may be constructed and arranged to, at a first time, flow a lithium-rich (or other target ion-rich) fluid into a compartment, and at a second time, flow a rinse fluid into the compartment. At a third time, the flow-switching element may be constructed and arranged to flow a third fluid into the compartment, e.g., a lithium-poor (or other target ion-poor) fluid into the compartment. In some cases, some or all of the compartments of the device may have the same fluids therein, e.g., as controlled by the flow-switching element.

As discussed, some or all of the electrodes within the first group of compartments may be connected to each other, e.g., electrically, and some or all of the electrodes within the second group of compartments may be connected to each other, in accordance with one set of embodiments. The electrodes of the first group may be connected to the electrodes of the second group via one or more electrical pathways. In addition, the electrodes within a group may be connected to each other in certain embodiments, e.g., in any suitable configuration, e.g., in series, in parallel, or in other arrangements. Different groups of electrodes may also independently be connected to each other in the same or different configurations.

An apparatus such as described herein can be used, in some aspects, to extract lithium from seawater, naturally occurring brines, or artificial brines from hydraulic fracturing, nuclear plant wastewater, reverse-osmosis or other water treatment processes, using local fresh water or desalinated water as the recovery solution. In one embodiment, the apparatus can be co-located with a geothermal power plant that produces additional electricity. In another embodiment, the apparatus can be co-located with a blue energy plant at a river estuary. In yet other embodiments, the apparatus can be used to extract lithium from acidic leach liquors from hard-rock mining of spodumene or other lithium containing minerals, or from acidic leachates that arise in Li-ion battery recycling, as a compliment to hydrometallurgical processes. Other applications are also possible in other embodiments.

In addition, certain aspects of the present disclosure are generally drawn to electrode composites comprising an electrochemically active material, a conductive matrix, a binder, and optionally, additives. The electrode composites may be used, for example, for elemental extraction from aqueous feedstocks.

In some embodiments, the target ions may be metal cations, for example, Li⁺, Na⁺, K⁺, Mg²⁺, Ca²⁺, or the like.

In some embodiments, the active material may be selective for one or more target ions of the same sign of electrical charge. In some cases, the active material may be selective by electrosorption, intercalation, electrodeposition from aqueous solutions, or the like. In some embodiments, the active material may be a metal oxide, metal phosphate, metal-organic framework, conjugated polymer, and/or carbonaceous material, etc. In some embodiments, the active material may be a Li-ion intercalation material, for example, LTO, LTP, LMO, NMC, NCA, LCO, LFP, LMFP, DRX (disordered rock salt) graphite, graphene oxide, hard carbon, carbon ionomer composite, and/or functionalized carbon, etc. In some embodiments, the active material may be a Na-ion intercalation material, for example, NMO, NVO, NFP, NTP, PBA, PW, and/or carbon nanomaterials, etc. In some embodiments, the active material may be a K-ion intercalation material, for example, KMO, KVO, KFP, KVP, PBA, PW, and/or graphite, etc. In some embodiments, the electrode may be a capacitive material, for example, graphite, titanium, activated carbon, and/or sulfonated carbon, etc. In some embodiments, the electrode may be a conversion electrode, for example, for In, Ag, Bi, Zn, Pb, and/or Cu, etc.

In some embodiments, the active material comprises particles. In some embodiments, the particles have an average particle size of between 1 nm and 10 micrometers. In some embodiments, the active material particles may be coated. For example, the particles may be coated to improve electronic conductivity, ionic conductivity, anti-fouling properties, solubility, reactivity, hydrophilicity, etc., of the electrode in aqueous solutions.

In some embodiments, a particle coating may include ceramics (for example, silica, alumina, aluminum fluorides, titanium oxide, zirconium oxide, niobium oxide, ITO, boron oxide, vanadium oxide, aluminum oxide, tin oxide, zinc oxide, magnesium oxide, tungsten oxide, lithium phosphate, manganese phosphate, aluminum phosphate, cobalt phosphate, nickel phosphate, magnesium fluoride, zirconium fluoride, iron fluoride, zirconium oxyfluoride, lithium lanthanum zirconium oxide, lithium lanthanum titanium oxide, lithium titanate, lithium aluminum titanium phosphate, boron nitride, etc.), carbons (for example, graphite, hard carbon, graphene oxide, activated carbon, etc.), polymers (for example, Nafion, anion exchange membranes, cation exchange membranes, polyamide, polypyrrole, PEG, PEDOT, polyimide, polydopamine, polyvinyl alcohol, etc.), or the like.

In some embodiments, the conductive material may be a metal powder (for example, titanium, platinum, silver, zirconium, tin, copper, gold, zinc, stainless steel, metal coated glass microspheres, etc.), conductive carbon (for example, carbon black, carbon nanotubes, graphene, graphene oxide, etc.), conductive polymer (for example, PEDOT:PSS, polypyrrole, polythiophene, PANI, polyaniline, polythiophene, etc.), conductive ceramics (for example, ITO, NTO, etc.), or the like.

In some embodiments, the electrode composite includes an ionically conductive additive. In some embodiments, this may improve the transport of ions through the electrode. In some embodiments, an additive may include perfluorinated hydrocarbon polymers linked to sulfonate groups (trademark name Nafion, Aquivion, etc.), alkali metal salts of polystyrene sulfonate, alkali metal salts of sulfonated poly(ether-etherketone) (SPEEK), alkali metal salts of polyvinylsulfonate, hydrocarbon polymers bearing peralkylated ammonium groups, hydrocarbon polymers bearing peralkylated phosphonium groups, or the like.

In some embodiments the electrode comprises a mixed ion-electron conducting (MIEC) additive. In some embodiments, this may improve the transport of both ions and electrons through the electrode. Examples of MIEC additives include, but are not limited to, poly(3,4-ethylenedioxythiophene) polystyrene sulfonate (PEDOT:PSS), or polystyrene sulfonate (cation conducting) with polyaniline, polythiophene, and/or polypyrrole, etc.

In some embodiments, a binder may increase the hydrophobicity of the electrode. Examples include, but are not limited to, PTFE, FEP, silicone, PVDF, polypropylene, polystyrene, and/or PET, etc. In some embodiments, a binder may increase the hydrophilicity of the electrode. Examples include, but are not limited to, polyurethane, CMC, SBR, PEG, Nafion, LA133, PA, PMMA, PVA, PAN, and/or PVC, etc.

In some embodiments, the electrode may include additives to improve the hydrophilicity of the electrode. Examples of hydrophilic additives include, but are not limited to, alkali metal salts of alkylsulfonic acids, alkali metal salts of alkylbenzene sulfonic acids (for example, sodium dodecylbenzene sulfonate), fluorosurfactants that are partially or completed fluorinated (perfluorinated) (for example, include polyethylene glycol polymers covalently linked to a partially fluorinated or perfluorinated hydrocarbon chain, or a perfluorinated hydrocarbon chain linked to a sulfonate or quaternary ammonium group), polydopamine, and/or polyvinyl alcohol, etc. In some embodiments, the electrode composite may include additives to improve the hydrophobicity of the electrode. Examples of hydrophobic additives include, but are not limited to, fluoroethers, polypropylene, polystyrene, PVDF, FEP, silicone, and/or PTFE, etc. In some embodiments, the electrode composite may include additives to mitigate electrode corrosion. Examples of additives to improve corrosion resistance include metals (for example, Zn, Al, Mg, Ti, etc.), reactive inhibitors (for example, amines, hydrazines, hexmine, phenylenediamine, dimethylethanolamine, etc.), antioxidants (for example, sulfite, ascorbic acid, polyphenols, etc.), and anti-corrosion coatings (for example, polymers, paints, etc.). In some embodiments, the electrode composite may include additives to buffer the pH to a desired range. In some cases, the buffer may include a weak acid and its conjugate base. Buffering additives include, but are not limited to, borate, boric acid, citric acid, acetic acid, and/or monopotassium phosphate, etc.

In some embodiments, the electrode may have a porous microstructure. A porous microstructure may to facilitate water transport and/or release of air bubbles through the electrode thickness. Porous microstructures may be introduced, for example, through the use of porogens, laser ablation, additive manufacturing, or mechanical patterning. Examples of porogens include, but are not limited to, chloride salts, sulfate salts, silica, carbonate salts, polystyrene, polyethylene glycol (PEG), polyvinyl pyrrolidone (PVP), polyvinylalcohol (PVA), polymethaacrylate (PMA), and/or polyacrylicacid (PAA), etc.

In some embodiments, the electrode may comprise additives or coatings to improve the resistance of the electrode to fouling or biofouling. Examples of anti-fouling additives and coatings include, but are not limited to, quaternary ammonium compounds (quats), polyquats, zwitterionic materials, PTFE, PVDF, polypropylene, silicone, and/or PEG, etc. In some embodiments, the electrode may include additives to improve the mechanical robustness of the electrode. Examples of additives include, but are not limited to, metal fibers, metal wires, metal powders, carbon fibers, carbon nanotubes, graphene, PTFE, PVDF, polypropylene, aluminum oxide, titanium oxide, and/or zirconium oxide, etc.

In some embodiments, a substrate may include a corrosion resistant conductive material. Examples include, but are not limited to, platinum, stainless steel, copper, titanium, silver, gold, lead, zinc, metal/polymer composites, graphite, graphite/polymer composites, aluminum, ITO, and/or NTO, etc. In some embodiments, the substrate can be a foil, sheet, mesh, foam, paper, fabric, shim, or composite. In some embodiments, the electrode may be deposited onto the substrate. Example deposition techniques include, but are not limited to, dip coating, spray or aerosol deposition, spin coating, blade coating, screen printing, slot-die coating, slurry coating, inkjet printing, physical deposition methods, and/or pad printing, etc. In some embodiments, an electrode, substrate, or any of its individual components may be treated to improve its hydrophilicity. Examples include, but are not limited to, thermal treatments, acid treatments, and/or surfactant treatments, etc. In some embodiments, a surfactant may include sorbitan esters (Spans) (for example, sorbitan monostearate, sorbitan trioleate, sorbitan tristearate, sorbitan monolaurate, etc.), ethoxylated sorbitan esters (polysorbates), Li/Na/K+ dodecylbenzenesulfonate, SDS surfactant, or the like.

In some embodiments, an electrode may have an active material present at 1-100 mg/cm² of the electrode. In some embodiments, an electrode may have an active material forming 20-99 wt % of the components. In some embodiments, an electrode may have a conductive matrix forming 0-80 wt % of the components. In some embodiments, an electrode may have a binder forming 0-80 wt % of the components. In some embodiments, an electrode may have an additive forming 0-80 wt % of the components.

Still another aspect is generally drawn to a device. In one embodiment, the device comprises an electrode comprising an active material, a conducting material, a binder, and silicone. The device, in still another embodiment, comprises an electrode comprising an active material, a conducting material, a binder, and lyotropic ions at a concentration of at least 1 wt %. The device, in yet another embodiment, comprises an electrode comprising an active material, a conducting material, a binder, and a zwitterionic material. In one embodiment, the device comprises an electrode comprising an active material, a conducting material, a binder, and an anti-fouling coating on at least a portion of the electrode. In another embodiment, the device comprises an electrode comprising an active material, a conducting material, a binder, and a biocide. In still another embodiment, the device comprises an electrode comprising an active material, a conducting material, a binder, and a corrosion inhibitor. In yet another embodiment, the device comprises an electrode comprising an active material, a conducting material, a binder, and a pH buffer. In still another embodiment, the device comprises an electrode comprising an active material, a conducting material, a binder, and an anti-freeze chemical. In yet another embodiment, the device comprises an electrode comprising an active material, a conducting material, a binder, and an anti-boiling coolant chemical. The device, in another embodiment, comprises an electrode comprising an active material, a conducting material, and a binder, where the electrode exhibits an elastic modulus of at least 5 MPa. The device, in still another embodiment, comprises an electrode comprising an active material, a conducting material, and a binder, where the electrode exhibits a compressive strength of at least 0.5 MPa. In yet another embodiment, the device comprises an electrode comprising an active material, a conducting material, and a binder, where the electrode exhibits a specific toughness of at least 3 mJ/cm³. In another embodiment, the device comprises an electrode comprising an active material, a conducting material, a binder, and a mechanical stability additive.

Another aspect is generally drawn to an apparatus for electrochemical extraction of lithium. In certain embodiments, the apparatus comprises a first compartment comprising a first inlet, a first outlet, and a first lithium-selective electrode, and an abrasive fluid; a second compartment comprising a second inlet, a second outlet, and a second electrode; a separator between the first compartment and the second compartment; and an electrical pathway connecting the first electrode in the first compartment and the second electrode in the second compartment.

One aspect is generally directed to an apparatus for electrochemical extraction of a target ion. In accordance with one embodiment, the apparatus comprises a compartment containing a target ion-selective electrode, the lithium-selective electrode comprising an active material, a conducting material, a binder, and silicone. The apparatus, in yet another embodiment, comprises a compartment containing a target ion-selective electrode, the lithium-selective electrode comprising an active material, a conducting material, a binder, and lyotropic ions at a concentration of at least 1 wt %. The apparatus, in still another embodiment, comprises a compartment containing a target ion-selective electrode, the lithium-selective electrode comprising an active material, a conducting material, a binder, and a zwitterionic material. In one embodiment, the apparatus comprises a compartment containing a target ion-selective electrode, the lithium-selective electrode comprising an active material, a conducting material, a binder, and an anti-fouling coating on at least a portion of the electrode. In another embodiment, the apparatus comprises a compartment containing a target ion-selective electrode, the lithium-selective electrode comprising an active material, a conducting material, a binder, and a biocide. In still another embodiment, the apparatus comprises a compartment containing a target ion-selective electrode, the lithium-selective electrode comprising an active material, a conducting material, a binder, and a corrosion inhibitor. In yet another embodiment, the apparatus comprises a compartment containing a target ion-selective electrode, the lithium-selective electrode comprising an active material, a conducting material, a binder, and a pH buffer. In still another embodiment, the apparatus comprises a compartment containing a target ion-selective electrode, the lithium-selective electrode comprising an active material, a conducting material, a binder, and an anti-freeze chemical. In yet another embodiment, the apparatus comprises a compartment containing a target ion-selective electrode, the lithium-selective electrode comprising an active material, a conducting material, a binder, and an anti-boiling coolant chemical. In one embodiment, the apparatus comprises a compartment containing a target ion-selective electrode, the lithium-selective electrode comprising an active material, a conducting material, and a binder, where the target ion-selective electrode exhibits an elastic modulus of at least 5 MPa. The apparatus, in another embodiment, comprises a compartment containing a target ion-selective electrode, the lithium-selective electrode comprising an active material, a conducting material, and a binder, where the target ion-selective electrode exhibits a compressive strength of at least 0.5 MPa. The apparatus, in yet another embodiment, comprises a compartment containing a target ion-selective electrode, the lithium-selective electrode comprising an active material, a conducting material, and a binder, where the target ion-selective electrode exhibits a specific toughness of at least 3 mJ/cm³. In still another embodiment, the apparatus comprises a compartment containing a target ion-selective electrode, the lithium-selective electrode comprising an active material, a conducting material, a binder, and a mechanical stability additive.

Another aspect is generally drawn to an apparatus for electrochemical extraction of lithium. In one embodiment, the apparatus comprises a compartment containing a lithium-selective electrode, the lithium-selective electrode comprising an active material, a conducting material, and a binder, where a component of the apparatus comprises silicone.

The apparatus, in still another embodiment, comprises a compartment containing a lithium-selective electrode, the lithium-selective electrode comprising an active material, a conducting material, and a binder, where a component of the apparatus comprises lyotropic ions at a concentration of at least 1 wt %. The apparatus, in yet another embodiment, comprises a compartment containing a lithium-selective electrode, the lithium-selective electrode comprising an active material, a conducting material, and a binder, where a component of the apparatus comprises a zwitterionic material. In yet another embodiment, the apparatus comprises a compartment containing a lithium-selective electrode, the lithium-selective electrode comprising an active material, a conducting material, and a binder, where a component of the apparatus comprises an anti-fouling material. The apparatus, in still another embodiment, comprises a compartment containing a lithium-selective electrode, the lithium-selective electrode comprising an active material, a conducting material, and a binder, where a component of the apparatus comprises a biocide. The apparatus, in another embodiment, comprises a compartment containing a lithium-selective electrode, the lithium-selective electrode comprising an active material, a conducting material, and a binder, where a component of the apparatus comprises a corrosion inhibitor. In another embodiment, the apparatus comprises a compartment containing a lithium-selective electrode, the lithium-selective electrode comprising an active material, a conducting material, and a binder, where a component of the apparatus comprises a pH buffer. In still another embodiment, the apparatus comprises a compartment containing a lithium-selective electrode, the lithium-selective electrode comprising an active material, a conducting material, and a binder, where a component of the apparatus comprises an anti-freeze chemical. In yet another embodiment, the apparatus comprises a compartment containing a lithium-selective electrode, the lithium-selective electrode comprising an active material, a conducting material, and a binder, where a component of the apparatus comprises an anti-boiling coolant chemical. In one embodiment, the apparatus comprises a compartment containing a lithium-selective electrode, the lithium-selective electrode comprising an active material, a conducting material, and a binder, where a component of the apparatus exhibits an elastic modulus of at least 5 MPa. In another embodiment, the apparatus comprises a compartment containing a lithium-selective electrode, the lithium-selective electrode comprising an active material, a conducting material, and a binder, where a component of the apparatus exhibits a compressive strength of at least 0.5 MPa. In yet another embodiment, the apparatus comprises a compartment containing a lithium-selective electrode, the lithium-selective electrode comprising an active material, a conducting material, and a binder, where a component of the apparatus exhibits a specific toughness of at least 3 mJ/cm³. The apparatus, in still another embodiment, comprises a compartment containing a lithium-selective electrode, the lithium-selective electrode comprising an active material, a conducting material, and a binder, where a component of the apparatus comprises a mechanical stability additive.

Yet another aspect is generally directed to an apparatus for electrochemical extraction of a target ion. In one embodiment, the apparatus comprises a compartment containing a target ion-selective electrode, the target ion-selective electrode comprising an active material, a conducting material, and a binder, where a component of the apparatus comprises silicone. In still another embodiment, the apparatus comprises a compartment containing a target ion-selective electrode, the target ion-selective electrode comprising an active material, a conducting material, and a binder, where a component of the apparatus comprises lyotropic ions at a concentration of at least 1 wt %. The apparatus, in yet another embodiment, comprises a compartment containing a target ion-selective electrode, the target ion-selective electrode comprising an active material, a conducting material, and a binder, where a component of the apparatus comprises a zwitterionic material. The apparatus, in another embodiment, comprises a compartment containing a target ion-selective electrode, the target ion-selective electrode comprising an active material, a conducting material, and a binder, where a component of the apparatus comprises an anti-fouling material. In one embodiment, the apparatus comprises a compartment containing a target ion-selective electrode, the target ion-selective electrode comprising an active material, a conducting material, and a binder, where a component of the apparatus comprises a biocide. The apparatus, in another embodiment, comprises a compartment containing a target ion-selective electrode, the target ion-selective electrode comprising an active material, a conducting material, and a binder, where a component of the apparatus comprises a corrosion inhibitor. The apparatus, in yet another embodiment, comprises a compartment containing a target ion-selective electrode, the target ion-selective electrode comprising an active material, a conducting material, and a binder, where a component of the apparatus comprises a pH buffer. The apparatus, in another embodiment, comprises a compartment containing a target ion-selective electrode, the target ion-selective electrode comprising an active material, a conducting material, and a binder, where a component of the apparatus comprises an anti-freeze chemical. The apparatus, in still another embodiment, comprises a compartment containing a target ion-selective electrode, the target ion-selective electrode comprising an active material, a conducting material, and a binder, where a component of the apparatus comprises an anti-boiling coolant chemical. The apparatus, in still another embodiment, comprises a compartment containing a target ion-selective electrode, the target ion-selective electrode comprising an active material, a conducting material, and a binder, where a component of the apparatus exhibits an elastic modulus of at least 5 MPa. In another embodiment, the apparatus comprises a compartment containing a target ion-selective electrode, the target ion-selective electrode comprising an active material, a conducting material, and a binder, where a component of the apparatus exhibits a compressive strength of at least 0.5 MPa. In yet another embodiment, the apparatus comprises a compartment containing a target ion-selective electrode, the target ion-selective electrode comprising an active material, a conducting material, and a binder, where a component of the apparatus exhibits a specific toughness of at least 3 mJ/cm³. The apparatus, in still another embodiment, comprises a compartment containing a target ion-selective electrode, the target ion-selective electrode comprising an active material, a conducting material, and a binder, where a component of the apparatus comprises a mechanical stability additive.

Still another aspect is generally directed to an apparatus for electrochemical extraction of a target ion. According to one embodiment, the apparatus comprises a first compartment comprising a first inlet, a first outlet, a first target ion-selective electrode, and an abrasive fluid; a second compartment comprising a second inlet, a second outlet, and a second electrode; a separator between the first compartment and the second compartment; and an electrical pathway connecting the first electrode in the first compartment and the second electrode in the second compartment.

Another aspect is generally drawn to a method for electrochemical extraction of lithium. In one embodiment, the method comprises flowing a lithium-rich fluid through a compartment containing a lithium-selective electrode, where the lithium-selective electrode comprises an active material, a conducting material, a binder, and silicone; and incorporating lithium from the lithium-rich fluid into the lithium-selective electrode. In yet another embodiment, the method comprises flowing a lithium-rich fluid through a compartment containing a lithium-selective electrode, where the lithium-selective electrode comprises an active material, a conducting material, a binder, and lyotropic ions at a concentration of at least 1 wt %; and incorporating lithium from the lithium-rich fluid into the lithium-selective electrode. The method, in still another embodiment, comprises flowing a lithium-rich fluid through a compartment containing a lithium-selective electrode, where the lithium-selective electrode comprises an active material, a conducting material, a binder, and a zwitterionic material; and incorporating lithium from the lithium-rich fluid into the lithium-selective electrode. The method, in accordance with one embodiment, comprises flowing a lithium-rich fluid through a compartment containing a lithium-selective electrode, where the lithium-selective electrode comprises an active material, a conducting material, a binder, and an anti-fouling coating on at least a portion of the electrode; and incorporating lithium from the lithium-rich fluid into the lithium-selective electrode. The method, in another embodiment, comprises flowing a lithium-rich fluid through a compartment containing a lithium-selective electrode, where the lithium-selective electrode comprises an active material, a conducting material, a binder, and a biocide; and incorporating lithium from the lithium-rich fluid into the lithium-selective electrode. In still another embodiment, the method comprises flowing a lithium-rich fluid through a compartment containing a lithium-selective electrode, where the lithium-selective electrode comprises an active material, a conducting material, a binder, and a corrosion inhibitor; and incorporating lithium from the lithium-rich fluid into the lithium-selective electrode. The method, in still another embodiment, comprises flowing a lithium-rich fluid through a compartment containing a lithium-selective electrode, where the lithium-selective electrode comprises an active material, a conducting material, a binder, and a pH buffer; and incorporating lithium from the lithium-rich fluid into the lithium-selective electrode. The method, in another embodiment, comprises flowing a lithium-rich fluid through a compartment containing a lithium-selective electrode, where the lithium-selective electrode comprises an active material, a conducting material, a binder, and an anti-freeze chemical; and incorporating lithium from the lithium-rich fluid into the lithium-selective electrode. The method, in still another embodiment, comprises flowing a lithium-rich fluid through a compartment containing a lithium-selective electrode, where the lithium-selective electrode comprises an active material, a conducting material, a binder, and an anti-boiling coolant chemical; and incorporating lithium from the lithium-rich fluid into the lithium-selective electrode. In another embodiment, the method comprises flowing a lithium-rich fluid through a compartment containing a lithium-selective electrode, where the lithium-selective electrode comprises an active material, a conducting material, and a binder, and the lithium-selective electrode exhibits an elastic modulus of at least 5 MPa; and incorporating lithium from the lithium-rich fluid into the lithium-selective electrode. In still another embodiment, the method comprises flowing a lithium-rich fluid through a compartment containing a lithium-selective electrode, where the lithium-selective electrode comprises an active material, a conducting material, and a binder, and the lithium-selective electrode exhibits a compressive strength of at least 0.5 MPa; and incorporating lithium from the lithium-rich fluid into the lithium-selective electrode. The method, according to another embodiment, comprises flowing a lithium-rich fluid through a compartment containing a lithium-selective electrode, where the lithium-selective electrode comprises an active material, a conducting material, and a binder, and the lithium-selective electrode exhibits a specific toughness of at least 3 mJ/cm³, and incorporating lithium from the lithium-rich fluid into the lithium-selective electrode. In one embodiment, the method comprises flowing a lithium-rich fluid through a compartment containing a lithium-selective electrode, where the lithium-selective electrode comprising an active material, a conducting material, a binder, and a mechanical stability additive; and incorporating lithium from the lithium-rich fluid into the lithium-selective electrode.

Still another aspect is generally drawn to a method for electrochemical extraction of a target ion. According to one embodiment, the method comprises flowing a target ion-rich fluid through a compartment containing a target ion-selective electrode, where the lithium-selective electrode comprises an active material, a conducting material, a binder, and silicone; and incorporating target ions from the target ion-rich fluid into the target ion-selective electrode. The method, in another embodiment, comprises flowing a target ion-rich fluid through a compartment containing a target ion-selective electrode, where the lithium-selective electrode comprises an active material, a conducting material, a binder, and lyotropic ions at a concentration of at least 1 wt %; and incorporating target ions from the target ion-rich fluid into the target ion-selective electrode. The method, according to yet another embodiment, comprises flowing a target ion-rich fluid through a compartment containing a target ion-selective electrode, where the lithium-selective electrode comprises an active material, a conducting material, a binder, and a zwitterionic material; and incorporating target ions from the target ion-rich fluid into the target ion-selective electrode. The method, in still another embodiment, comprises flowing a target ion-rich fluid through a compartment containing a target ion-selective electrode, where the lithium-selective electrode comprises an active material, a conducting material, a binder, and an anti-fouling coating on at least a portion of the electrode; and incorporating target ions from the target ion-rich fluid into the target ion-selective electrode. The method, in still another embodiment, comprises flowing a target ion-rich fluid through a compartment containing a target ion-selective electrode, where the lithium-selective electrode comprises an active material, a conducting material, a binder, and a biocide; and incorporating target ions from the target ion-rich fluid into the target ion-selective electrode. In one embodiment, the method comprises flowing a target ion-rich fluid through a compartment containing a target ion-selective electrode, where the lithium-selective electrode comprises an active material, a conducting material, a binder, and a corrosion inhibitor; and incorporating target ions from the target ion-rich fluid into the target ion-selective electrode. In another embodiment, the method comprises flowing a target ion-rich fluid through a compartment containing a target ion-selective electrode, where the lithium-selective electrode comprises an active material, a conducting material, a binder, and a pH buffer; and incorporating target ions from the target ion-rich fluid into the target ion-selective electrode. In still another embodiment, the method comprises flowing a target ion-rich fluid through a compartment containing a target ion-selective electrode, where the lithium-selective electrode comprises an active material, a conducting material, a binder, and an anti-freeze chemical; and incorporating target ions from the target ion-rich fluid into the target ion-selective electrode. In yet another embodiment, the method comprises flowing a target ion-rich fluid through a compartment containing a target ion-selective electrode, where the lithium-selective electrode comprises an active material, a conducting material, a binder, and an anti-boiling coolant chemical; and incorporating target ions from the target ion-rich fluid into the target ion-selective electrode. In still another embodiment, the method comprises flowing a target ion-rich fluid through a compartment containing a target ion-selective electrode, where the lithium-selective electrode comprises an active material, a conducting material, and a binder, and the target ion-selective electrode exhibits an elastic modulus of at least 5 MPa; and incorporating target ions from the target ion-rich fluid into the target ion-selective electrode. The method, in another embodiment, comprises flowing a target ion-rich fluid through a compartment containing a target ion-selective electrode, where the lithium-selective electrode comprises an active material, a conducting material, and a binder, and the target ion-selective electrode exhibits a compressive strength of at least 0.5 MPa; and incorporating target ions from the target ion-rich fluid into the target ion-selective electrode. In yet another embodiment, the method comprises flowing a target ion-rich fluid through a compartment containing a target ion-selective electrode, where the lithium-selective electrode comprises an active material, a conducting material, and a binder, and the target ion-selective electrode exhibits a specific toughness of at least 3 mJ/cm³; and incorporating target ions from the target ion-rich fluid into the target ion-selective electrode. The method, in still another embodiment, comprises flowing a target ion-rich fluid through a compartment containing a target ion-selective electrode, where the lithium-selective electrode comprises an active material, a conducting material, a binder, and a mechanical stability additive; and incorporating target ions from the target ion-rich fluid into the target ion-selective electrode.

Yet another aspect is generally drawn to a method for electrochemical extraction of lithium. In one embodiment, the method comprises flowing a lithium-rich fluid through a compartment of an apparatus, the compartment containing a lithium-selective electrode, where the lithium-selective electrode comprises an active material, a conducting material, and a binder, and a component of the apparatus comprises silicone; and incorporating lithium from the lithium-rich fluid into the lithium-selective electrode. In another embodiment, the method comprises flowing a lithium-rich fluid through a compartment of an apparatus, the compartment containing a lithium-selective electrode, where the lithium-selective electrode comprises an active material, a conducting material, and a binder, and a component of the apparatus comprises lyotropic ions at a concentration of at least 1 wt %; and incorporating lithium from the lithium-rich fluid into the lithium-selective electrode. In yet another embodiment, the method comprises flowing a lithium-rich fluid through a compartment of an apparatus, the compartment containing a lithium-selective electrode, where the lithium-selective electrode comprises an active material, a conducting material, and a binder, and a component of the apparatus comprises a zwitterionic material; and incorporating lithium from the lithium-rich fluid into the lithium-selective electrode. The method, in still another embodiment, comprises flowing a lithium-rich fluid through a compartment of an apparatus, the compartment containing a lithium-selective electrode, where the lithium-selective electrode comprises an active material, a conducting material, and a binder, and a component of the apparatus comprises an anti-fouling material; and incorporating lithium from the lithium-rich fluid into the lithium-selective electrode. The method, in yet another embodiment, comprises flowing a lithium-rich fluid through a compartment of an apparatus, the compartment containing a lithium-selective electrode, where the lithium-selective electrode comprises an active material, a conducting material, and a binder, where a component of the apparatus comprises a biocide; and incorporating lithium from the lithium-rich fluid into the lithium-selective electrode. In another embodiment, the method comprises flowing a lithium-rich fluid through a compartment of an apparatus, the compartment containing a lithium-selective electrode, where the lithium-selective electrode comprises an active material, a conducting material, and a binder, and a component of the apparatus comprises a corrosion inhibitor; and incorporating lithium from the lithium-rich fluid into the lithium-selective electrode. The method, in still another embodiment, comprises flowing a lithium-rich fluid through a compartment of an apparatus, the compartment containing a lithium-selective electrode, where the lithium-selective electrode comprises an active material, a conducting material, and a binder, and a component of the apparatus comprises a pH buffer; and incorporating lithium from the lithium-rich fluid into the lithium-selective electrode. The method, in another embodiment, comprises flowing a lithium-rich fluid through a compartment of an apparatus, the compartment containing a lithium-selective electrode, where the lithium-selective electrode comprises an active material, a conducting material, and a binder, and a component of the apparatus comprises an anti-freeze chemical; and incorporating lithium from the lithium-rich fluid into the lithium-selective electrode. The method, in yet another embodiment, comprises flowing a lithium-rich fluid through a compartment of an apparatus, the compartment containing a lithium-selective electrode, where the lithium-selective electrode comprises an active material, a conducting material, and a binder, and a component of the apparatus comprises an anti-boiling coolant chemical; and incorporating lithium from the lithium-rich fluid into the lithium-selective electrode. The method, in another embodiment, comprises flowing a lithium-rich fluid through a compartment of an apparatus, the compartment containing a lithium-selective electrode, where the lithium-selective comprises comprising an active material, a conducting material, and a binder, and a component of the apparatus exhibits an elastic modulus of at least 5 MPa; and incorporating lithium from the lithium-rich fluid into the lithium-selective electrode. In one embodiment, the method comprises flowing a lithium-rich fluid through a compartment of an apparatus, the compartment containing a lithium-selective electrode, where the lithium-selective comprises comprising an active material, a conducting material, and a binder, and a component of the apparatus exhibits a compressive strength of at least 0.5 MPa; and incorporating lithium from the lithium-rich fluid into the lithium-selective electrode. In yet another embodiment, the method comprises flowing a lithium-rich fluid through a compartment of an apparatus, the compartment containing a lithium-selective electrode, where the lithium-selective comprises comprising an active material, a conducting material, and a binder, and a component of the apparatus exhibits a specific toughness of at least 3 mJ/cm³; and incorporating lithium from the lithium-rich fluid into the lithium-selective electrode. In still another embodiment, the method comprises flowing a lithium-rich fluid through a compartment of an apparatus, the compartment containing a lithium-selective electrode, where the lithium-selective electrode comprises an active material, a conducting material, and a binder, and a component of the apparatus comprises a mechanical stability additive; and incorporating lithium from the lithium-rich fluid into the lithium-selective electrode.

Still another aspect is generally directed to a method for electrochemical extraction of a target ion. The method, in one embodiment, comprises flowing a target ion-rich fluid through a compartment of an apparatus, the compartment containing a target ion-selective electrode, where the target ion-selective electrode comprises an active material, a conducting material, and a binder, and a component of the apparatus comprises silicone; and incorporating target ions from the target ion-rich fluid into the target ion-selective electrode. In still another set of embodiments, the method comprises flowing a target ion-rich fluid through a compartment of an apparatus, the compartment containing a target ion-selective electrode, where the target ion-selective electrode comprises an active material, a conducting material, and a binder, and a component of the apparatus comprises lyotropic ions at a concentration of at least 1 wt %; and incorporating target ions from the target ion-rich fluid into the target ion-selective electrode. In yet another set of embodiments, the method comprises flowing a target ion-rich fluid through a compartment of an apparatus, the compartment containing a target ion-selective electrode, where the target ion-selective electrode comprises an active material, a conducting material, and a binder, and a component of the apparatus comprises a zwitterionic material; and incorporating target ions from the target ion-rich fluid into the target ion-selective electrode. The method, in another set of embodiments, comprises flowing a target ion-rich fluid through a compartment of an apparatus, the compartment containing a target ion-selective electrode, where the target ion-selective electrode comprises an active material, a conducting material, and a binder, and a component of the apparatus comprises an anti-fouling material; and incorporating target ions from the target ion-rich fluid into the target ion-selective electrode. In yet another set of embodiments, the method comprises flowing a target ion-rich fluid through a compartment of an apparatus, the compartment containing a target ion-selective electrode, where the target ion-selective electrode comprises an active material, a conducting material, and a binder, and a component of the apparatus comprises a biocide; and incorporating target ions from the target ion-rich fluid into the target ion-selective electrode. The method, in still another set of embodiments, comprises flowing a target ion-rich fluid through a compartment of an apparatus, the compartment containing a target ion-selective electrode, where the target ion-selective electrode comprises an active material, a conducting material, and a binder, and a component of the apparatus comprises a corrosion inhibitor; and incorporating target ions from the target ion-rich fluid into the target ion-selective electrode. In another set of embodiments, the method comprises flowing a target ion-rich fluid through a compartment of an apparatus, the compartment containing a target ion-selective electrode, where the target ion-selective electrode comprises an active material, a conducting material, and a binder, and a component of the apparatus comprises a pH buffer; and incorporating target ions from the target ion-rich fluid into the target ion-selective electrode. In yet another set of embodiments, the method comprises flowing a target ion-rich fluid through a compartment of an apparatus, the compartment containing a target ion-selective electrode, where the target ion-selective electrode comprises an active material, a conducting material, and a binder, and a component of the apparatus comprises an anti-freeze chemical; and incorporating target ions from the target ion-rich fluid into the target ion-selective electrode. In still another set of embodiments, the method comprises flowing a target ion-rich fluid through a compartment of an apparatus, the compartment containing a target ion-selective electrode, where the target ion-selective electrode comprises an active material, a conducting material, and a binder, and a component of the apparatus comprises an anti-boiling coolant chemical; and incorporating target ions from the target ion-rich fluid into the target ion-selective electrode. The method, in another embodiment, comprises flowing a target ion-rich fluid through a compartment of an apparatus, the compartment containing a target ion-selective electrode, where the target ion-selective electrode comprises an active material, a conducting material, and a binder, and a component of the apparatus exhibits an elastic modulus of at least 5 MPa; and incorporating target ions from the target ion-rich fluid into the target ion-selective electrode. In still another embodiment, the method comprises flowing a target ion-rich fluid through a compartment of an apparatus, the compartment containing a target ion-selective electrode, where the target ion-selective electrode comprises an active material, a conducting material, and a binder, and a component of the apparatus exhibits a compressive strength of at least 0.5 MPa; and incorporating target ions from the target ion-rich fluid into the target ion-selective electrode. The method, according to another embodiment, comprises flowing a target ion-rich fluid through a compartment of an apparatus, the compartment containing a target ion-selective electrode, where the target ion-selective electrode comprises an active material, a conducting material, and a binder, and a component of the apparatus exhibits a specific toughness of at least 3 mJ/cm³; and incorporating target ions from the target ion-rich fluid into the target ion-selective electrode. In yet another embodiment, the method comprises flowing a target ion-rich fluid through a compartment of an apparatus, the compartment containing a target ion-selective electrode, where the target ion-selective electrode comprises an active material, a conducting material, and a binder, where a component of the apparatus comprises a mechanical stability additive; and incorporating target ions from the target ion-rich fluid into the target ion-selective electrode.

One aspect is generally directed to a method comprising flowing a target ion-rich fluid through a compartment containing a target ion-selective electrode; incorporating target ions from the target ion-rich fluid into the target ion-selective electrode; and flowing an abrasive fluid through the compartment. Another aspect is generally drawn to a method comprising flowing an abrasive fluid through a compartment containing a lithium-selective electrode. Still another aspect is generally drawn to a method comprising flowing an abrasive fluid through a compartment containing a target ion-selective electrode.

Another aspect is generally drawn to a method comprising flowing a target ion-rich fluid through a compartment containing a target ion-selective electrode; incorporating target ions from the target ion-rich fluid into the target ion-selective electrode; and applying a shear stress of at least 1 kPa to the target ion-selective electrode. Another aspect is generally drawn to a method comprising applying a shear stress of at least 1 kPa to a lithium-selective electrode. Still another aspect is generally drawn to a method comprising applying a shear stress of at least 1 kPa to a target ion-selective electrode.

The following are each incorporated herein by reference in their entireties: U.S. Provisional Patent Application Ser. No. 63/440,889, filed Jan. 24, 2023, entitled “Methods and Apparatuses for Galvanic Ion Extraction”; U.S. Provisional Patent Application Ser. No. 63/444,484, filed Feb. 9, 2023, entitled “Flow Field Configurations and Methods for Separation Processes”; U.S. Provisional Patent Application Ser. No. 63/513,519, filed Jul. 13, 2023, entitled “Methods and Apparatuses for Electrochemical Ion Exchange”; U.S. Provisional Patent Application Ser. No. 63/513,532, filed Jul. 13, 2023, entitled “Processes and Apparatuses for Enriching Solutions”; and U.S. Provisional Patent Application Ser. No. 63/513,538, filed Jul. 13, 2023, entitled “Flow Systems and Methods for Membraneless Separation.” In addition, the following, each filed on even date herewith, are each incorporated herein by reference in their entireties: a PCT patent application entitled “Methods and Apparatuses for Galvanic Ion Extraction”; a PCT patent application entitled “Flow Field Configurations and Methods for Separation Processes”; a PCT patent application entitled “Methods and Apparatuses for Electrochemical Ion Exchange”; a PCT patent application entitled “Processes and Apparatuses for Enriching Solutions”; a PCT patent application entitled “Flow Systems and Methods for Membraneless Separation”; and a PCT patent application entitled “Apparatuses, Manufacturing, and Operation of Electrochemical Stacks for Metals Extraction, and Methods Thereof.”

The following examples are intended to illustrate certain embodiments of the present disclosure, but do not exemplify the full scope of the disclosure.

### EXAMPLE 1

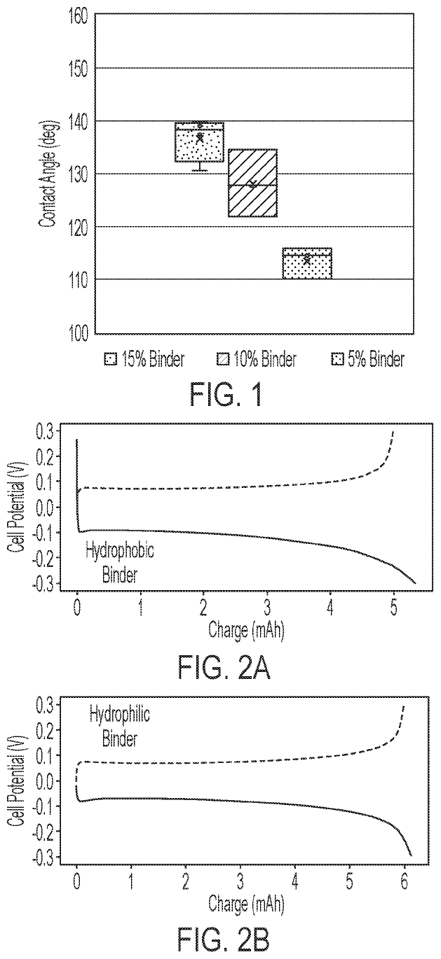

This example illustrates the ability to alter the hydrophobicity/hydrophilicity of an electrode by varying the content of a hydrophobic binder, in accordance with one embodiment. The electrodes used in this example included active material, carbon, and binder in three different ratios. The electrodes contained 5%, 10%, and 15% of the binder (by weight). The fraction of the carbon was equal to that of the binder, while the remaining balance was comprised of the active material. The electrodes materials were mixed in a solvent to form a slurry and cast onto a carbon cloth substrate. The contact angle measurement was conducted by dropping a 10 microliter drop of deionized water onto the face of the electrode, and the angle was measured with image analysis software. See FIG. 1, which shows the contact angle of water of a bead of deionized water on the face of electrodes with varying contents of hydrophobic binder.

### EXAMPLE 2

This example illustrates the electrochemical behavior of lithium extraction electrodes produced in accordance with one embodiment. In this example, delithiated active material was used as the working electrode, while lithiated active material is used as the counter electrode. Lithium extraction was conducted in a solution of 1M LiCl under a constant current of 0.33 mA/cm². The electrodes were cycled until the electrode potential reached 0.3 V or −0.3 V. Two electrodes are shown, one with a hydrophobic binder and one with a hydrophilic binder.

FIGS. 2A and 2B illustrate the electrochemical behavior of iron phosphate electrodes during electrochemical lithium extraction and release. The electrode manufactured with a hydrophobic binder exhibited larger cell polarization, which resulted in a lower accessible capacity. In contrast, the electrode manufactured with a hydrophilic binder exhibited less cell polarization, resulting in a higher accessible capacity.

### EXAMPLE 3

This example shows the capacity achieved during cycling of lithium extraction electrodes, in accordance with one embodiment. A delithiated active material was used as the working electrode while a lithiated active material was used as the counter electrode.

Lithium extraction was conducted in a solution of 1 M LiCl under a constant current of 0.23 mA/cm². The electrodes were cycled until the electrode potential reached 0.3 V or −0.3V. The cell was cycled for 20 full extraction and release cycles. Two cells are shown, one with electrodes containing a hydrophobic binder and the second with electrodes containing a hydrophobic binder with a hydrophilic additive.

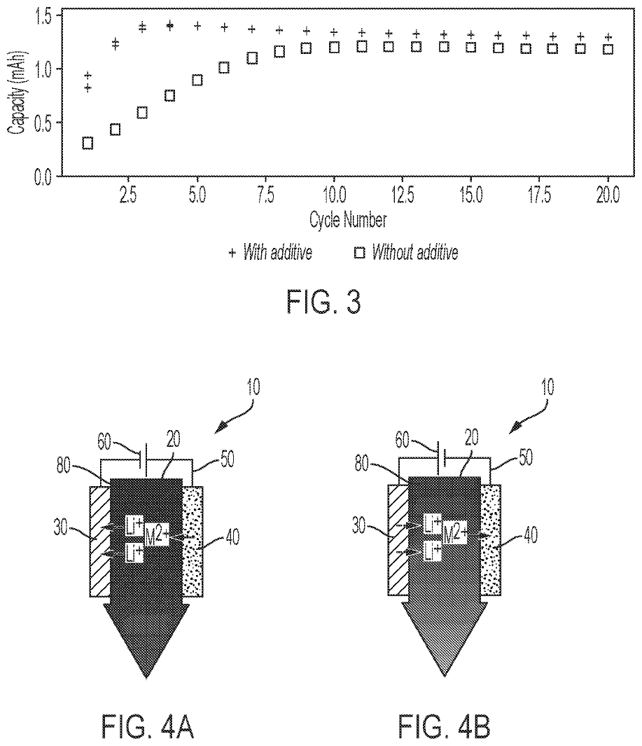

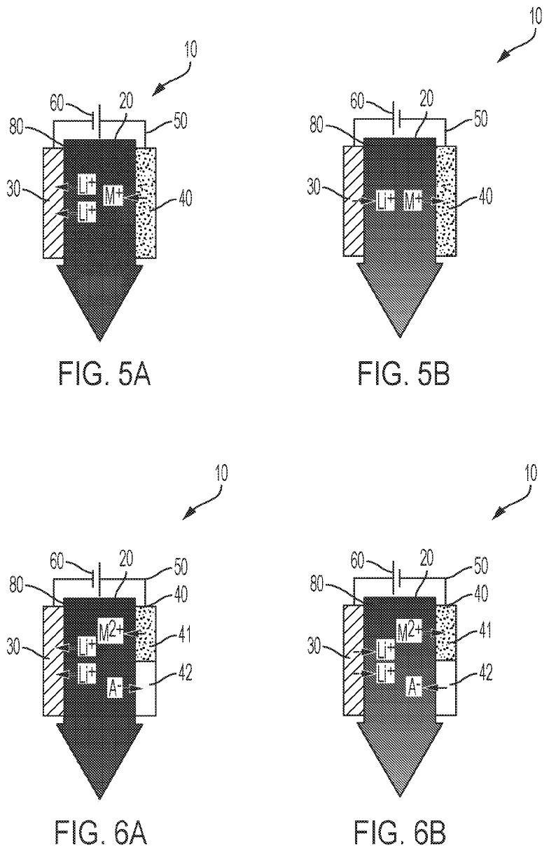

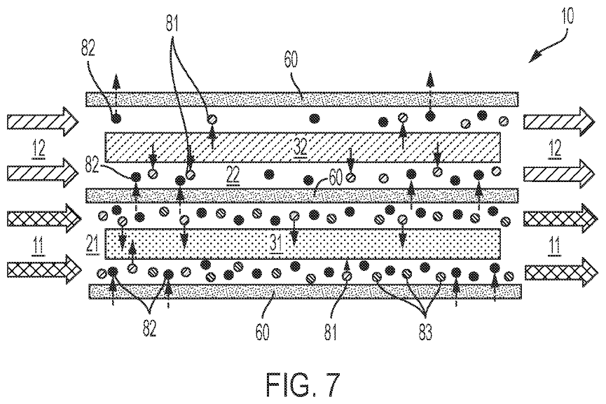

FIG. 3 shows electrode capacity as a function of cycle number for a cell containing electrodes with and without a hydrophilic additive. The cell containing electrodes with no additive showed a slow increase in the electrode capacity, indicating slow permeation of electrolyte into the electrode. Slow permeation of electrolyte resulted in poor contact between electrode and electrolyte which leads to lower accessible electrode capacity. Meanwhile, the electrode with the hydrophilic additive showed a rapid increase in the electrode capacity, indicating fast wetting of the electrode. The fast wetting of the electrode resulted in rapid contact of the electrode and electrolyte, leading to faster increases in accessible electrode capacity.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements), etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus for electrochemical extraction of lithium, comprising:
a compartment containing a lithium-selective electrode, the lithium-selective electrode comprising an active material, a conducting material, and a binder, wherein the lithium-selective electrode exhibits an air-water contact angle of less than 120°.

2. The apparatus of claim 1, wherein the lithium-selective electrode exhibits an air-water contact angle between 75°and 120°.

3. The apparatus of any one of claims 1 or 2, wherein the lithium-selective electrode exhibits an air-water contact angle between 75°and 100°.

4. The apparatus of any one of claims 1-3, wherein the lithium-selective electrode exhibits an air-water contact angle between 75°and 90°.

5. The apparatus of any one of claims 1-4, wherein the lithium-selective electrode exhibits an air-water contact angle between 90°and 120°.

6. The apparatus of any one of claims 1-5, further comprising an electrical pathway connecting the lithium-selective electrode to a second electrode.

7. The apparatus of claim 6, wherein the second electrode is contained within the compartment.

8. The apparatus of claim 6, wherein the second electrode is contained within a second compartment, the apparatus further comprising a separator between the compartment and the second compartment.

9. The apparatus of claim 8, wherein the separator is a membrane.

10. The apparatus of any one of claims 8 or 9, wherein the separator is an anion-selective membrane.

11. The apparatus of any one of claims 6-10, wherein the second electrode is a counter electrode.

12. The apparatus of claim 11, wherein the counter electrode is a multivalent cation-selective electrode.

13. The apparatus of any one of claims 6-12, wherein the second electrode has a lower lithium selectivity than the lithium-selective electrode.

14. The apparatus of any one of claims 6-13, wherein the second electrode is a second lithium-selective electrode.

15. The apparatus of any one of claims 6-14, wherein the second electrode is a sodium-selective electrode.

16. The apparatus of any one of claims 6-15, wherein the second electrode is a potassium-selective electrode.

17. The apparatus of any one of claims 6-16, wherein the second electrode is a rare-earth-element-selective electrode.

18. The apparatus of any one of claims 6-17, wherein the second electrode is an anion-capture electrode.

19. The apparatus of any one of claims 1-18, further comprising a source of lithium-rich fluid in fluid communication with the compartment.

20. The apparatus of any one of claims 1-19, wherein the binder is present in the lithium-selective electrode at at least 5 wt %.

21. The apparatus of any one of claims 1-20, wherein the binder is present in the lithium-selective electrode at no more than 80 wt %.

22. The apparatus of any one of claims 1-21, wherein the binder exhibits an air-water contact angle of at least 120°.

23. The apparatus of any one of claims 1-22, wherein the binder comprises a hydrophobic polymer that exhibits an air-water contact angle of at least 120°.

24. The apparatus of claim 23, wherein the hydrophobic polymer comprises polytetrafluoroethylene (PTFE).

25. The apparatus of any one of claims 23 or 24, wherein the hydrophobic polymer comprises a fluoroether.

26. The apparatus of any one of claims 23-25, wherein the hydrophobic polymer comprises fluorinated ethylene propylene (FEP).

27. The apparatus of any one of claims 23-26, wherein the hydrophobic polymer comprises silicone.

28. The apparatus of any one of claims 23-27, wherein the hydrophobic polymer comprises polyvinylidene fluoride (PVDF).

29. The apparatus of any one of claims 23-28, wherein the hydrophobic polymer comprises polypropylene.

30. The apparatus of any one of claims 23-29, wherein the hydrophobic polymer comprises polystyrene.

31. The apparatus of any one of claims 23-30, wherein the hydrophobic polymer comprises polyethylene terephthalate (PET).

32. The apparatus of any one of claims 1-31, wherein the binder comprises silicone.

33. The apparatus of any one of claims 1-32, wherein the binder comprises a silicone polymer.

34. The apparatus of any one of claims 1-33, wherein the binder comprises a hydrophobic additive.

35. The apparatus of any one of claims 1-34, wherein the binder comprises a hydrophilic polymer that exhibits an air-water contact angle of less than 90°.

36. The apparatus of claim 35, wherein the hydrophilic polymer comprises polyurethane.

37. The apparatus of any one of claims 35 or 36, wherein the hydrophilic polymer comprises carboxymethyl cellulose (CMC).

38. The apparatus of any one of claims 35-37, wherein the hydrophilic polymer comprises styrene-butadiene rubber (SBR).

39. The apparatus of any one of claims 35-38, wherein the hydrophilic polymer comprises polyethylene glycol (PEG).

40. The apparatus of any one of claims 35-39, wherein the hydrophilic polymer comprises sulfonated tetrafluoroethylene.

41. The apparatus of any one of claims 35-49, wherein the hydrophilic polymer comprises polyacrylic latex.

42. The apparatus of any one of claims 35-41, wherein the hydrophilic polymer comprises polyamide (PA).

43. The apparatus of any one of claims 35-42, wherein the hydrophilic polymer comprises poly(methyl methacrylate) (PMMA).

44. The apparatus of any one of claims 35-43, wherein the hydrophilic polymer comprises polyvinyl alcohol (PVA).

45. The apparatus of any one of claims 35-44, wherein the hydrophilic polymer comprises polyacrylonitrile (PAN).

46. The apparatus of any one of claims 35-45, wherein the hydrophilic polymer comprises polyvinyl chloride (PVC).

47. The apparatus of any one of claims 1-46, wherein the binder comprises a hydrophilic additive.

48. The apparatus of claim 47, wherein the hydrophilic additive comprises an alkali metal salt of an alkylsulfonic acid.

49. The apparatus of any one of claims 47 or 48, wherein the hydrophilic additive comprises an alkali metal salt of an alkylbenzene sulfonic acid.

50. The apparatus of any one of claims 47-49, wherein the alkali metal salt comprises sodium dodecylbenzene.

51. The apparatus of any one of claims 47-50, wherein the hydrophilic additive comprises a fluorosurfactant.

52. The apparatus of claim 51, wherein the fluorosurfactant is partially fluorinated.

53. The apparatus of any one of claims 51 or 52, wherein the fluorosurfactant is perfluorinated.

54. The apparatus of any one of claims 51-53, wherein the fluorosurfactant comprises a polyethylene glycol polymer covalently bonded to a fluorinated hydrocarbon.

55. The apparatus of any one of claims 51-54, wherein the fluorosurfactant comprises a perfluorinated hydrocarbon bonded to a sulfonate.

56. The apparatus of any one of claims 51-55, wherein the fluorosurfactant comprises a perfluorinated hydrocarbon bonded to a quaternary ammonium.

57. The apparatus of any one of claim 47-56, wherein the hydrophilic additive comprises polydopamine.

58. The apparatus of any one of claims 47-57, wherein the hydrophilic additive comprises polyvinyl alcohol.

59. The apparatus of any one of claims 1-58, wherein the electrode further comprises a surfactant.

60. The apparatus of claim 59, wherein the surfactant comprises sorbitan monostearate.

61. The apparatus of any one of claims 59 or 60, wherein the surfactant comprises sorbitan trioleate.

62. The apparatus of any one of claims 59-61, wherein the surfactant comprises sorbitan tristearate.

63. The apparatus of any one of claims 59-62, wherein the surfactant comprises sorbitan monolaurate.

64. The apparatus of any one of claims 59-63, wherein the surfactant comprises an ethoxylated sorbitan ester.

65. The apparatus of any one of claims 59-64, wherein the surfactant comprises a polysorbate.

66. The apparatus of any one of claims 59-65, wherein the surfactant comprises a dodecylbenzenesulfonate salt.

67. The apparatus of any one of claims 59-66, wherein the surfactant comprises sodium dodecyl sulfate (SDS).

68. The apparatus of any one of claims 1-67, wherein the conducting material is present in the lithium-selective electrode at at least 5 wt %.

69. The apparatus of any one of claims 1-68, wherein the conducting material is present in the lithium-selective electrode at no more than 70 wt %.

70. The apparatus of any one of claims 1-69, wherein the conducting material exhibits an air-water contact angle of less than 125°.

71. The apparatus of any one of claims 1-70, wherein the conducting material exhibits an air-water contact angle of at least 90°.

72. The apparatus of any one of claims 1-71, wherein the conducting material comprises a capacitive material.

73. The apparatus of claim 72, wherein the conductive material comprises graphite.

74. The apparatus of any one of claims 72 or 73, wherein the conductive material comprises titanium.

75. The apparatus of any one of claims 72-74, wherein the conductive material comprises activated carbon.

76. The apparatus of any one of claims 72-75, wherein the conductive material comprises sulfonated carbon.

77. The apparatus of any one of claims 1-76, wherein the conducting material comprises a metal powder.

78. The apparatus of claim 77, wherein the metal powder comprises titanium.

79. The apparatus of any one of claims 77 or 78, wherein the metal powder comprises platinum.

80. The apparatus of any one of claims 77-79, wherein the metal powder comprises silver.

81. The apparatus of any one of claims 77-80, wherein the metal powder comprises zirconium.

82. The apparatus of any one of claims 77-81, wherein the metal powder comprises tin.

83. The apparatus of any one of claims 77-82, wherein the metal powder comprises copper.

84. The apparatus of any one of claims 77-83, wherein the metal powder comprises gold.

85. The apparatus of any one of claims 77-84, wherein the metal powder comprises zinc.

86. The apparatus of any one of claims 77-85, wherein the metal powder comprises stainless steel.

87. The apparatus of any one of claims 1-86, wherein the conducting material comprises glass microspheres

88. The apparatus of any one of claims 1-87, wherein the conducting material comprises metal coated glass microspheres.

89. The apparatus of any one of claims 1-88 wherein the conducting material comprises a conductive carbon material.

90. The apparatus of claim 89, wherein the conductive carbon material comprises carbon black.

91. The apparatus of any one of claims 89 or 90, wherein the conductive carbon material comprises carbon nanotubes.

92. The apparatus of any one of claims 89-91, wherein the conductive carbon material comprises graphene.

93. The apparatus of any one of claims 89-92, wherein the conductive carbon material comprises graphene oxide.

94. The apparatus of any one of claims 1-93, wherein the conducting material comprises a conductive polymer.

95. The apparatus of claim 94, wherein the conductive polymer comprises poly(3,4-ethylenedioxythiophene) polystyrene sulfonate (PEDOT:PSS).

96. The apparatus of any one of claims 94 or 95, wherein the conductive polymer comprises polypyrrole.

97. The apparatus of any one of claims 94-96, wherein the conductive polymer comprises polythiophene.

98. The apparatus of any one of claims 94-97, wherein the conductive polymer comprises polyaniline (PANI).

99. The apparatus of any one of claims 94-98, wherein the conductive polymer comprises polythiophene.

100. The apparatus of any one of claims 1-99, wherein the conducting material comprises a conductive ceramic.

101. The apparatus of claim 100, wherein the conductive ceramic comprises indium tin oxide (ITO).

102. The apparatus of any one of claims 100 or 101, wherein the conductive ceramic comprises niobium titanium oxide (NTO).

103. The apparatus of any one of claims 1-102, wherein the active material is present in the lithium-selective electrode at at least 20 wt %.

104. The apparatus of any one of claims 1-103, wherein the active material is present in the lithium-selective electrode at no more than 95 wt %.

105. The apparatus of any one of claims 1-104, wherein the active material is present in the first lithium-selective electrode at at least 1 mg/cm² of surface.

106. The apparatus of any one of claims 1-105, wherein the active material is present in the first lithium-selective electrode at no more than 100 mg/cm² of surface.

107. The apparatus of any one of claims 1-106, wherein the active material exhibits an air-water contact angle of less than 75°.

108. The apparatus of any one of claims 1-107, wherein the active material comprises a metal oxide.

109. The apparatus of any one of claims 1-108, wherein the active material comprises a metal phosphate.

110. The apparatus of any one of claims 1-109, wherein the active material comprises a metal-organic framework.

111. The apparatus of any one of claims 1-110, wherein the active material comprises a conjugated polymer.

112. The apparatus of any one of claims 1-111, wherein the active material comprises a carbonaceous material.

113. The apparatus of any one of claims 1-112, wherein the active material comprises a lithium-ion intercalation material.

114. The apparatus of claim 113, wherein the lithium-ion intercalation material comprises lithium titanium phosphate (LTP).

115. The apparatus of any one of claims 113 or 114, wherein the lithium-ion intercalation material comprises lithium manganese oxide (LMO).

116. The apparatus of any one of claims 113-115, wherein the lithium-ion intercalation material comprises nickel manganese cobalt oxide (NMC).

117. The apparatus of any one of claims 113-116, wherein the lithium-ion intercalation material comprises nickel cobalt aluminum oxide (NCA).

118. The apparatus of any one of claims 113-117, wherein the lithium-ion intercalation material comprises lithium cobalt oxide (LCO).

119. The apparatus of any one of claims 113-118, wherein the lithium-ion intercalation material comprises lithium iron phosphate (LFP).

120. The apparatus of any one of claims 113-119, wherein the lithium-ion intercalation material comprises lithium manganese iron phosphate (LMFP).

121. The apparatus of any one of claims 113-120, wherein the lithium-ion intercalation material comprises lithium titanium oxide (LTO).

122. The apparatus of any one of claims 113-121, wherein the lithium-ion intercalation material comprises disordered rock salt (DRX).

123. The apparatus of any one of claims 113-122, wherein the lithium-ion intercalation material comprises graphite 124. The apparatus of any one of claims 113-123, wherein the lithium-ion intercalation material comprises hard carbon.

125. The apparatus of any one of claims 113-124, wherein the lithium-ion intercalation material comprises a carbon ionomer composite.

126. The apparatus of any one of claims 113-125, wherein the lithium-ion intercalation material comprises functionalized carbon.

127. The apparatus of any one of claims 1-126, wherein the lithium-selective electrode further comprises lyotropic ions at a concentration of at least 1 wt %.

128. The apparatus of any one of claims 1-127 wherein the lithium-selective electrode further comprises a zwitterionic material.

129. The apparatus of any one of claims 1-128, wherein the lithium-selective electrode further comprises an anti-fouling coating present on at least a portion of the electrode.

130. The apparatus of any one of claims 1-129, wherein the lithium-selective electrode further comprises a biocide.

131. The apparatus of any one of claims 1-130, wherein the lithium-selective electrode further comprises a corrosion inhibitor.

132. The apparatus of any one of claims 1-131, wherein the lithium-selective electrode further comprises a pH buffer.

133. The apparatus of any one of claims 1-132, wherein the lithium-selective electrode further comprises an anti-freeze chemical.

134. The apparatus of any one of claims 1-133, wherein the lithium-selective electrode further comprises a mechanical stability additive.

135. The apparatus of any one of claims 1-134, wherein the first compartment further comprises an abrasive fluid.

136. The apparatus of any one of claims 1-135, wherein the first lithium-selective electrode further comprises an ionically conducting additive.

137. The apparatus of claim 136, wherein the ionically conducting additive comprises a perfluorinated hydrocarbon polymer linked to a sulfonate.

138. The apparatus of any one of claims 136 or 137, wherein the ionically conducting additive comprises an alkali metal salt of polystyrene sulfonate.

139. The apparatus of any one of claims 136-138, wherein the ionically conducting additive comprises an alkali metal salt of sulfonated poly(etheretherketone) (SPEEK).

140. The apparatus of any one of claims 136-139, wherein the ionically conducting additive comprises an alkali metal salt of polyvinylsulfonate.

141. The apparatus of any one of claims 136-140, wherein the ionically conducting additive comprises a hydrocarbon polymer comprising a peralkylated ammonium.

142. The apparatus of any one of claims 136-141, wherein the ionically conducting additive comprises a hydrocarbon polymer comprising a peralkylated phosphonium.

143. The apparatus of any one of claims 136-142, wherein the ionically conducting additive is present in the first lithium-selective electrode at at least 1 wt %.

144. The apparatus of any one of claims 136-143, wherein the ionically conducting additive is present in the first lithium-selective electrode at no more than 80 wt %.

145. The apparatus of any one of claims 1-144, wherein the first lithium-selective electrode further comprises a mixed ion-electron conducting (MIEC) additive.

146. The apparatus of claim 145, wherein the MIEC additive comprises poly(3,4-ethylenedioxythiophene) polystyrene sulfonate (PEDOT:PSS).

147. The apparatus of any one of claims 145 or 146, wherein the MIEC additive comprises polystyrene sulfonate.

148. The apparatus of any one of claims 145-147, wherein the MIEC additive comprises polyaniline.

149. The apparatus of any one of claims 145-148, wherein the MIEC additive comprises polythiophene.

150. The apparatus of any one of claims 145-149, wherein the MIEC additive comprises polypyrrole.

151. The apparatus of any one of claims 145-150, wherein the MIEC additive is present in the first lithium-selective electrode at at least 1 wt %.

152. The apparatus of any one of claims 145-151, wherein the MIEC additive is present in the first lithium-selective electrode at no more than 80 wt %.

153. The apparatus of any one of claims 1-152, wherein the first lithium-selective electrode further comprises particles.

154. The apparatus of claim 153, wherein the particles form a packed bed within the lithium-selective electrode.

155. The apparatus of any one of claims 153 or 154, wherein the particles have an average size of at least 1 nm.

156. The apparatus of any one of claims 153-155, wherein the particles have an average size of no more than 10 micrometers.

157. The apparatus of any one of claims 153-156, wherein at least some of the particles are coated with a particle coating.

158. The apparatus of claim 157, wherein the particle coating comprises a ceramic.

159. The apparatus of claim 158, wherein the ceramic comprises silica, alumina, aluminum fluorides, titanium oxide, zirconium oxide, niobium oxide, ITO, boron oxide, vanadium oxide, aluminum oxide, tin oxide, zinc oxide, magnesium oxide, tungsten oxide, lithium phosphate, manganese phosphate, aluminum phosphate, cobalt phosphate, nickel phosphate, magnesium fluoride, zirconium fluoride, iron fluoride, zirconium oxyfluoride, lithium lanthanum zirconium oxide, lithium lanthanum titanium oxide, lithium titanate, lithium aluminum titanium phosphate, and/or boron nitride.

160. The apparatus of any one of claims 157-159, wherein the particle coating comprises a carbon.

161. The apparatus of claim 160, wherein the carbon comprises graphite, hard carbon, graphene oxide, and/or activated carbon.

162. The apparatus of any one of claims 157-161, wherein the particle coating comprises a polymer.

163. The apparatus of any one of claims 1-162, wherein the lithium-selective electrode is formed using a porogen.

164. The apparatus of any one of claims 1-163, further comprising a substrate in contact with the lithium-selective electrode.

165. The apparatus of claim 164, wherein the substrate is a current collector.

166. The apparatus of any one of claims 164 or 165, wherein the substrate is attached to the electrode via an adhesive.

167. The apparatus of any one of claims 164-166, wherein the substrate is welded to the electrode.

168. The apparatus of any one of claims 164-167, wherein the substrate is soldered to the electrode via an adhesive.

169. The apparatus of any one of claims 164-168, wherein the substrate comprises a conductor.

170. The apparatus of claim 169, wherein the conductor and the conducting material are identical.

171. The apparatus of claim 169, wherein the conductor and the conducting material are different.

172. The apparatus of any one of claims 164-171, wherein the substrate comprises platinum.

173. The apparatus of any one of claims 164-172, wherein the substrate comprises stainless steel.

174. The apparatus of any one of claims 164-173, wherein the substrate comprises copper.

175. The apparatus of any one of claims 164-174, wherein the substrate comprises titanium.

176. The apparatus of any one of claims 164-175, wherein the substrate comprises silver.

177. The apparatus of any one of claims 164-176, wherein the substrate comprises gold.

178. The apparatus of any one of claims 164-177, wherein the substrate comprises lead.

179. The apparatus of any one of claims 164-178, wherein the substrate comprises zinc.

180. The apparatus of any one of claims 164-179, wherein the substrate comprises a metal-polymer composite.

181. The apparatus of any one of claims 164-180, wherein the substrate comprises graphite.

182. The apparatus of any one of claims 164-181, wherein the substrate comprises a graphite-polymer composite.

183. The apparatus of any one of claims 164-182, wherein the substrate comprises aluminum.

184. The apparatus of any one of claims 164-183, wherein the substrate comprises indium tin oxide (ITO).

185. The apparatus of any one of claims 164-184, wherein the substrate comprises niobium titanium oxide (NTO).

186. The apparatus of any one of claims 164-185, wherein the substrate is a foil.

187. The apparatus of any one of claims 164-185, wherein the substrate is a sheet.

188. The apparatus of any one of claims 164-185, wherein the substrate is a mesh.

189. The apparatus of any one of claims 164-185, wherein the substrate is a foam.

190. The apparatus of any one of claims 164-185, wherein the substrate is a paper.

191. The apparatus of any one of claims 164-185, wherein the substrate is a fabric.

192. The apparatus of any one of claims 164-185, wherein the substrate is a shim.

193. The apparatus of any one of claims 164-192, wherein the electrode is present on the substrate as a deposition layer.

194. The apparatus of claim 193, wherein the deposition layer is formed by dip coating.

195. The apparatus of claim 193, wherein the deposition layer is formed by spray deposition.

196. The apparatus of claim 193, wherein the deposition layer is formed by aerosol deposition.

197. The apparatus of claim 193, wherein the deposition layer is formed by spin coating.

198. The apparatus of claim 193, wherein the deposition layer is formed by blade coating.

199. The apparatus of claim 193, wherein the deposition layer is formed by screen printing.

200. The apparatus of claim 193, wherein the deposition layer is formed by slot-die coating.

201. The apparatus of claim 193, wherein the deposition layer is formed by slurry coating.

202. The apparatus of claim 193, wherein the deposition layer is formed by inkjet printing.

203. The apparatus of claim 193, wherein the deposition layer is formed by physical deposition.

204. The apparatus of claim 193, wherein the deposition layer is formed by pad printing.

205. A device, comprising:
an electrode comprising an active material, a conducting material, and a binder, wherein the electrode exhibits an air-water contact angle of less than 120°.

206. A method for electrochemical extraction of lithium, comprising:
flowing a lithium-rich fluid through a compartment containing a lithium-selective electrode, wherein the lithium-selective electrode comprises an active material, a conducting material, and a binder, and the lithium-selective electrode exhibits an air-water contact angle of less than 120°; and
incorporating lithium from the lithium-rich fluid into the lithium-selective electrode.

207. An apparatus for electrochemical extraction of a target ion, comprising:
a compartment containing a target ion-selective electrode, the lithium-selective electrode comprising an active material, a conducting material, and a binder, wherein the target ion-selective electrode exhibits an air-water contact angle of less than 120°.

208. The apparatus of claim 207, wherein the target ion is Li⁺.

209. The apparatus of any one of claims 207, wherein the target ion is Na⁺.

210. The apparatus of any one of claims 207, wherein the target ion is K⁺.

211. The apparatus of any one of claims 207, wherein the target ion is Mg²⁺.

212. The apparatus of any one of claims 207, wherein the target ion is Ca²⁺.

213. The apparatus of any one of claims 207-212, wherein the active material comprises a sodium-ion intercalation material.

214. The apparatus of claim 213, wherein the sodium-ion intercalation material comprises sodium manganese oxide (NMO).

215. The apparatus of any one of claims 213 or 214, wherein the sodium-ion intercalation material comprises sodium vanadium oxide (NVO).

216. The apparatus of any one of claims 213-215, wherein the sodium-ion intercalation material comprises sodium iron phosphate (NFP).

217. The apparatus of any one of claims 213-216, wherein the sodium-ion intercalation material comprises sodium titanium phosphate (NTP).

218. The apparatus of any one of claims 213-217, wherein the sodium-ion intercalation material comprises a Prussian blue analogue (PBA).

219. The apparatus of any one of claims 213-218, wherein the sodium-ion intercalation material comprises Prussian White (PW).

220. The apparatus of any one of claims 213-219, wherein the sodium-ion intercalation material comprises a carbon nanomaterial.

221. The apparatus of any one of claims 207-220, wherein the active material comprises a potassium-ion intercalation material.

222. The apparatus of claim 221, wherein the potassium-ion intercalation material comprises potassium manganese oxide (KMO).

223. The apparatus of any one of claims 221 or 222, wherein the potassium-ion intercalation material comprises potassium vanadium oxide (KVO).

224. The apparatus of any one of claims 221-223, wherein the potassium-ion intercalation material comprises potassium iron phosphate (KFP).

225. The apparatus of any one of claims 221-224, wherein the potassium-ion intercalation material comprises potassium vanadium phosphate (KVP).

226. The apparatus of any one of claims 221-225, wherein the potassium-ion intercalation material comprises Prussian blue analogue (PBA).

227. The apparatus of any one of claims 221-226, wherein the potassium-ion intercalation material comprises Prussian White (PW).

228. The apparatus of any one of claims 221-227, wherein the potassium-ion intercalation material comprises graphite.

229. A method for electrochemical extraction of a target ion, comprising:
flowing a target ion-rich fluid through a compartment containing a target ion-selective electrode, wherein the lithium-selective electrode comprises an active material, a conducting material, and a binder, and the target ion-selective electrode exhibits an air-water contact angle of less than 120°; and
incorporating target ions from the target ion-rich fluid into the target ion-selective electrode.

230. An apparatus for electrochemical extraction of lithium, comprising:
a compartment containing a lithium-selective electrode, the lithium-selective electrode comprising an active material, a conducting material, and a binder,
wherein a component of the apparatus exhibits an air-water contact angle of greater than 100°.

231. The apparatus of claim 230, wherein the component comprises a spacer.

232. The apparatus of any one of claims 230 or 231, wherein the component comprises tubing.

233. The apparatus of any one of claims 230-232, wherein the component comprises support.

234. The apparatus of any one of claims 230-233, wherein the component comprises a gasket.

235. The apparatus of any one of claims 230-234, wherein the component comprises a separator.

236. The apparatus of any one of claims 230-235, wherein the component comprises a fluidic interconnect.

237. The apparatus of any one of claims 230-236, wherein the component comprises an electrical interconnect.

238. A method for electrochemical extraction of lithium, comprising:
flowing a lithium-rich fluid through a compartment of an apparatus, the compartment containing a lithium-selective electrode, wherein the lithium-selective comprises comprising an active material, a conducting material, and a binder, and a component of the apparatus exhibits an air-water contact angle of greater than 100°; and
incorporating lithium from the lithium-rich fluid into the lithium-selective electrode.

239. An apparatus for electrochemical extraction of a target ion, comprising:
a compartment containing a target ion-selective electrode, the target ion-selective electrode comprising an active material, a conducting material, and a binder,
wherein a component of the apparatus exhibits an air-water contact angle of greater than 100°.

240. A method for electrochemical extraction of a target ion, comprising:
flowing a target ion-rich fluid through a compartment of an apparatus, the compartment containing a target ion-selective electrode, wherein the target ion-selective electrode comprises an active material, a conducting material, and a binder, and a component of the apparatus exhibits an air-water contact angle of greater than 100°; and
incorporating target ions from the target ion-rich fluid into the target ion-selective electrode.

241. An apparatus for electrochemical extraction of lithium, comprising:
a compartment containing a lithium-selective electrode, the lithium-selective electrode comprising an active material, a conducting material, a binder, and silicone.

242. The apparatus of claim 241, wherein the silicone is in a coating present on at least a portion of the electrode.

243. The apparatus of claim 242, wherein the coating covers at least 50% of an outer surface of the electrode.

244. The apparatus of any one of claims 242 or 243, wherein the coating covers at least 95% of an outer surface of the electrode.

245. The apparatus of any one of claims 242-244, wherein the coating comprises a polymer.

246. The apparatus of any one of claims 242-245, wherein the coating comprises a paint.

247. The apparatus of any one of claims 241-246, wherein the binder comprises the silicone.

248. The apparatus of any one of claims 241-247, wherein the silicone comprises a silicone polymer.

249. The apparatus of any one of claims 241-248, further comprising an electrical pathway connecting the lithium-selective electrode to a second electrode.

250. The apparatus of claim 249, wherein the second electrode is contained within the compartment.

251. The apparatus of any one of claims 249 or 250, wherein the second electrode is contained within a second compartment, the apparatus further comprising a separator between the compartment and the second compartment.

252. The apparatus of any one of claims 249-251, wherein the second electrode is a counter electrode.

253. The apparatus of any one of claims 249-252, wherein the second electrode has a lower lithium selectivity than the lithium-selective electrode.

254. The apparatus of any one of claims 249-253, wherein the second electrode is a second lithium-selective electrode.

255. An apparatus for electrochemical extraction of lithium, comprising:
a compartment containing a lithium-selective electrode, the lithium-selective electrode comprising an active material, a conducting material, a binder, and lyotropic ions at a concentration of at least 1 wt %.

256. The apparatus of claim 255, wherein the lyotropic ions are in a coating present on at least a portion of the electrode.

257. The apparatus of claim 256, wherein the coating covers at least 50% of an outer surface of the electrode.

258. The apparatus of any one of claims 256 or 257, wherein the coating covers at least 95% of an outer surface of the electrode.

259. The apparatus of any one of claims 255-258, wherein the binder comprises the lyotropic ions.

260. The apparatus of any one of claims 255-259, further comprising an electrical pathway connecting the lithium-selective electrode to a second electrode.

261. The apparatus of claim 260, wherein the second electrode is contained within the compartment.

262. The apparatus of any one of claims 260 or 261, wherein the second electrode is contained within a second compartment, the apparatus further comprising a separator between the compartment and the second compartment.

263. The apparatus of any one of claims 260-262, wherein the second electrode is a counter electrode.

264. The apparatus of any one of claims 260-263, wherein the second electrode has a lower lithium selectivity than the lithium-selective electrode.

265. The apparatus of any one of claims 260-264, wherein the second electrode is a second lithium-selective electrode.

266. The apparatus of any one of claims 255-265, wherein the lyotropic ions are present at a concentration that causes precipitation of albumin.

267. The apparatus of any one of claims 255-266, wherein the lyotropic ions comprise a quaternary ammonium salt.

268. The apparatus of any one of claims 255-267, wherein the lyotropic ions comprise NH₄⁺.

269. The apparatus of any one of claims 255-268, wherein the lyotropic ions comprise K⁺.

270. The apparatus of any one of claims 255-269, wherein the lyotropic ions comprise Na⁺.

271. The apparatus of any one of claims 255-270, wherein the lyotropic ions comprise Li⁺.

272. The apparatus of any one of claims 255-271, wherein the lyotropic ions comprise F⁻.

273. The apparatus of any one of claims 255-272, wherein the lyotropic ions comprise SO₄²⁻.

274. The apparatus of any one of claims 255-273, wherein the lyotropic ions comprise HPO₄²⁻.

275. The apparatus of any one of claims 255-274, wherein the lyotropic ions comprise C₂H₃O₂⁻.

276. The apparatus of any one of claims 255-275, wherein the lyotropic ions comprise Cl⁻.

277. The apparatus of any one of claims 255-276, wherein the lyotropic ions comprise Br⁻.

278. An apparatus for electrochemical extraction of lithium, comprising:
a compartment containing a lithium-selective electrode, the lithium-selective electrode comprising an active material, a conducting material, a binder, and a zwitterionic material.

279. The apparatus of claim 278, wherein the zwitterionic material is in a coating present on at least a portion of the electrode.

280. The apparatus of claim 279, wherein the coating covers at least 50% of an outer surface of the electrode.

281. The apparatus of any one of claims 279 or 280, wherein the coating covers at least 95% of an outer surface of the electrode.

282. The apparatus of any one of claims 278-281, wherein the binder comprises the zwitterionic material.

283. The apparatus of any one of claims 278-282, further comprising an electrical pathway connecting the lithium-selective electrode to a second electrode.

284. The apparatus of claim 283, wherein the second electrode is contained within the compartment.

285. The apparatus of any one of claims 283 or 284, wherein the second electrode is contained within a second compartment, the apparatus further comprising a separator between the compartment and the second compartment.

286. The apparatus of any one of claims 283-285, wherein the second electrode is a counter electrode.

287. The apparatus of any one of claims 283-286, wherein the second electrode has a lower lithium selectivity than the lithium-selective electrode.

288. The apparatus of any one of claims 283-287, wherein the second electrode is a second lithium-selective electrode.

289. An apparatus for electrochemical extraction of lithium, comprising:
a compartment containing a lithium-selective electrode, the lithium-selective electrode comprising an active material, a conducting material, a binder, and an anti-fouling coating present on at least a portion of the electrode.

290. The apparatus of claim 289, wherein the coating covers at least 50% of an outer surface of the electrode.

291. The apparatus of any one of claims 289 or 290, wherein the coating covers at least 95% of an outer surface of the electrode.

292. The apparatus of any one of claims 289-291, further comprising an electrical pathway connecting the lithium-selective electrode to a second electrode.

293. The apparatus of claim 292, wherein the second electrode is contained within the compartment.

294. The apparatus of any one of claims 292 or 293, wherein the second electrode is contained within a second compartment, the apparatus further comprising a separator between the compartment and the second compartment.

295. The apparatus of any one of claims 292-294, wherein the second electrode is a counter electrode.

296. The apparatus of any one of claims 292-295, wherein the second electrode has a lower lithium selectivity than the lithium-selective electrode.

297. The apparatus of any one of claims 292-296, wherein the second electrode is a second lithium-selective electrode.

298. The apparatus of any one of claims 289-297, wherein the anti-fouling coating comprises a quaternary ammonium compound.

299. The apparatus of any one of claims 289-298, wherein the anti-fouling coating comprises a polymeric quaternary ammonium compound.

300. The apparatus of any one of claims 289-299, wherein the anti-fouling coating comprises a zwitterionic material.

301. The apparatus of any one of claims 289-300, wherein the anti-fouling coating comprises polytetrafluoroethylene (PTFE).

302. The apparatus of any one of claims 289-301, wherein the anti-fouling coating comprises polyvinylidene fluoride (PVDF).

303. The apparatus of any one of claims 289-302, wherein the anti-fouling coating comprises polypropylene.

304. The apparatus of any one of claims 289-303, wherein the anti-fouling coating comprises silicone.

305. The apparatus of any one of claims 289-304, wherein the anti-fouling coating comprises polyethylene glycol (PEG).

306. The apparatus of any one of claims 289-305, wherein the anti-fouling coating comprises polyethylene (PE).

307. The apparatus of any one of claims 289-306, wherein the anti-fouling coating comprises polypropylene (PP).

308. The apparatus of any one of claims 289-307, wherein the anti-fouling coating comprises polystyrene (PS).

309. An apparatus for electrochemical extraction of lithium, comprising:
a compartment containing a lithium-selective electrode, the lithium-selective electrode comprising an active material, a conducting material, a binder, and a biocide.

310. The apparatus of claim 309, wherein the biocide is in a coating present on at least a portion of the electrode.

311. The apparatus of claim 310, wherein the coating covers at least 50% of an outer surface of the electrode.

312. The apparatus of any one of claims 310 or 311, wherein the coating covers at least 95% of an outer surface of the electrode.

313. The apparatus of any one of claims 309-312, wherein the binder comprises the biocide.

314. The apparatus of any one of claims 309-313, further comprising an electrical pathway connecting the lithium-selective electrode to a second electrode.

315. The apparatus of claim 314, wherein the second electrode is contained within the compartment.

316. The apparatus of any one of claims 314 or 315, wherein the second electrode is contained within a second compartment, the apparatus further comprising a separator between the compartment and the second compartment.

317. The apparatus of any one of claims 314-316, wherein the second electrode is a counter electrode.

318. The apparatus of any one of claims 314-317, wherein the second electrode has a lower lithium selectivity than the lithium-selective electrode.

319. The apparatus of any one of claims 314-318, wherein the second electrode is a second lithium-selective electrode.

320. The apparatus of any one of claims 309-319, wherein the biocide comprises copper.

321. The apparatus of any one of claims 309-320, wherein the biocide comprises zinc.

322. The apparatus of any one of claims 309-321, wherein the biocide is contained within a ceramic bead.

323. The apparatus of any one of claims 309-322, wherein the biocide comprises a quaternary ammonium salt.

324. An apparatus for electrochemical extraction of lithium, comprising:
a compartment containing a lithium-selective electrode, the lithium-selective electrode comprising an active material, a conducting material, a binder, and a corrosion inhibitor.

325. The apparatus of claim 324, wherein the corrosion inhibitor is in a coating present on at least a portion of the electrode.

326. The apparatus of claim 325, wherein the coating covers at least 50% of an outer surface of the electrode.

327. The apparatus of any one of claims 325 or 326, wherein the coating covers at least 95% of an outer surface of the electrode.

328. The apparatus of any one of claims 325-327, wherein the coating comprises a polymer.

329. The apparatus of any one of claims 325-328, wherein the coating comprises a paint.

330. The apparatus of any one of claims 324-329, wherein the binder comprises the corrosion inhibitor.

331. The apparatus of any one of claims 324-330, further comprising an electrical pathway connecting the lithium-selective electrode to a second electrode.

332. The apparatus of claim 331, wherein the second electrode is contained within the compartment.

333. The apparatus of any one of claims 331 or 332, wherein the second electrode is contained within a second compartment, the apparatus further comprising a separator between the compartment and the second compartment.

334. The apparatus of any one of claims 331-333, wherein the second electrode is a counter electrode.

335. The apparatus of any one of claims 331-334, wherein the second electrode has a lower lithium selectivity than the lithium-selective electrode. The apparatus of any one of claims 331-335, wherein the second electrode is a second lithium-selective electrode.

337. The apparatus of any one of claims 324-336, wherein the corrosion inhibitor comprises an oxygen scavenger.

338. The apparatus of any one of claims 324-337, wherein the corrosion inhibitor comprises an antioxidant.

339. The apparatus of claim 338, wherein the antioxidant comprises a sulfite.

340. The apparatus of any one of claims 338 or 339, wherein the antioxidant comprises ascorbic acid.

341. The apparatus of any one of claims 338-340, wherein the antioxidant comprises a polyphenol.

342. The apparatus of any one of claims 324-341, wherein the corrosion inhibitor comprises a metal.

343. The apparatus of claim 342, wherein the metal comprises zinc.

344. The apparatus of any one of claims 342 or 343, wherein the metal comprises aluminum.

345. The apparatus of any one of claims 342-344, wherein the metal comprises magnesium.

346. The apparatus of any one of claims 342-345, wherein the metal comprises titanium.

347. The apparatus of any one of claims 324-346, wherein the corrosion inhibitor comprises a reaction inhibitor.

348. The apparatus of claim 347, wherein the reaction inhibitor comprises an amine.

349. The apparatus of any one of claims 347 or 348, wherein the reaction inhibitor comprises a hydrazine.

350. The apparatus of any one of claims 347-349, wherein the reaction inhibitor comprises a hexmine.

351. The apparatus of any one of claims 347-350, wherein the reaction inhibitor comprises phenylenediamine.

352. The apparatus of any one of claims 347-351, wherein the reaction inhibitor comprises dimethylethanolamine.

353. An apparatus for electrochemical extraction of lithium, comprising:
a compartment containing a lithium-selective electrode, the lithium-selective electrode comprising an active material, a conducting material, a binder, and a pH buffer.

354. The apparatus of claim 353, wherein the pH buffer is in a coating present on at least a portion of the electrode.

355. The apparatus of claim 354, wherein the coating covers at least 50% of an outer surface of the electrode.

356. The apparatus of any one of claims 354 or 355, wherein the coating covers at least 95% of an outer surface of the electrode.

357. The apparatus of any one of claims 353-356, wherein the binder comprises the pH buffer.

358. The apparatus of any one of claims 353-357, wherein the pH buffer comprises boric acid.

359. The apparatus of any one of claims 353-358, wherein the pH buffer comprises citric acid.

360. The apparatus of any one of claims 353-359, wherein the pH buffer comprises acidic acid.

361. The apparatus of any one of claims 353-360, wherein the pH buffer comprises monopotassium phosphate.

362. The apparatus of any one of claims 353-361, further comprising an electrical pathway connecting the lithium-selective electrode to a second electrode.

363. The apparatus of claim 362, wherein the second electrode is contained within the compartment.

364. The apparatus of any one of claims 362 or 363, wherein the second electrode is contained within a second compartment, the apparatus further comprising a separator between the compartment and the second compartment.

365. The apparatus of any one of claims 362-364, wherein the second electrode is a counter electrode.

366. The apparatus of any one of claims 362-365, wherein the second electrode has a lower lithium selectivity than the lithium-selective electrode.

367. The apparatus of any one of claims 362-366, wherein the second electrode is a second lithium-selective electrode.

368. The apparatus of any one of claims 353-367, wherein the pH buffer comprises a weak acid and a conjugate base to the weak acid, wherein the weak acid has a pKₐ of at least 2.

369. The apparatus of any one of claims 353-368, wherein the pH buffer comprises boric acid.

370. The apparatus of any one of claims 353-369, wherein the pH buffer comprises citric acid.

371. The apparatus of any one of claims 353-370, wherein the pH buffer comprises acetic acid.

372. The apparatus of any one of claims 353-371, wherein the pH buffer comprises monopotassium phosphate.

373. An apparatus for electrochemical extraction of lithium, comprising:
a compartment containing a lithium-selective electrode, the lithium-selective electrode comprising an active material, a conducting material, and a binder, wherein the lithium-selective electrode exhibits an elastic modulus of at least 5 MPa.

374. The apparatus of claim 373, wherein the lithium-selective electrode exhibits a compressive strength of at least 0.5 MPa.

375. The apparatus of any one of claims 373 or 374, wherein the lithium-selective electrode exhibits a specific toughness of at least 3 mJ/cm³.

376. An apparatus for electrochemical extraction of lithium, comprising:
a compartment containing a lithium-selective electrode, the lithium-selective electrode comprising an active material, a conducting material, and a binder, wherein the lithium-selective electrode exhibits a compressive strength of at least 0.5 MPa.

377. An apparatus for electrochemical extraction of lithium, comprising:
a compartment containing a lithium-selective electrode, the lithium-selective electrode comprising an active material, a conducting material, and a binder, wherein the lithium-selective electrode exhibits a specific toughness of at least 3 mJ/cm³.

378. An apparatus for electrochemical extraction of lithium, comprising:
a compartment containing a lithium-selective electrode, the lithium-selective electrode comprising an active material, a conducting material, a binder, and a mechanical stability additive.

379. The apparatus of claim 378, wherein the mechanical stability additive is in a coating present on at least a portion of the electrode.

380. The apparatus of claim 379, wherein the coating covers at least 50% of an outer surface of the electrode.

381. The apparatus of any one of claims 379 or 380, wherein the coating covers at least 95% of an outer surface of the electrode.

382. The apparatus of any one of claims 378-381, wherein the binder comprises the mechanical stability additive.

383. The apparatus of any one of claims 378-382, further comprising an electrical pathway connecting the lithium-selective electrode to a second electrode.

384. The apparatus of claim 383, wherein the second electrode is contained within the compartment.

385. The apparatus of any one of claims 383 or 384, wherein the second electrode is contained within a second compartment, the apparatus further comprising a separator between the compartment and the second compartment.

386. The apparatus of any one of claims 383-385, wherein the second electrode is a counter electrode.

387. The apparatus of any one of claims 383-386, wherein the second electrode has a lower lithium selectivity than the lithium-selective electrode.

388. The apparatus of any one of claims 383-387, wherein the second electrode is a second lithium-selective electrode.

389. The apparatus of any one of claims 378-388, wherein the mechanical stability additive comprises fibers.

390. The apparatus of any one of claims 378-389, wherein the mechanical stability additive comprises metal fibers.

391. The apparatus of any one of claims 378-390, wherein the mechanical stability additive comprises wires.

392. The apparatus of any one of claims 378-391, wherein the mechanical stability additive comprises metal wires.

393. The apparatus of any one of claims 378-392, wherein the mechanical stability additive comprises metal powders.

394. The apparatus of any one of claims 378-393, wherein the mechanical stability additive comprises carbon fibers.

395. The apparatus of any one of claims 378-394, wherein the mechanical stability additive comprises carbon nanotubes.

396. The apparatus of any one of claims 378-395, wherein the mechanical stability additive comprises graphene.

397. The apparatus of any one of claims 378-396, wherein the mechanical stability additive comprises polytetrafluoroethylene (PTFE).

398. The apparatus of any one of claims 378-397, wherein the mechanical stability additive comprises polyvinylidene fluoride (PVDF).

399. The apparatus of any one of claims 378-398, wherein the mechanical stability additive comprises polypropylene.

400. The apparatus of any one of claims 378-399, wherein the mechanical stability additive comprises aluminum oxide.

401. The apparatus of any one of claims 378-400, wherein the mechanical stability additive comprises titanium oxide.

402. The apparatus of any one of claims 378-401, wherein the mechanical stability additive comprises zirconium oxide.

403. A method, comprising:
flowing a lithium-rich fluid through a compartment containing a lithium-selective electrode;
incorporating lithium from the lithium-rich fluid into the lithium-selective electrode; and
flowing an abrasive fluid through the compartment.

404. The method of claim 403, wherein the abrasive fluid comprises a slurry.

405. The method of any one of claims 403 or 404, wherein the abrasive fluid comprises alumina.

406. The method of any one of claims 403-405, wherein the abrasive fluid comprises SiC.

407. A method, comprising:
flowing a lithium-rich fluid through a compartment containing a lithium-selective electrode;
incorporating lithium from the lithium-rich fluid into the lithium-selective electrode; and
applying a shear stress of at least 1 kPa to the lithium-selective electrode.

408. The method of claim 407, comprising flowing a fluid through the compartment to apply the shear stress to the lithium-selective electrode.

409. A device, comprising:
an electrode comprising an active material, a conducting material, and a binder, wherein the electrode exhibits fouling resistance as determined by ASTM D3623-78a (1998).

410. A device, comprising:
an electrode comprising an active material, a conducting material, and a binder, wherein the electrode exhibits corrosion resistance as determined by ASTM B117-19 Salt Spray (2019), ASTM G85-19 Modified Salt Spray (2019), ASTM G85 Cyclic Corrosion (2019), or ASTM G1-03 Corrosion Test (2003).

411. An apparatus for electrochemical extraction of lithium, comprising:
a compartment containing a lithium-selective electrode, the lithium-selective electrode comprising an active material, a conducting material, a binder, and an anti-freeze chemical.

412. The apparatus of claim 411, wherein the anti-freeze chemical comprises ethylene glycol.

413. The apparatus of any one of claims 411 or 412, wherein the anti-freeze chemical comprises propylene glycol.

414. The apparatus of any one of claims 411-413, wherein the anti-freeze chemical comprises methanol.

415. The apparatus of any one of claims 411-414, wherein the anti-freeze chemical comprises isopropanol.

416. The apparatus of any one of claims 411-415, wherein the anti-freeze chemical comprises an antifreeze protein.

417. The apparatus of any one of claims 411-416, wherein the anti-freeze chemical comprises a cryoprotectant.

418. The apparatus of any one of claims 411-417, wherein the anti-freeze chemical comprises an organic acid.

419. The apparatus of any one of claims 411-418, wherein the anti-freeze chemical comprises sodium silicate.

420. The apparatus of any one of claims 411-419, wherein the anti-freeze chemical comprises disodium phosphate.

421. The apparatus of any one of claims 411-420, wherein the anti-freeze chemical comprises dextrin.

422. An apparatus for electrochemical extraction of lithium, comprising:
a compartment containing a lithium-selective electrode, the lithium-selective electrode comprising an active material, a conducting material, a binder, and an anti-boiling coolant chemical.

423. The apparatus of claim 422, wherein the anti-boiling coolant chemical comprises ethylene glycol.

424. The apparatus of any one of claims 422 or 423, wherein the anti-boiling coolant chemical comprises polyethylene glycol (PEG).
